(19) United States
(12) Patent Application Publication
(10) Pub. No.: US 2006/0050929 A1
(43) Pub. Date: Mar. 9, 2006

(54) Visual vector display generation of very fast moving elements

(76) Inventors: Rodger H. Rast, Gold River, CA (US); Rick Martin Wiesner, Carmichael, CA (US)

Correspondence Address: RODGER H. RAST, 11230 GOLD EXPRESS DRIVE, SUIT 310 MS 337, GOLD RIVER, CA, 95670, US

(21) Appl. No.: 11/223,512

(22) Filed: Sep. 9, 2005

Related U.S. Application Data
(60) Provisional application No. 60/608,789, filed on Sep. 9, 2004.

(51) Int. Cl. G06K 9/00

(52) U.S. Cl. 382/103

(57) ABSTRACT

Apparatus, system and method for providiing tactical information. One aspect is a system and method for displaying vectors (preferably in real time) for very fast moving (VFM) elements, such as projectiles (e.g., bullets or shells), missiles, and other transient events that arise in a battlefield or civil police action. The system optically and/or acoustically collects information about the ordinance and displays vectors of otherwise unseen ordinance. One aspect is a device for collecting intelligence on and confusing enemy troops, as well as small munition deployment.

### CROSS-REFERENCE TO RELATED APPLICATIONS

This application claims priority from provisional patent application Ser. No. 60/608,789 filed Sep. 9, 2004 which is incorporated herein by reference and priority to which is claimed.

This application is related to these copending applications, which are subject to a common assignment: Utility patent application Ser. No. 10/612,221 filed Jul. 1, 2003; Provisional patent application Ser. No. 60/394,160 filed Jul. 1, 2002; Utility patent application docket number KeyboardRAST070103 Ser. No. 10/612,777 as filed Jul. 1, 2003; Provisional patent application describing an “Eceptor within docket “PPA_RAST061403” Ser. No. 60/478,900 as filed Jun. 14, 2003; Provisional patent application docket “PPA_RAST120103” Ser. No. 60/526,376 filed Dec. 1, 2003; Utility patent application docket “Display_RAST092303” Ser. No. 10/670,432 filed Sep. 23, 2003; Provisional patent application Ser. No. 60/413,199 filed Sep. 23, 2002; Utility patent application docket “TransportRAST070103” Ser. No. 10/612,225 filed Jul. 1, 2003; Utility patent application docket “KeyboardRAST070103” Ser. No. 10/612,777 as filed Jul. 1, 2003; Utility patent application Ser. No. 10/612,221 as filed Jul. 1, 2003; Utility patent application docket “Scrollster_{—}02” Ser. No. 10/008,662 filed Nov. 1, 2000; Provisional patent application docket number “PPA_RAST071403” Ser. No. 60/487,295 filed Jul. 14, 2003; Utility patent application docket “PSPid_{—}02” Ser. No. 10/066,495 filed Feb. 2, 2002; and Provisional patent application Ser. No. 60/267,115 filed Feb. 7, 2001.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to method of increasing battlefield or police intelligence gathering and more particularly to a system for tracing very fast moving objects such as projectiles.

2. Description of the Background Art

Any advantages that can be gained by our military during combat situations, or even police actions, can save lives and more readily reach objectives. The need for small arms combat between opposing personnel remains a necessity of many engagements.

The situation that arise when a person is being fired upon by an enemy (or criminal party), such as small arms fire, has changed little in the last decades. It is still incumbent upon the individual to seek defensible position, and to return fire. However, one can never be sure the path of the incoming rounds, wherein taking cover and returning fire properly is an “art”. As a person is unable to see bullets they rely on seeing muzzle flashes, movement, or hearing the direction from which shots were fired. As a result our military is left to rely on their perceptions of the situation and both combat effectiveness and safety are compromised.

It is always important in military battle scenarios to collect sufficient tactical information, to gain every advantage. However, when a combatant is under cover it is often difficult to safely gather information from nearby locations.

Presently more small arms platforms and systems are being deployed to support in tactical roles. However, including conventional weapons systems into these platforms is often problematic, or at best inefficient, as the technologies do not scale well to small platforms as the mechanisms for round storage, loading, firing, and shell ejection require heavy and expensive mechanisms.

Accordingly, the present invention provides apparatus and methods for increasing combat awareness of projectiles, collection of battle intelligence, improved arms systems for small platforms, and other aspects of benefit in both military and civil roles.

### BRIEF SUMMARY OF THE INVENTION

The present invention provides tactical information and control. A system referred to as Visual Vector Display Generation of Very Fast Moving Elements is described for enhancing the sight of our forces to allow them to view the paths of bullets. The system is particularly well suited for implementation within night vision systems, and can share a number of elements therein. The system provides for optical detection of objects moving at high speed and determines vectors for those projectiles. The system displays these items to alert the viewer. In one aspect the vector display is shown having a desired persistence, and is displayed differently as time passes, therein providing information as to the age of the data. The trace data is correlated with position and direction, or may be erased in response to changes in positioning as desired. In this way the system paints the vectors correctly regardless of changes in direction or position. The vectors are mapped by the system into a three dimensional internal map from which the data is generated to drive the display.

The advantages of this system should be readily recognized. Combatants can better find cover when under fire, as both the path and origination of bullets can be quickly seen. The historical paths can also be seen wherein the user can determine the movements of the enemy. The benefits for returning fire are even more significant, in that the user only need follow a single vector or recognize where multiple vectors converge to detect an enemy position. The enemy can be fired upon without the need of seeing them physically, but in response to the fire pattern.

A system referred to as Fau-Tactical Position Indicators and Markers is described for collecting additional data and providing additional controlled firepower to our combat personnel. The system can be deployed in a number of ways wherein it collects information while being able to confuse, annoy, and in some cases inflict harm to the enemy.

Embodiments of the present invention can provide a number of beneficial aspects which can be implemented either separately or in any desired combination without departing from the present teachings.

An aspect of the invention is to generate a display of vectors associated with the flight of bullets and similar ordnance.

Another aspect of the invention is to generate the vector display with a desired level of persistence.

Another aspect of the invention is to generate the vector display in response to optical detection of projectiles

Another aspect of the invention is to augment the optical detection of projectiles with the collection of audio information.

Another aspect of the invention is to provide for the estimation of projectile speed, change of speed along path, and actual flight path as well as estimated flight path.

Another aspect of the invention is to optically register muzzle flashes to aid in the recognition of projectile paths.

Another aspect of the invention is to discern between projectiles and non-projectile items, whereas false vectors are not generated.

Another aspect of the invention is to provide (at least on higher quality systems) the ability to generate and display vectors in their proper 3D position even if the user point of view or position changes.

Another aspect of the invention is to provide for additional camera inputs which have a view which is wider than that of the user, so that more data is collected for the vector displays.

Another aspect of the invention is to provide for the detection and marking in response to Friend-or-Foe systems.

Another aspect of the invention is to communicate vector information to other systems and personnel.

Another aspect of the invention is to provide a small portable device that simulates troop activity.

Another aspect of the invention is to provide a small portable device that can collect information at its location.

Another aspect of the invention is to generate light and sound output for simulating troop activity and/or confusing the enemy, or even for causing temporary blindness to the enemy.

Another aspect of the invention is to provide an intelligent small arms grenade style device with a number of beneficial features.

Another aspect of the invention is to provide for the collection of imagery (still, frame sequences, or video) from the device.

Another aspect of the invention is to provide a system for electrically firing a plurality of projectiles based on a chemical charge from small inexpensive housings.

Another aspect of the invention is to provide an in-line series of projectiles for being fired in a proper sequence.

Another aspect of the invention is to provide a fail safe which prevents the improper projectile from being activated.

Another aspect of the invention is to provide a multi-round cartridge which may be readily replaced into the weapon platform.

Another aspect of the invention is to provide a small arms device that is highly reliable, very light weight, and expendable.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of vector generation in response to very fast object detection according to an aspect of the present invention, shown with optional multiple image sensors and acoustic sensors.

FIG. 2 is a facing view of a tactical device (Fau-Tac) which provides simulated troop activity for confusing the enemy according to an aspect of the present invention, shown in a spherical embodiment.

FIG. 3A-3B are side views of options within the Fau-Tac device of FIG. 2 according to an aspect of the present invention, shown with a laser direction control and camera along with a muscle wire control.

FIG. 4 is a schematic diagram of the Fau-Tac device of FIG. 2 according to an aspect of the present invention.

FIG. 5-7 are top and side views respectively of Fau-Tac conveyance examples according to an aspect of the present invention, shown enabled for air, water, or land.

FIG. 8 is a block diagram of a distributed acoustic modulation unit according to an aspect of the present invention.

FIG. 9 is a cutaway view of a Smartridge based weapon system according to an aspect of the present invention, shown with a plurality of alternating projectiles and explosive charges.

FIG. 10 is a side view of a Smartridge of FIG. 9, according to an aspect of the present invention.

FIG. 11 is a top view of a wing upon which a number of Smartridges are mounted according to an aspect of the present invention.

FIG. 12-13 is a end view of two Smartridges showing the variability of types of loads that each Smartridge can be configured for any given mission, according to an aspect of the present invention.

FIG. 14 is a top view of the construction for a Smartridge (laid open) according to an aspect of the present invention.

FIG. 15 is a cutaway view of a no-shell artillery round according to an aspect of the present invention.

FIG. 16 is a cutaway view of electronically ignited munitions according to an aspect of the present invention.

FIG. 17 is a facing view of an environmentally responsive gun control system according to an aspect of the present invention.

FIG. 18 is a schematic of the firearm control system of FIG. 17 according to an aspect of the present invention.

FIG. 19 is a top view of an apparatus for effecting mechanical disengagement according to an aspect of the present invention.

FIG. 20 is a schematic diagram of the system for effecting mechanical disengagement according to an aspect of the present invention.

FIG. 21 is a top view of a device element adapted to selectively release according to an aspect of the present invention.

FIG. 22 is a cross-section view of a bolt adapted to selective disengagement according to an aspect of the present invention.

FIG. 23 is a block diagram of a distributed image collection system, such as for within a theme park according to an aspect of the present invention.

FIG. 24 is a block diagram of an image framing alignment apparatus according to an aspect of the present invention.

FIG. 25 is a block diagram of a tour guide device according to an aspect of the present invention, shown operating in response to RFID tags.

FIG. 26 is a bottom view of a camera configured for receiving any of a number of personality modules according to an aspect of the present invention.

FIG. 27 is a schematic diagram of the camera system of FIG. 26 according to an aspect of the present invention.

FIG. 28 is a facing view of cell-activity blocking while driving according to an aspect of the present invention.

FIG. 29 is a schematic of the cell-activity blocking of FIG. 28 according to an aspect of the present invention.

FIG. 30-31 are block diagrams of cascading input according to an aspect of the present invention.

FIG. 32 is a block diagram of a series input module according to an aspect of the present invention.

FIG. 33 is a block diagram of the circuit for controller (FIG. 32) according to an aspect of the present invention, shown with.

FIG. 34-38 are views of a heated bait trap according to an aspect of the invention.

FIG. 39 is a block diagram of a hand sanitation station according to an aspect of the present invention.

FIG. 40 is a flowchart of operations according to the verified sanitation station according to an aspect of the present invention.

### DETAILED DESCRIPTION OF EMBODIMENT(S)

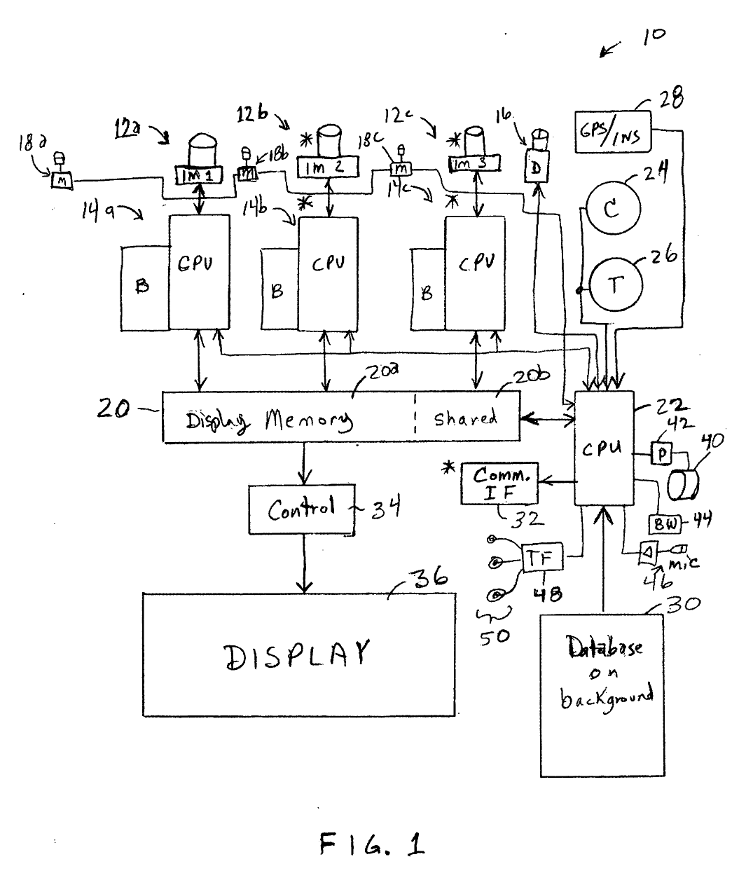

Referring more specifically to the drawings for illustrative purposes, the present invention is embodied in the method generally described in FIG. 1 to FIG. 40. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

The detailed description is not intended to limit the apparatus and methods for generating visual vectors for very fast moving objects. Instead the scope of the apparatus and methods is identified by any inventive aspects which are described separately or in combination within the specification and a subset of which are defined by the appended claims and their equivalents.

Furthermore, aspects of the invention may be implemented separately or in various combinations without departing from the teachings of the present invention. Specific embodiments are typically shown having a given set of features for the sake of clarity, however, it will be appreciated that the invention may be implemented with more or fewer aspects without departing from the invention. Furthermore, the claims, and/or claim portions contained within the application are considered to comprise portions of the invention disclosure and are to be considered as such for all purposes.

1 Visual Vector Display Generation of Very Fast Moving Elements.

1.1 Problem Description

When a person is being fired upon by an enemy (or criminal party), such as small arms fire, it is incumbent upon the individual to seek a somewhat defensible position, (where preferably the largest portion of their body is shielded from the incoming fire), and then to return fire for the purpose of taking down (i.e., killing or seriously wounding) the enemy, or at least striking back at sufficient proximity to the enemy that they the enemy is forced to leave a weakly defensible position.

The scenario has not changed substantially since guns were first introduced into combat scenarios, whether battlefields, or situations of civil disobedience and unrest. It has been taken generally for granted that a person is unable to see bullets and they must rely on seeing muzzle flashes, movement, or hearing the direction from which shots were fired.

1.2 Overview.

A system and method of increasing battlefield awareness by displaying information, preferably overlaid on battlefield images in real time. The system is configured to detect any of a number of events and to display information about those events for a period of time but to fade the event display as time elapses. The events are tagged with location information, wherein they may be displayed at the correct locations regardless of panning and tilting of user view. By way of example, very fast moving objects are detected wherein paths of bullets are detected and displayed as vectors by the system. Furthermore, muzzle flashes, detected motions, and so forth are detected by the system and displayed providing the user with enhanced battlefield awareness.

1.3 Example Embodiments.

The system and method to provide for displaying vectors (preferably in real time) for very fast moving (VFM) elements, such as projectiles (i.e. bullets or shells), missiles, and so forth in a battlefield or civil police action. The user of the device is thereby given a means of visually discerning from where shots have been fired, and patterns of fire, wherein they have a higher probability of taking down a target with returned fire, or more effectively laying down a pattern of suppressive fire.

Using sight alone, a human is of course typically unable to see bullets, or other very fast moving items, however, it has not been fully appreciated that high speed electronic equipment, such as a high speed camera, can register the presence and path of a bullet (or other very fast moving items), and over the course of a number of high-speed frames the path accuracy can be increased dramatically to alert the user of the system—preferably graphically.

Modern electronic cameras can readily provide framing rates of over 3000 frames per second (i.e. SpeedCam lite™), and video capture is available up to over 12,000 frames per second. By way of simple example, consider a muzzle velocity of 3600 mph (1 mile/second) analyzed at 3,000 frames per second (fps), it will be appreciated that the projectile will travel approximately 1.75 feet per frame. Although rarely will the imaging be obtained from a view that is orthogonal to the path. The present system may be utilized with imagers spanning a wide range of framing rates depending on the accuracy desired and the speed and computational power of the frame-to-frame image analysis being performed. It will also be appreciated that at 3000 fps the other elements in the image are moving from one frame to the next at a much slower velocity than the projectile, wherein the movement of the projectile (VFM) is readily discerned by the image processing software from static or slowly moving objects such as personnel, vehicles and the like.

Tracking the motion vector representing the projectile from one frame to the next it is seen to disappear from location x, y on frame n and to appear at a location x+u, y+v on frame n+1. Once analyzed as motion vectors, the tracking of the movement of the VFM (projectile in this case) is a simple matter of “connecting the dots” wherein the coordinates from frame to frame are connected to define a complete vector. It should be appreciated that the determination of image vectors within conventional speed signals (30-60 fps) is an operation generally known in the art for encoding video, such as into the MPEG video format, therefore the details of this processing need not be described herein.

Since the human could not see this event if displayed in real-time, the system displays information, such as creating a line segment on the display, which can be seen by the user for a much longer period of time than that over which the event actually occurred (which could span less than a millisecond in some cases). For example, the vectors associated with VFM, such as projectiles, can be displayed over a period of time as selected by the user and preferably the character of the displayed element will change over time, for instance color changes or line dashing etc, wherein the user can discern the age of the augmented information provided by the system.

By way of example the system may be implemented within a wearable camera-display, such as in a similar manner that night-goggles are utilized, and the night vision functionality may be likewise incorporated within the present invention to provide for displaying vectors in night or day. It will be appreciated that VFM elements are often at an elevated temperature making them more readily discerned in from the background image in a portion of the infrared spectrum.

The method generally comprises (a) capturing images at a sufficiently high first framing rate wherein very fast moving elements are captured more than once along their travel path; (b) extracting very fast moving features which arise in sequential frames; (c) determining vectors for each fast moving feature; and (d) annunciating said vectors such as visually projecting them at a conventional framing rate, typically at a second framing rate which much less than the high-speed framing rate. The vectors are preferably annunciated by displaying images of the scene, preferably in real time, over which the vectors are depicted. It should be appreciated that the vectors can be annunciated with audio information, such as providing coordinates to fire upon, or directions to lay down fire. It will be appreciated, however, that displaying the vectors provides a wealth of information readily assimilated spatially.

Preferably the vectors are displayed (typically at a conventional video framing rate of between about 6 to 120 frames per second, and more typically about 30 frames per second, wherein the direction of movement is readily ascertainable, such as toward or away from the viewer. For example the vector path may be shown with small arrowheads along its length.

In addition, the vectors are displayed for a period of time (preferably user selectable) after the event, and the vector is preferably generated on the display so that a user can discern the relative time that the vector was determined. For example, the vector may be initially displayed in a first color and as time passes the color shifts until at the end of the period the vector completely fades away. In this way the relevance of the vector information is displayed along with the vector information, however, temporally local trends, such as would arise when viewing projectile vectors from a moving source, can be displayed allowing the user to discern a pattern and for example estimate location of next burst.

It is also preferred that in displaying these vectors that the difference between VFM element actual path and extrapolated path be made visible. In response to sequential frames containing a given VFM element, a vector is generated which spans those locations in reference to the background locations. When displayed that vector comprises a line having no end or beginning. If a spread burst of fire was detected from a given origin (i.e. automatic weapons fire, or “machine gun nest”) then the displayed vectors cross at the point of origin, giving an excellent indication of the origin. However, for sporadic fire it is difficult to discern where along the vector that the fire originated. The present invention preferably utilizes a number of methods for enhancing this available information.

(1) Registering acoustic information (remembering that it is received after the images) and correlating the time differential between the captured images and the arrival of the associated sound. Muzzle velocity of a rifle is on the order of 2000-3000 mph, whereas speed of sound is approximately 600-700 mph depending on air density. The origin of the round can be easily estimated and displayed along the vector path by tracing the audio and image vector back in time to the point where the audio and video would coincide, taking into account of course the deceleration of the projectile being imaged. Since the audio and image were sourced at a single point in time, but diverged in time to the user's point of reference, the system is configured to estimate back in time the point of coincidence for the image and acoustic, wherein the location of the firing point may be discerned or estimated. For example, the portion of the vector behind the estimated location from which fire emanated can be displayed at a dashed or dotted line.

(2) Registering acoustic information from multiple sensors, wherein some direction and distance information can be extracted from the audio data collected. This acoustic information is processed and preferably correlated with collected visual information, to aid in displaying proper vectors preferably indicating point of origin of each associated element of fire. It should be appreciated that the present invention is preferably configured to also generate and display vectors based only on acoustical information, although the precision is more limited than with an imaged path.

(3) Estimating loss of projectile speed in reference to initial muzzle velocity. Although generally of limited accuracy, the speed of a round may be determined from its movement in successive frames. If the initial muzzle velocity of the round can be estimated with any accuracy, then a distance can be estimated which coincides with the detected drop in velocity of the round. Of course each type of bullet and weapon has a range of muzzle velocities and depending on the projective profile a deceleration profile. Additionally, it should be appreciated that even in bullets produced by automated equipment muzzle velocity can vary significantly from batch to batch, or even round to round. The type of weapon and a gross indication of initial muzzle velocity can typically be discerned from the acoustic information associated with the muzzle flash, in particular if multiple discharges are registered for a given weapon.

(3) Registering muzzle flashes. The imaging system is configured for detecting the signature of muzzle flashes (or other short life time events) and storing the image relating to the position of the muzzle flash. It will be appreciated that a muzzle flash occurs in a very brief period of time, such as is often not fully captured at a conventional framing rate, although the persistence of the eye can the flash—but of course then requires individual memory of location. The muzzle flashes are preferably detected as a combination of visible light and infrared light, for optimum detection. Muzzle flash locations are then displayed over a longer period of time on the display, such as a colored circle. As time elapses the muzzle flash display preferably changes so the recentness of the flash can be determined by the user of the system. For example the color changes from red through a series of other color before fading away after sufficient elapsed time. This mode adds another aid to detecting enemy positions.

(4) Motion detections. The imaging system is configured for analyzing frame to frame to detect VFM, but is also configured to detect slower forms of motion, such as vehicles, personnel and so forth. Moving elements are preferably highlighted to make them easier to see, and wherein the user does not have to remember where the enemy has been sighted. Further in some cases the system can determine the nature of the threat for example, whether a moving enemy personnel or a moving vehicle.

(5) Distance and motion information. The imaging system and the targeting laser are configured for compute the distance to the targeted object, and both speed and motion information for moving targets upon which the targeting laser is directed.

(6) Marking target paintings. The system is configured wherein the backscatter (reflection) from the user's targeting laser is identified on the display to avoid confusion (explained later).

(7) Data base view augmentation. Map data, such as collected earlier, is stored in the system wherein features of the terrain, buildings, bunkers, razor wire location, mines, and so forth can be selectively marked on the display (i.e. edge depiction and hidden lines) providing the user with an enhanced view of what otherwise would remain unseen such as in the dark or obscured behind objects, terrain, buildings or smoke.

(8) FOF Detection and Marking. The images collected can also include information about friend or foe, wherein the FOF information can be overlaid over other information to mark the vectors and graphics appropriately as FOF information becomes available. For instance friendly fire can be marked and the source identified in many cases, wherein the user can communicate directly or indirectly for the friendly to cease firing upon their position. By way of example, the optical communication system described in the invention entitled “Secure Visual Data Communication Methods” which is incorporated herein by reference, can be utilized for generating FOF information to units equipped with the present imaging system. Garments on allied solders can emit a coded transmission, that is picked up by the display and marked as a friendly. Clothing signals are preferably only active so long as the heartbeat pattern of its user remains active, preventing secondary use of the military garments. As each heartbeat pattern is unique, the garment can be specially coded to detect if that signature is no longer available. Also special codes can be transmitted over the modulated optical exterior, such as indicating captured, emergency, and other situations. The imaging system can display the information collected over the secure visual data communication method to enhance depicting whether forces are friend or foe to reduce the likelihood of friendly fire incidents.

(9) Communication of vector information from other friendly sources. All of the data collected by the system can be communication through command and control for battlefield control purposes. Furthermore, the data collection can be shared by the system with other friendly units, thereby pooling the information which is being collected on enemy positions, firing patterns and so forth. The system is also configured to perform data extraction from the additional data sources, wherein enemy positions can be more accurately determined, vectors more accurately displayed, movement information determined with increased accuracy, and so forth.

Vectors and other important locations (i.e., muzzle flashes etc.) are displayed in relation to the real time view (such as a transparent display overlay) over displayed over an image of the background. The vectors are preferably displayed at a conventional framing rate, such as approximately 30-60 frames per second with the vectors and flashes and other detected events marked for easy identification by the user. The display is configured to automatically adjust in response to angular motion (i.e. head panning and tilting) of the point of reference, wherein a virtual sensory experience is created with the view enhanced by programming within the computer that displays vectors, elements, and historical information which increase user awareness of battlefield situation. The system is also preferably configured to compensate for movement of the point of reference (i.e. when walking, crawling, running, or motion caused from a moving platform).

1.4 Example Embodiments of Drawings.

FIG. 1 illustrates by way of example an vector projecting very fast image capture system 10 according to the present invention. Input is received from at least one imager 12a, 12b, 12c (three shown by way of example). Images are preferably processed locally by CPUs 14a, 14b, 14c having fast buffers for processing current image against prior images, configured for manipulating the images and extracting very fast image feature information. The CPUs may comprise processors of conventional architectures (CISC), comprise other forms of processing elements (RISC, DSP, Neural processing, simulated neural processing), include image processing specific digital and analog circuits (i.e. ASICs and discrete circuits), and combinations thereof. It will be appreciated that typically digital implementations having an at least an image processing core which is not subject to the need for fetching and executing microcoded instructions can perform faster than programmatic cores.

The feature extraction software which executes on the local CPU 14 and buffer can be configured in a similar manner as video encoders, such as MPEG-2. Extraction is preferably performed frame by frame, and it assumed that the pan tilting of the imager is constrained to a value less (typically substantially less) than the motion of the very high speed objects being detected.

Flash events are discerned. Substantial changes that arise between high speed are considered as flash events. These events typically move near the BG vector velocity, when moving quickly they would be picked up as a VFM element instead of a flash. Substantial image changes frame-to-frame are marked. Optionally a select number of flash events can be identified, such as muzzle flashes. Identification can be performed by pattern matching techniques and/or signature processes, which can make use of intensity, shape, rate of change, color, and infrared (i.e. near IR) information is available. Image portions of the flash event can be stored as an event icon, either as a single image portion, a series of image portions, or a video clip. It is preferred that at least two image portions be saved for a given flash event, preferably the image portions would include the flash when most visible, such as when expanded to largest extent) along with another portion taken at either an earlier stage or a later stage. The extraction can track the size changes of an identified flash event and determine a life span of the flash event. The preferably one or two image portions saved for the flash event are preferably selected from all those that arrive over the course of the flash event. Flash events are also preferably marked for being examined first or more carefully for VFM.

Flash background image. During a flash event such as a muzzle flash, explosion and so forth, often the light created illuminates enemy positions, equipment, and so forth. Unfortunately, since a flash such as an explosion occurs rapidly and is very intense it is difficult for a human to assess all the available information available. One mode of the system extracts additional information from the areas of the images that were made more visible by the flash. The system preferably annunciates this information to the user, in one or more of the following ways, or similar. Saves the portions of the image lit by the flash event preferably at lower intensity for display. Features extraction wherein the edges of all items or those deemed most important (i.e. having the sharp edges of equipment and persons), or which are not moving with the background.

VFM elements are discerned from objects. A background motion vector is determined (BG) in comparing current frame with previous frames. All image details are compared with a prior frame and only elements having a vector that sufficiently diverges from the BG vector are considered as a possible VFM object, unless they are emanating from a flash event. When a flash event arises, the image processing is preferably performed more readily and carefully near where the flash event is arising. Additionally more careful VFM detection can be performed near the center of field of view corresponding to the user location, so that incoming VFM occurs the most readily and accurately, thereby reducing probably casualties.

A distance detection means 16, such as an encoded (signal modulated at high frequency on the order of mHz) targeting laser with backscatter (reflection) detector which determines “time of flight” from the time the signal is transmitted until its reflection is registered in the backscatter. This distance information is preferably displayed on a portion of the image providing additional information to the user. The distance information is also preferably utilized in the system for processing portions of the images being painted by the target laser. The tactical laser output is preferably also modulated with a lower frequency, such as on the order of 10-1000 Hz, so that the modulation pattern of the backscatter can be detected by the very high speed imaging system. This can be accomplished by modulating with first signal at the high rate and then turning on and off the laser output at the lower modulation, the distance sensing is performed during the active bursts while the low frequency modulation carries the unit identifier information (i.e. 4-8 should be sufficient for generally discerning a single unit within a group of allies working with one another although a deeper bit encoding may be utilized). This allows the software to mark the painted target for the user, such as encircling the painted on mark (which may be invisible to the eye if directed away from the visible spectrum (i.e. UV or IR), allowing to discern their own target from those of allied combatants painting nearby targets.

Acoustic sensors 18a-18c are depicted for collecting acoustic information, such as for use in combination with the imagers for more precisely locating where to return fire on enemy locations. Acoustic information can be utilized in concert with flash information of VFM information to more accurately locate the enemy. The differential between projectile velocity, time of flash occurrence, and audio signature can narrow down location. Furthermore, audio signature can be processed for angle off of target information, location of target when multiple acoustic sensors, deployed and for estimating the position of snipers and other hidden enemies where flashes and VFm are not visible.

After processing is performed for VFM and other fast moving events, the event data and baseline image is loaded into a display memory 20, such as at a rate compatible with the display. A portion 20a of the display memory is preferably for retaining image information frames, while a second portions 20b retains vector information and sprites based on the extracted data, which is to displayed and refreshed over the display over a period of time. For example a VFM vector is given, which is painted over proper sections of the display to show line of movement, and which is refreshed periodically, but preferably with lowered intensity and optionally color as the time from the event extends out, until the vector is no longer shown.

One method of allowing the user to selectively eliminate the display of older data is to erase vectors from the shared memory when these vectors no longer exist in the current field of view. This eliminates the annoyance factor and memory requirements when an individual is moving readily, and allows a steady individual to simply look away, such as down or to the side (presuming imaging component(s) mounted on face shield display) to essentially reset the displayed vectors.

The system is preferably configured with a means for providing external communication, such as controlled by computer 22, and a means for collecting perspective information such as comprising compass 24, tilt sensor 26, global positioning system (GPS) and/or inertial navigation system (INS) 28. Information about the local terrain and conditions, which can aid in affixing viewer perspective may be retained in a database 30 for the system. Information from database 30 is preferably utilized for ascertaining user perspective and to allow the system to delineate objects and terrain that are not visible to the individual at the time, such as objects hidden behind terrain, buildings, terrain features, wiring and so forth. Select data from the database can be displayed in a number of alternative ways, a preferred way involves displaying edges of important features, which may be shown in hidden lines when behind other objects and so forth. Although the user can not literally “see” through obstructions for detecting moving targets, they are provided with a perspective on the positioning of terrain, building and somewhat static elements in response to map data collected previously and from other angles. CPU 22 processes the database information electing what to display from the current view based on user settings.

Data to and from this user to other allies and control facilities is preferably provided by a secure communication link 32, which has access to vector generation data both from the imagers, audio registration system, as well as perspective information.

The principle output is the system is preferably and augmented viewing display 36 controlled by a controller 34, wherein the user can view real time events with near real time VFM vectors and other augmentation described above. The display preferably comprises a head mounted device, or a ocular device. One preferred method of implementation is with a retinal scanning laser device, such as directing one or more colored beams via a micromirror into the retina of the user, wherein their actual visual perception is thus augmented by the retina scanned light. The retina scanner is preferably utilized in a vector mode, wherein more rapid updating of important elements within the view is accomplished and less impact arises on areas of view which are not being augmented. The augmented view provided by a retina scan system preferably incorporates highlighting of elements which are detected by an infrared detector, wherein the view of these items is enhanced without the necessity of painting an entire display screen. Alternatively a full display screen may be utilized, or a single eye piece, head-up style display, or similar in which the entire scene with augmentation is directed at the semi-transparent to opaque display.

Additional inputs may be provided into the system to register the state of the user, as well as registering information about their combat gear, ammunition and so forth. By way of example, a blood pressure cuff 40 with pressure sensor 42, brain wave sensor 44, and audio microphone input 46 are shown for registering information about the user. It will be appreciated that other sensors may be incorporated, such as any of the following: blood levels (i.e. adrenaline), perspiration, and so forth. Additionally sensors can be incorporated for tracking the equipment on the user and the state of that equipment. For example equipment that cannot be readily tethered to the system with communication wiring may be configured with wireless communication links, such as passive transponders which encode selected information from the device in response to a challenge as described in another patent application of the inventor.

1.4.1 Tactile Output.

The system can be configured with an optional tactile outputs, such as for directing the motion of individuals away from incoming VFM. It will be appreciated that although VFM vectors can be displayed at near real time, the user still must interpret the displayed images to determine which way to move to avoid being hit by a round in a automatic weapon spray string. Although it is doubtful that a user can move rapidly enough to avoid a head-on round, the system can determine a danger zone based on a first imaged round and increase the accuracy of predicting the danger areas when registering automatic firing bursts. By way of example a projective, electric shock, or acoustic stimulator (electrodes) elements may be coupled to portions of the user's body (i.e. upper arms, back of the neck) wherein these stimulators are activated to direct the user to move right, left, or down in response to system detecting VFM, and VFM pattern activity. This is depicted as a tactile feedback control interface 48 to which are coupled three tactile output devices 50.

2 Fau-Tactical Position Indicators and Markers.

2.1 Problem Description.

Military battle scenarios require that one garnish every available tactical advantage which requires utilizing technology to its fullest to detect, confuse and distract the enemy toward finally disabling their capability to wage war.

2.2 Overview.

An inexpensive fau-tactical device to confuse an enemy as to the strength and position of friendly forces. We (allies) typically have command & control advantage. We can push that advantage by pushing situational complexity at the enemy to confuse and immobilize them. With numerous weapon systems and now the addition of simulated weapons and presence another step to victory is provided. A preferred embodiment can provide additional intelligence, or even minor levels of firepower, to further confuse the enemy. This invention can provide a subset of the functionality of that described above for the “Visual Vector Display Generation of Very Fast Moving Elements”.

2.3 Example Embodiments.

In a first embodiment the device is configured to mimic the presence of troops to confuse the enemy as to the presence and/or size of a squad, troop or other contingent of forces. The unit contains a computer control element, such as a microcontroller circuit wherein it may autonomously generate outputs, or outputs in response to sensory inputs. Also it can be optionally configured for having some or all of its functionality controlled by an external remote control device.

FIG. 2 illustrates an example Fau-Tac device 10 with housing 12, shown in a spherical configuration allowing the unit to be thrown to a desired location. The unit may be configured in any desired shape, other shapes may facilitate the unit being carried, or to enhance some aspect of the unit, such as frontal area and so forth.

Light outputs 14 may comprise LED or solid state lasers, or other conventional light sources, these may be configured for a single light or more preferably contain multiple color die to allow the unit to generate white light and light in desired ranges of color. Wherein lighting may include at least one laser device configured to emit a directed beam of light, such as a directed beam to simulate a laser sighting beam.

Audio input/output ports 16 are shown as apertures into the housing, through which audio generated from within the housing, is dispersed. Also ambient audio can be detected from the environment through input ports 16 from the environment.

At least one optical sensor 18 is shown, which may comprise light intensity detection, intensity and color detection, or a camera having providing still or video framing with a desired number of pixels. An image sensor can be incorporated which in combination with the controller is preferably configured for optically detecting activity in the field of view, using conventional signal processing, DSP chips, or electronic neural mechanisms (simulated or neural based processors).

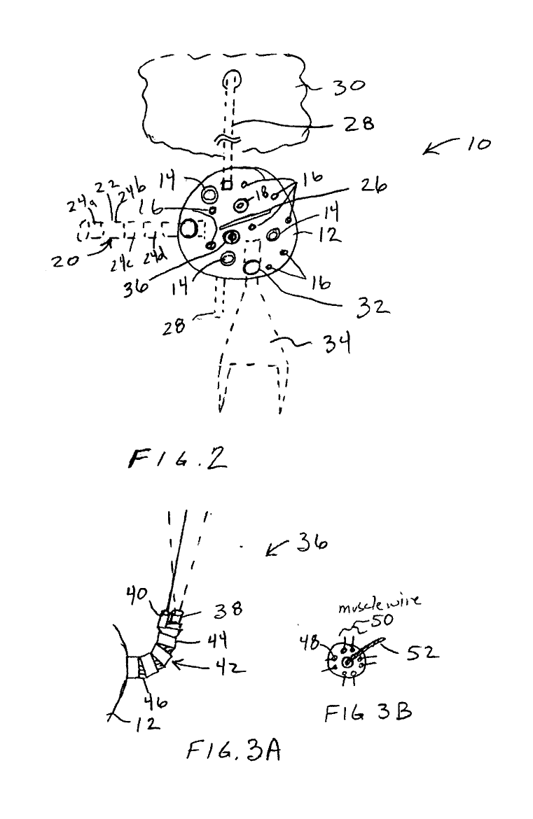

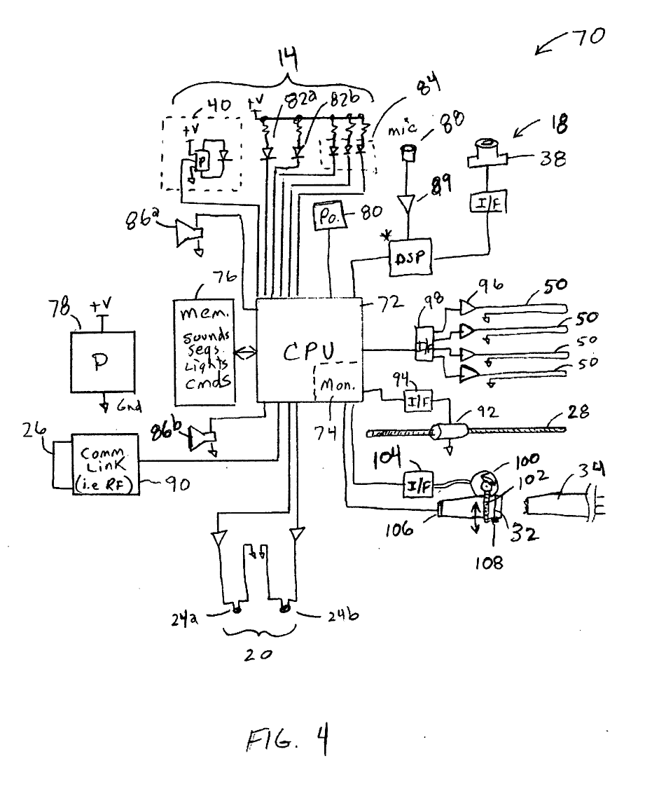

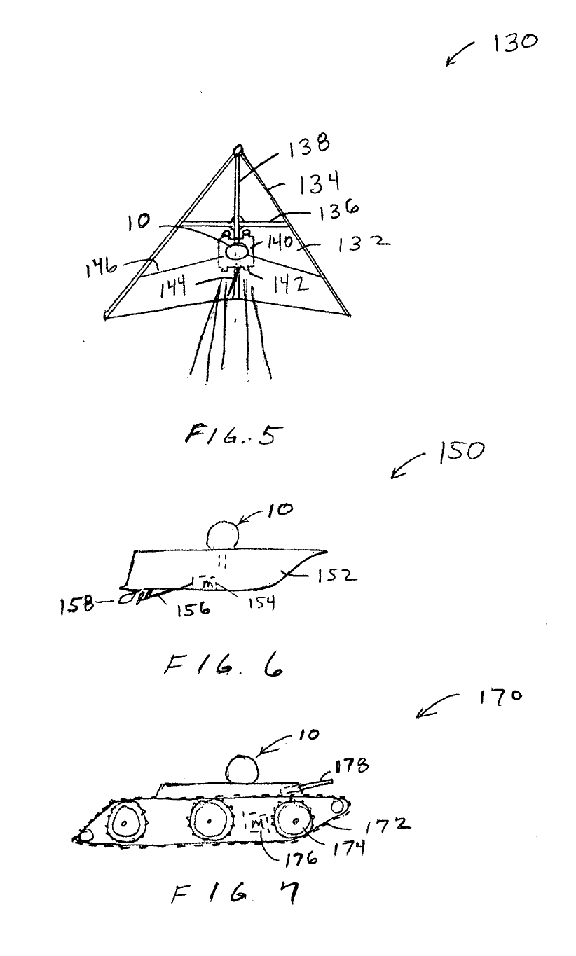

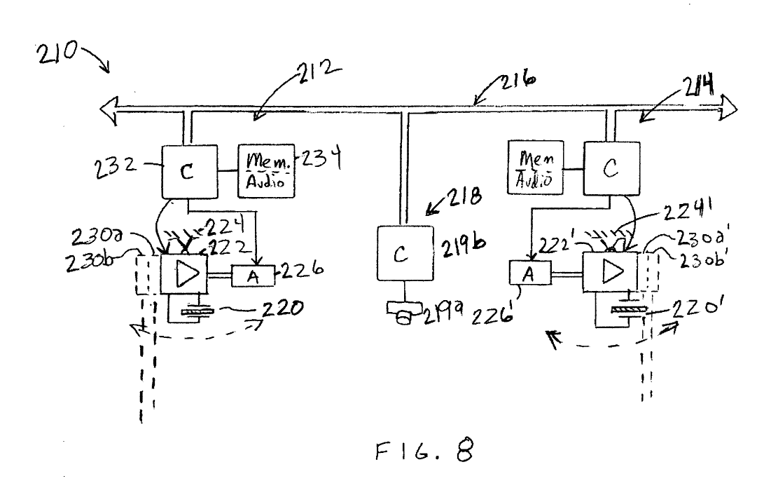

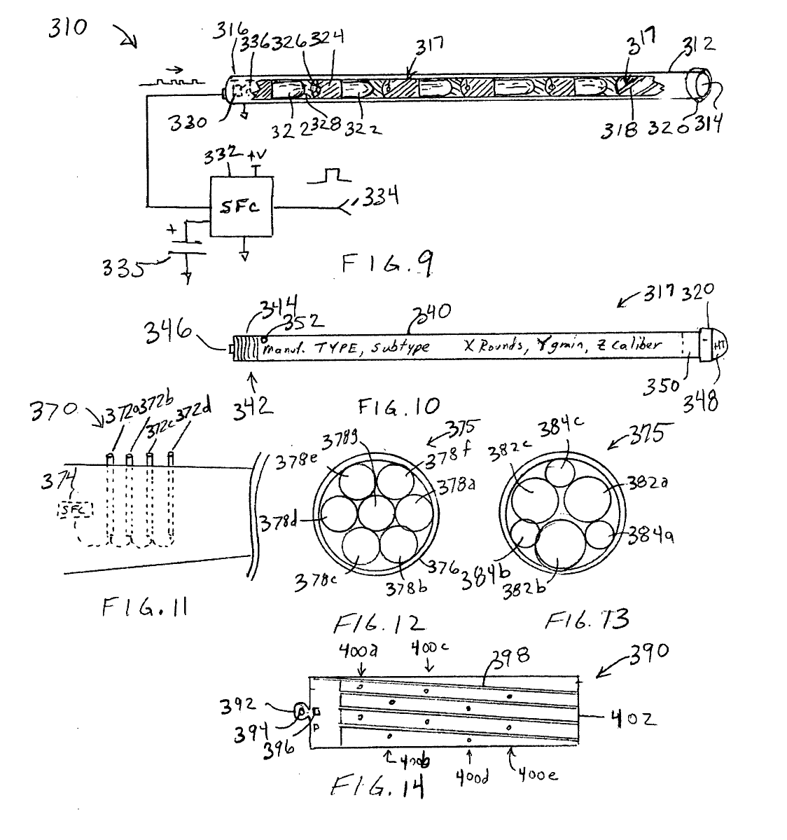

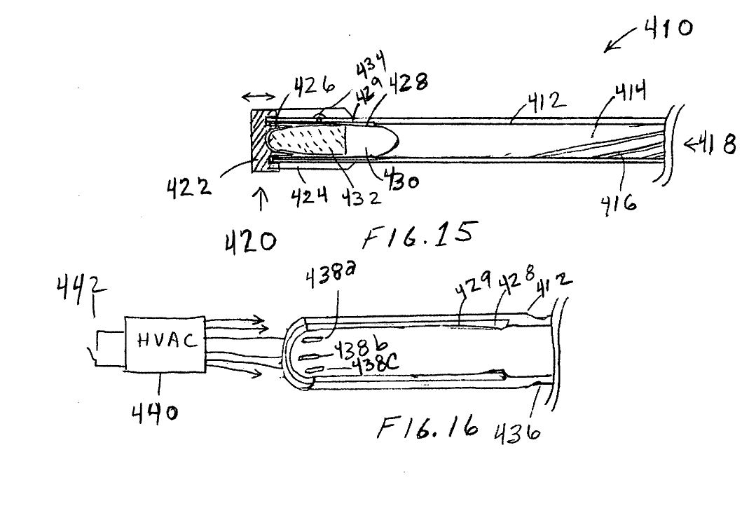

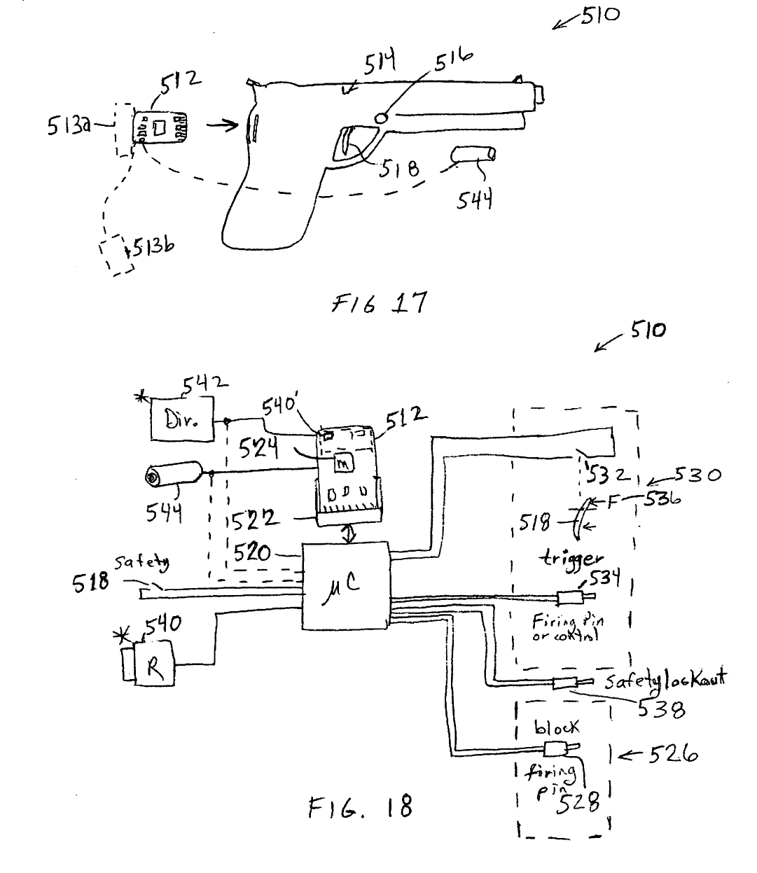

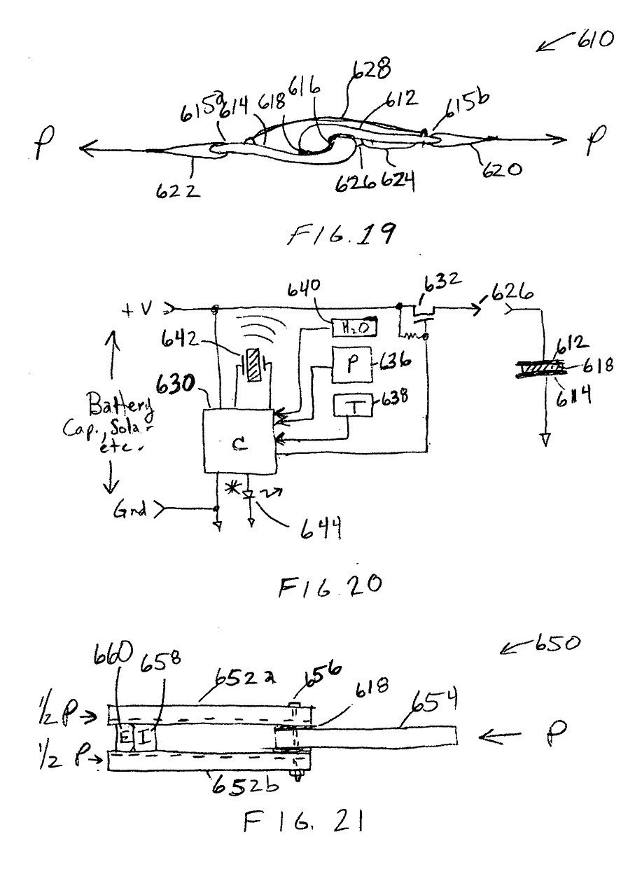

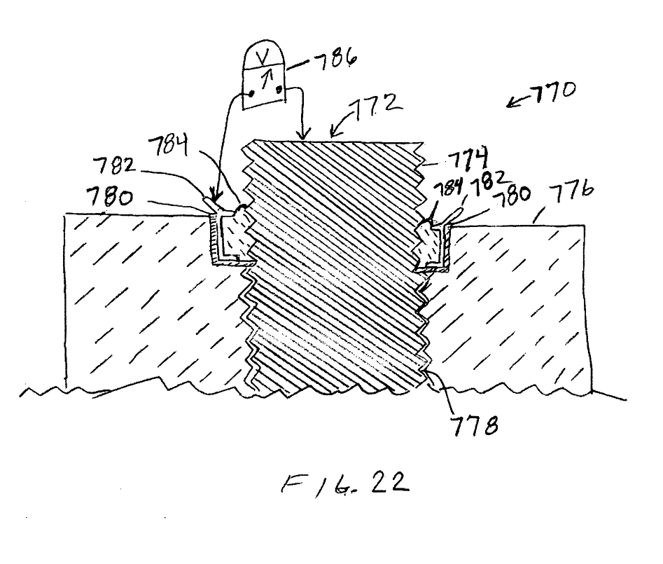

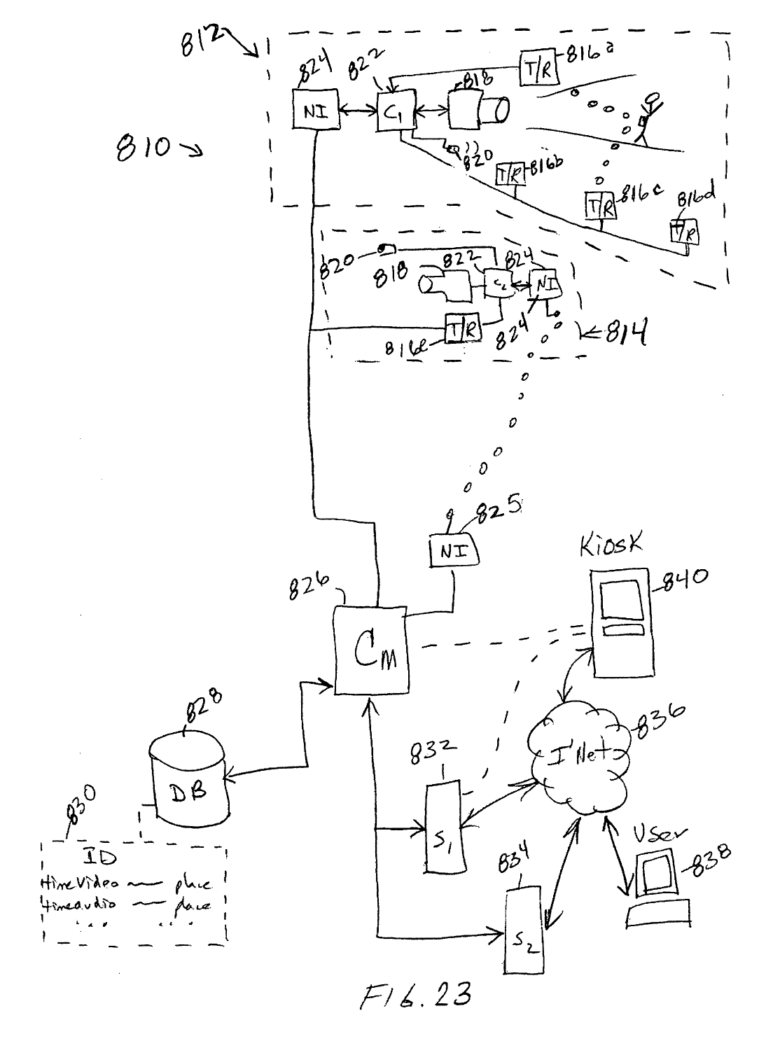

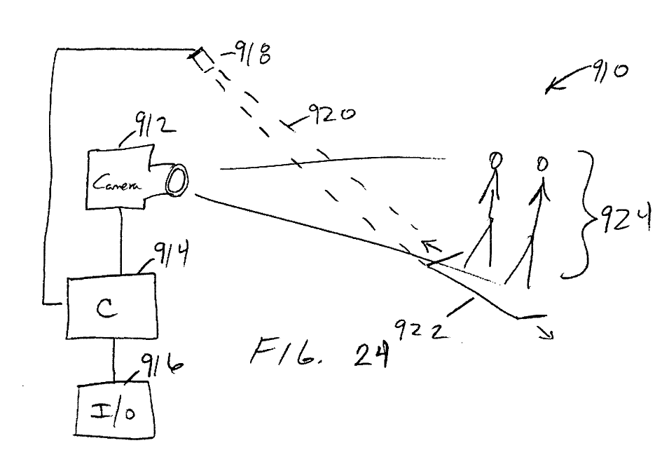

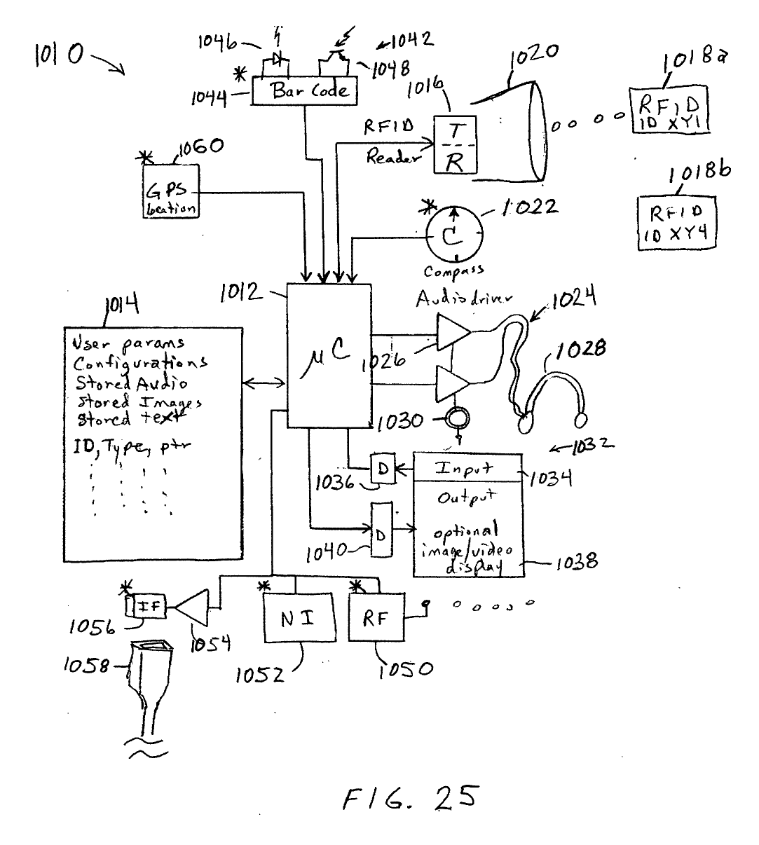

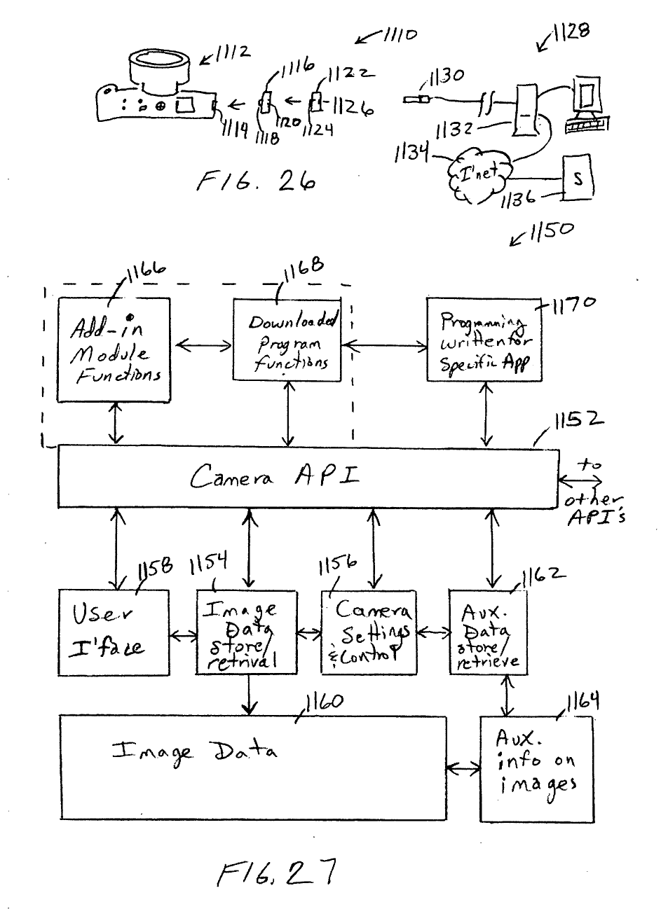

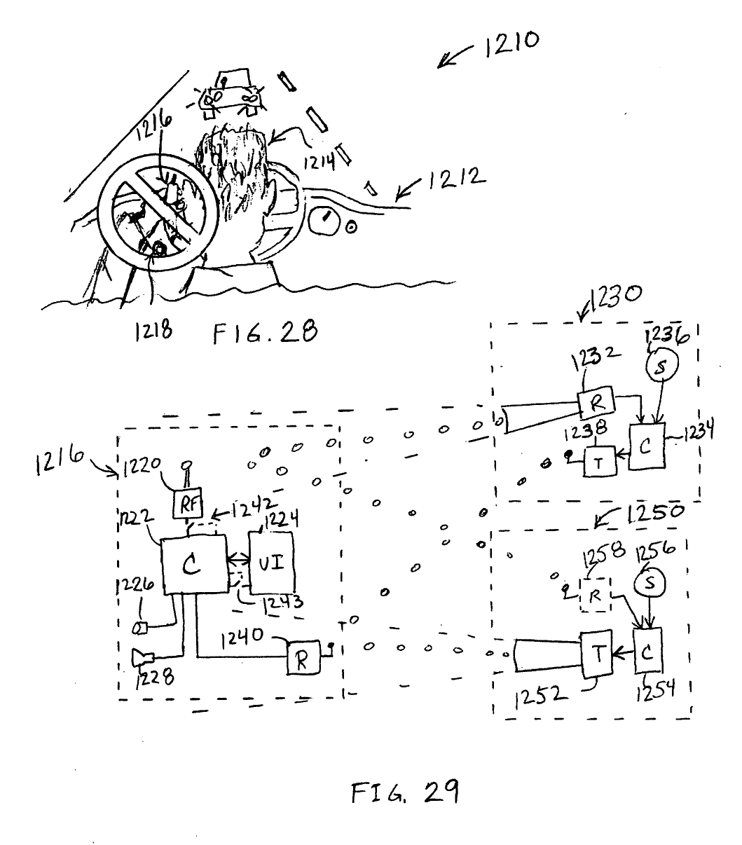

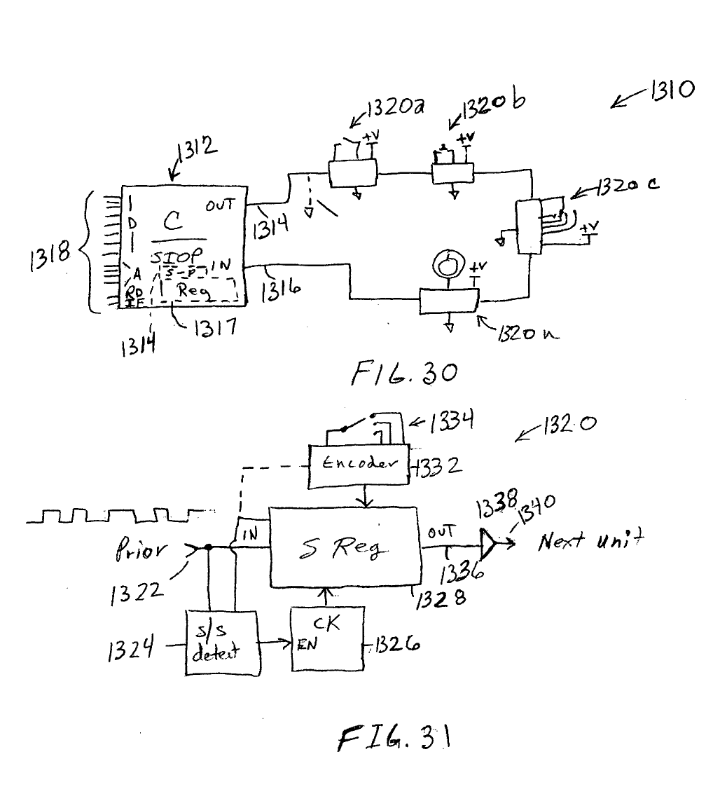

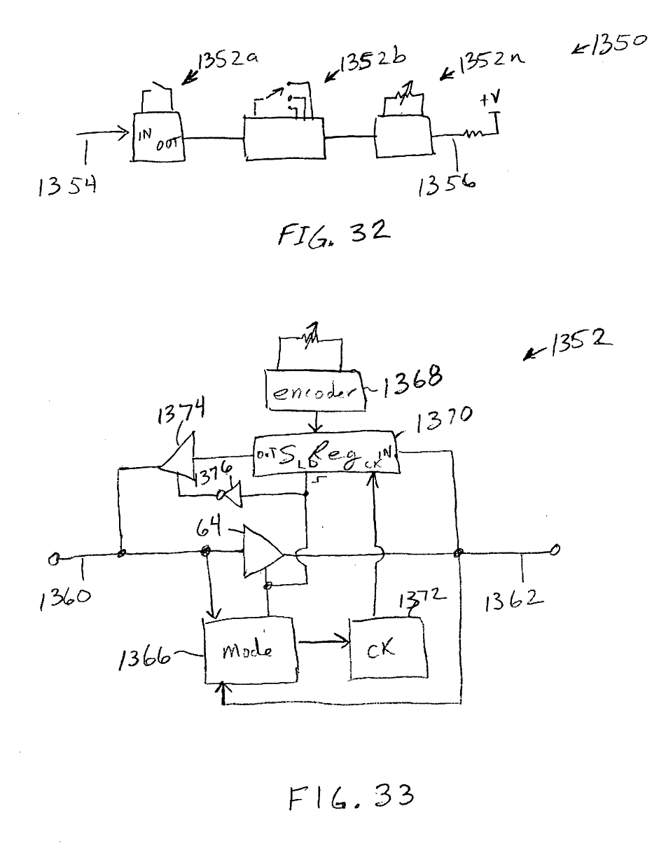

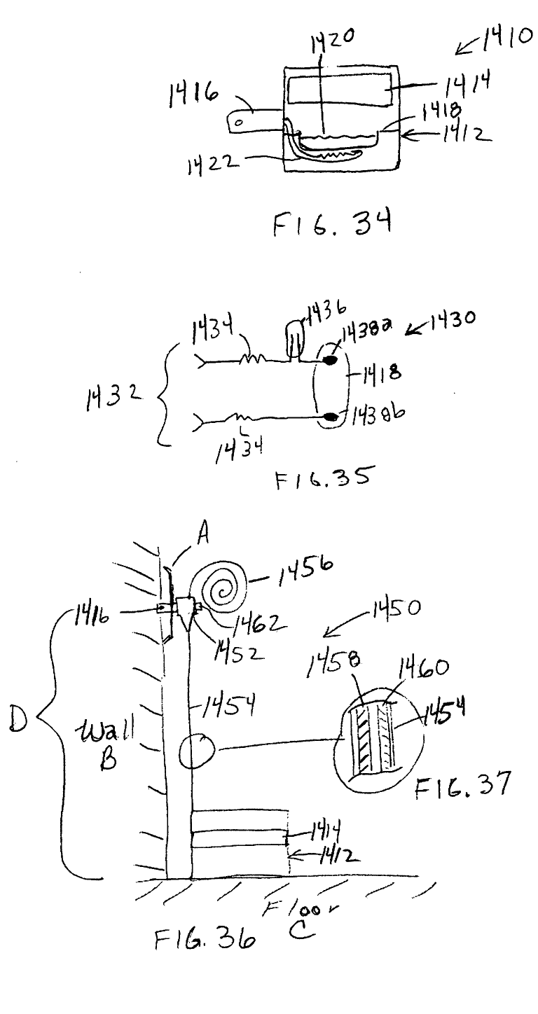

FIGS. 3A and 3B depict an image sensor 38 and a laser 40 coupled to one another focused in the same direction and connected to a motion stage 42, wherein the laser can be directed automatically to positions where activity is detected. The stage may comprise a conventional motion stage, or more preferably comprises a compliant tubular structure 42 that is flexed in response to expanding or contracting segments of muscle wire, as described in another application by said applicant. A series of beads 44 are alternated with compliant elements (may be a part of the beads). The beads and compliant elements 46 have holes 48 through which muscle wire 50 is passed, for example four pairs of holes about the perimeter, as shown in FIG. 3B. Loops of muscle wire (i.e. nitinol or more preferably newer polymeric muscle wire) extend from the unit toward the camera-lighting tip and back down to the base. Passing a current through the wire causes it to contract thereby shortening that side of the tubular structure causing it to flex. Passing current though all wires causes the entire structure to shrink somewhat. A central hole allows wires for control signals to pass through the tubular structure to the devices at the end, in this case the laser and camera. Control by the CPU is shown in FIG. 4 with an interface circuit 98 shown coupled to the CPU for controlling the outputs of drive circuits 96 to control the movement of the motion stage in response to muscle wire 50 activations.

The above description considers the use of muscle wire fibers which shrink in response to the application of current, however a recently demonstrated polymeric muscle wire fiber actually stretches in response to the application of a sufficient electrical current. It should be appreciated that the stretching muscle wire fiber may be utilized in the same embodiments as the shrinking muscle wire fiber, however, its contracted and expanded phases are simply reversed in relation to the application of current. For example in the above example of the “beaded” flexing motion stage, the use of this new polymeric muscle wire fiber would mean the device in a default state would be scrunched up in a straight line with all fibers in tension. Application of current to muscle fibers on any side of the unit would result in deflecting the motion stage toward that side, applying current to a combination of two sides allows a deflection between those sides, while applying current to all muscle wires would allow the unit to go limp, wherein gravity or other applicable forces (or positioning just prior to applying current to all muscle wires) could dictate the direction of flexure.

The controller can therefore scan a given field of view and direct images as desired back to friendly personnel. Furthermore, upon detecting movement or other selected conditions, the image centers the motion in its field of view and then can activate the laser (i.e. periodically) to sight the elements in view, causing a huge distraction to the enemy who knows he's been seen and whose presence is being further marked by the laser light to friendlies nearby that can pick off the laser marked target. Furthermore, the Fau-Tac device can provide for automatically laser marking of targets for airborne tactical strikes, such as laser guided munitions. In this way the laser alerts friendly parties to the position of the moving enemy personnel while distracting them.

Electronically fired explosive charges 20, depicted as a stick 22 which is coupled to the Fau-Tac unit 12, such as by threaded connector. The controller can then ignite the charges to generate desired sound effects. This unit may be implemented in a similar manner to that described for electronically discharging a sequence of bullets as described elsewhere in the present application. However, in this case the stick could be configured without a projectiles so that only sound is generated. The electronically ignited charges can comprise: a plurality of small explosive charges configured to simulate small arms fire; electrically activated igniter; and a base plate to which said charges and igniters are coupled; wherein said base plate is configured with an electrical connector for electrically coupling said base plate with electronically charges to said electronic controller. The small explosive charges may comprise blank bullets configured for being electronically triggered. Alternatively, the electronically ignited charges may comprise a plurality of semiconductor based igniters fabricated on a substrate over which small explosive charges are disposed to simulate small arms fire.

An antenna 26 is shown for allowing the Fau-Tac unit to communicate with other Fau-Tac units, or other friendly devices, as well as for communicating to friendly personnel transmitting collected audio, vibration, and/or image data and for receiving control commands. The communications are preferably wideband dispersed transmissions or encoded in some manner to prevent enemy tampering.

A mechanical member 28 is shown attached to a deployable member 30, here depicted as a decay image, profile, or other visually apparent element (2D or 3D). The deployable member 30 may comprise a decoy element to be seen by the enemy, such as a helmet image, or other image. Alternatively, the deployable element may comprise an active element, such as a microphone, camera, light output element, sound output element, and so forth.

The Fau-Tac unit can be configured for deployment in a steady or modulated position. A base 34 can be attached to the housing, such as into a receptacle 32. In addition, receptacle 32 may be configured to allow for rotation of the Fau-Tac unit about the inserted portion of base 34. This provides for increased opportunities for sensing and to generate output over a range of directions. It should also be appreciated that the unit can be adapted for use on a mobile platform base, providing additional mobility. The mobile platform base being preferably configured with a control stalk (or other wired connectivity receptacle) for receiving the Fau-Tac unit. Upon coupling the Fau-Tac unit to the base, or to other forms of devices, the controller within the Fau-Tac unit automatically detects the presence of the base and adds the functionality of the base or other unit to its repertoire. In this example, the unit accepts mobility related commands.

FIG. 4 depicts a block diagram of a circuit 70 for an implementation of the Fau-Tac unit as described, it should be appreciated that the unit may be implemented with one or all features described, which may be used in combination with conventional elements without departing from the teachings of the present invention. An electronic controller 72 is configured for controlling all aspects of the operation of the Fau-Tac device. An on-chip monitoring circuit 74 is preferably incorporated into the controller which typically provides less processing power than the main controller and monitors the inputs and outputs from the controller and the executed program stream to detect errant operation, wherein it can itself take over control in a limited fashion, so as to decrease the likelihood a faulty CPU. A memory 76 coupled to the CPU 72 may comprise any desired form of memory and may include mass storage elements. Various sound sequences, as well as light pattern outputs, as well as communication related information (codes, encryption info) is preferably retained therein as well as the programming for operating the Fau-Tac unit including any optional items.

Power is supplied to all elements in the Fau-Tac unit by a preferably replicable power module 78, such as a battery or fuel cell. All possible operating power can thus be removed the Fau-Tac unit until it is put into service—in this way the unit is wholly unable to activate undesired elements prior to insertion of the battery. In addition the monitor circuit can be configured to provide a fail safe for the device, wherein all actions of the device except for those considered as user feedback, are locked out until a diagnostic is run after power up, followed by receipt of user control input.

Position sensing 80 may be incorporated within the Fau-Tac unit for determining how the unit is positioned (i.e. which side is up) and may further include the ability to generate position information, such as coordinates, or changes thereof, to the controller. Positioning information may be derived from one or more sources, such as Global Positioning (GPS), Differential GPS, Inertial Navigation Systems (INS), tilt, compass heading, acceleration, and other known means of detecting an absolute and/or relative position.

The unit is preferably configured with a plurality of lights 14 for providing different lighting effects and/or different directions. These may be LEDs 82a, 82b, multielement LEDs 84, laser light 40, or other forms of electrical lighting (i.e. electroluminescent, incandescent) or chemically derived lighting (i.e. similar to a light stick, or chemical reaction flash).

The unit can generate the sounds to mimic troop contingents, vehicles, or other sounds for confusing the enemy. The audio output can comprise recorded sounds which are indicative of conversations and the sounds of personnel, these may be in the form of computer generated speech and sounds. These sounds may be stored as audio sequences or control parameters for a synthesizing sounds within the unit. In either case the information for controlling these audio sounds will be referred to herein as a repository of audio sound effects, and typically would be expected to comprise audio, such as noises, murmuring, conversations and so forth, which may be output through a specific transducer 86a on the exterior of the unit, or output through apertures 16, or sealed compliant ports, to the interior of the unit where audio transducers are mounted. Any form of audio transducer may be utilized, but the tradeoffs must be considered. Present piezoelectric transducers are small, robust and efficient; however they produce less realism due to a very limited frequency response characteristic.

It should be appreciated that multiple audio transducers 86a, 86b may be supported to increase the amplitude, frequency response, or other characteristics of the audio output.

One anticipated audio configuration is that of using multiple ultrasonic transducers (preferably separated from one another and directed to overlap at a given range). The sound to be heard is encoded as a beat frequency (difference in frequencies between the first and second transducer) wherein the encoded audio can only be heard at the overlap of the ultrasonic audio outputs which are highly directional in nature. It will be appreciated that sounds from the unit can be generated so that they are only heard in select areas. For example, the Fau-Tac unit can be set to alert friendly personal with an audio output that is directed rearwardly as the overlap between the ultrasonic audio signals, wherein other personnel are unable to hear the sounds. This can also be directed toward an enemy although the close distances within a single Fau-Tac can increase the difficulty of creating an overlap at a desired position and range. By incorporating an actuator for modulating the direction of the ultrasonic transducers, the Fau-Tac unit can select where to direct selected sounds, allowing one party in the enemy ranks to hear one thing while another hears nothing at all or something else; providing further confusion to the enemy.

One mechanism for providing spatial separation between the ultrasonic transducers involves implementing a first and second device each having the capability to at least generate ultrasonics in at least one selected direction. These units are spatially separated and configured to communicate with one another via spread spectrum, conventional RF, magnetic field communication, electric field coupling, optical communication, wired communication and other conventional means of communicating data between the first and second unit. One unit, typically the one wanting to initiate creating a sound at a specific position and distance, communicates a command to the second unit as to the direction (i.e. compass direction, tilt, or actual coordinates), and preferably the frequency of the sound (unless a known fixed frequency or pattern is already known to the other unit), also a time duration of the sound can be programmed, otherwise they operate in a turn on-turn off mode. The initiating unit then generates the complementary sound with embedded beat frequency to intercept the first unit at a desired location. In this way the unit can communicate secretly to either friend or foe, providing a number of benefits. It should be appreciated that the above may be implemented between Fau-Tac units, but may also be implemented between any two points under friendly control, such as armored vehicle units, field personnel, robotic vehicles, and the like, without departing from the teachings of the present invention. This aspect is described in greater detail in the section entitled “distributed ultrasonic transducer array”.

An optical sensor 18 for detecting sudden changes in available lighting which can indicate the proximity of personnel and vehicles is preferably provided, if it is desired to sense light changes. The optical sensor may comprise either discrete single element detectors, clusters of detectors, or utilize imaging units configured for capturing still or video images for processing by the unit and/or for communication to remote parties. The controller 72 receives the signal from the optical sensor and is preferably configured to generate output effects, in particular changing output light levels, in response to the ambient lighting or changes in ambient lighting, whereby lighting effects are displayed properly despite changes in lighting, such as being partially dimmed in response to darkness, or deactivated in bright light if they could not be seen anyway. An optical sensor, such as imaging sensor 18, may be coupled to a controllable stage for directing the direction of image collection. By way of example and not limitation one form of articulated stage is depicted as being driven by four muscle wire loops 50, driven by amplifiers 96 through interface 98.

An acoustic sensor 88 with conditioning and amplification circuitry 89 is configured to receive sound from the external environment, such as mounted on the housing of the device or interior of the housing and receiving sounds through the housing, such as through audio ports 16. This enables registering acoustic events and generated signals to the controller, wherein the controller can alter output effects in response to the detected sounds.

The controller 72 is configured for controlling the ignition of optional electronically ignited explosive charges 20, or ammunition rounds 20, which can be set off periodically, randomly, by remote control, or in response to events such as acoustical, visual images, vibration (i.e. moving personnel or vehicles), and so forth. These charges can be used to simulate personnel, or live rounds utilized for laying down fire towards a desired direction. Controller 72 is preferably configured to respond to select detected acoustic or ambient lighting events by igniting one or more explosive charges 24a, 24b.

Furthermore, the explosive charges can be utilized for propelling the unit to another location, albeit a short distance from its current position. Explosive charges configured for repositioning the unit preferably burn over a longer period of time with a high gaseous discharge consistent with solid fuel propellant systems. In one embodiment (not shown) the explosive/rocket charges are retained primarily within the housing wherein the unit containing the charges is still capable of rolling. For example an explosive tube can be coupled to the unit by inserting the bulk of it into a recess in the housing adapted to receive the charge. Use of rocket charges or explosives can provide one simple form of drive mechanism, although it will be appreciated that controlling positioning becomes an issue unless the unit is configured with aerodynamic lifting body and flight controls, as described in a later embodiment.

At least one transceiver 90 in the Fau-Tac unit allows it to communicate with other units, other friendly devices, and friendly personnel. The transceiver may utilize an antenna such as antenna 26 shown on the exterior of the housing. The transceiver allows a number of Fau-Tacs to coordinate (synchronize) their output effects to generate a more natural simulation of personnel, or to otherwise increase effectiveness. For example one Fau-Tac may be operational while adjacent units are in a standby mode, and return to operational mode when the operational Fau-Tac unit generates a signal to awaken the other units.

Controller 72 (although multiple controller could be utilized) is preferably configured to receive radio commands (or magnetic field communications, optical communications, and so forth) for controlling the output effects of said Fau-Tac apparatus. Commands received by the controller allow for regulating the intensity and patterns of output lighting and sounds. A specially encoded self-destruct signal can be received which causes the controller to disable the electronic components and usable parts of the apparatus, preferably without posing a serious risk to personnel. Small explosive charges can be activated within the integrated circuits or other components within the present invention. Therefore, the disabling of the device can be caused by electrically activating a plurality of very small cap charges located within or proximal to integrated circuits, select board traces, electromechanical devices, sensors, and combinations thereof.

The controller may control the output of simulation events by initializing the output effects to a substantially random event seed and then providing output event thresholds which are modulated in response to inputs from acoustic and lighting sensors.

One or more actuators 92 preferably controlled through a drive interface 94 within the unit allow for controlling the deployment of deployable element 30 attached to mechanical member 28. The controller selectively deploys element 30 in response to events, time and/or received signals.

Another movement mechanism is depicted as a rotating coupling 32 into which a portion of a external stalk 34, coupling and so forth is connected. Rotation of coupling 32 is shown by way of an actuator 100 (i.e. motor with gearhead) whose output is preferably directed to gears 102 for rotating the Fac-Tac in relation to a fixed stalk 34, or moving a movable stalk 34 in relation to the Fau-Tac device. A drive interface 104 is shown for directing the motion of actuator 100. An electrical connection 106 is preferably configured establishing electrical connection with stalk 34, for example to operate electronics coupled to the stalk. A locking pin 108 or similar locking means is preferably coupled to the rotating coupled to prevent disengagement of the stalk. The Fau-Tac unit can be configured for deployment in a steady or modulated position. A base 34 can be attached to the housing, such as into a receptacle 32. In addition, receptacle 32 may be configured to allow for rotation of the Fau-Tac unit about the inserted portion of base 34. This provides for increased opportunities for sensing and to generate output over a range of directions. The Fau-Tac unit is preferably configured so that it may be coupled to a movable platform, such as on land, water, or air. In one embodiment the Fau-Tac unit may be coupled to large items such as tanks, personnel carrying vehicles and the like, from configured with control couplings into which the Fau-Tac units may be connected. In a preferred embodiment the Fau-Tac units are configured for coupling to small robotic vehicles, such as airplanes, boats, or ground vehicle platforms. The Fau-Tac preferably provides the motion control intelligence, although the movable platform preferably provides its own controller for at least orchestrating movement functions and providing a simple control interface to the Fau-Tac unit, wherein the Fau-Tac need not understand the low level operating characteristics of the mobile platform, but can provide direction, speed, and other metrics for reaching a desired location, or moving about a perimeter, location and so forth.

FIG. 5-7 illustrate by way of example a Fau-Tac unit coupled to different mobile platforms. In FIG. 5 the Fau-Tac 10 is coupled to an airborne platform 130 shown implemented as a foldup Rogello style wing with covering 132, exterior supports 134 cross support 136 and a central support 138 upon which a mobile power and control module 140 is mounted. Wingspan of the platform is preferably 2-5 feet. The power and control module 140 is configured with a locomotion source, herein depicted as a pair of low thrust solid fuel rockets 142, for getting the unit over a target, for performing the functions previously described or to activate munitions. Flight control is provided by a rudder 144 and wing flexing controls 146. The Fau-Tac unit 10 is coupled to power and control module 140, wherein a Fau-Tac with the desired characteristics can be field assembled to a wing system for carrying out a desired mission.

FIG. 6 depicts coupling Fau-Tac 10 in a similar manner to a small boat 150 (1-3 feet in length) having a hull 152, motor drive 154, drive shaft and propeller 156 (or jet drive), and a rudder 158.

FIG. 7 depicts similarly the coupling of a Fau-Tac 10 to a land vehicle 170, herein depicted as a vehicle having tracks 172, although any means of conveyance over the ground may be utilized in conjunction with Fau-Tac unit 10. A motor 176, preferably a quit electric unit is provided for driving track cogs 174, or wheels. A munition 178 is shown preferably an electrically fired device having multiple rounds in a single chamber.

It should be appreciated that Fau-Tac unit 10 need not be configured in the spherical form depicted previously, but can be implemented in any convenient shape. The mobile Fau-Tac unit can provide for confusing enemy forces with lights, sounds, and its very presence and can provide for collecting intelligence. Furthermore, the unit can be configured with an explosive that is delivered by the mobile base to a target. Preferably, the unit performs its confusionary role while collecting intelligence, and then may switch to a munition role at the proper time to further confuse and/or strike at the enemy.

2.3.1 Alternative Embodiments—Intelligent Grenade.

A plurality of ammunition rounds, are coupled to a simple Fau-Tac unit, and/or a series of explosive charges facing in different directions, the unit can sense the proximity of personnel and can discharge the rounds/explosives accordingly. The unit preferably contains a large explosive that can be detonated in response to its detecting larger targets, expiration of a programmed time period, or activated in response to a remote control signal from friendly forces, or combinations thereof. The smaller explosive charges, which may be distributed on the outside of the unit, can be utilized for moving the unit into a new position or striking targets.

2.3.2 Alternative Embodiments—Electronically Ignited Flash Device.

Unit has sensory inputs, wherein upon detecting a sufficient provocation, such as detecting nearby personnel by visual, auditory, and/or vibration means, activates a flash output as a chemical explosive, a flash cube style flasher, or less preferably an electronic strobe.

2.3.3 Alternative Embodiments—Camera Spikes.

Communicate via RF, or passively in response to challenge signals. The camera is small and difficult to see from a distance. Personnel can use these in a handheld manner, or place them strategically to monitor activity while maintaining a secure position. Additionally, active camera spikes may be implemented according to the invention which can extend/retract between a first hidden position and a second raised position, and alternatively to positions in-between those two positions.

2.4 Conclusion.

Systems are described for increasing the confusion of enemy combatants as to position and strength of friendly forces. These systems can be deployed inexpensively in a variety of situations. Optional features provide for collecting intelligence on the enemy and small munition deployment.

3 Distributed Ultrasonic Transducer Array.

3.1 Problem Description.

Acoustics have traditionally exhibited limited directionality and severe attenuation over distance which has limited the effective use of it in many situations. A new technique has become available in the form of a multioutput ultrasonic acoustic array, wherein a beat frequency is encoded between at least two channels of ultrasonic acoustic output. The sound (encoded as the beat frequency) only being heard where the highly directional ultrasonic outputs overlap.

However, it has not been recognized in the industry that providing a wide range of overlap points particularly spanning over a large area (two dimensional plane, or three dimensional area) requires separation between the output arrays that is often not easily achieved.

Therefore, it will be appreciated that a need exists for a system and method for controlling the acoustic overlap between units spread over a distance. The present invention fulfills that need and overcomes a number of issues with implementing ultrasonic acoustic systems.

3.2 Overview.

One mechanism for providing spatial separation between the ultrasonic transducers involves implementing at least a first and second device each having the capability to generate ultrasonics in at least one selected direction (preprogrammed or actively selected). These units are spatially separated and configured with a synchronization mechanism for communicating with one another, such as via spread spectrum, conventional RF, magnetic field communication, electric field coupling, optical communication, wired communication and other conventional means of communicating data between the first and second unit.

One unit, typically the one wanting to initiate creating a sound at a specific position and distance, communicates a command to the second unit as to the direction (i.e. compass direction, tilt, or actual coordinates), and preferably the frequency of the sound (unless a known fixed frequency or pattern is already known to the other unit), also a time duration of the sound can be programmed, otherwise they operate in a turn on-turn off mode.

The initiating unit then generates the complementary sound with embedded beat frequency to intercept the first unit at a desired location. In this way the unit can communicate secretly to either friend or foe, providing a number of benefits. It should be appreciated that the above may be implemented between Fau-Tac units, but may also be implemented between any two points under friendly control, such as armored vehicle units, field personnel, robotic vehicles, and the like, without departing from the teachings of the present invention. This aspect is described in greater detail in the section entitled “distributed ultrasonic transducer array”.

Within environments in which communication over the channel(s) are either full, prone to drop outs, or otherwise unreliable; the commands controlling ultrasonic direction and output are communicated from said first unit to a second unit (or any additional units) and synchronized by an external synchronizing signal. One form of synchronizing signal is that of a clock signal derived from a Global Positioning System (GPS) which has high accuracy, other external signals such as generated by friendly equipment can also provide the clocking. Furthermore, the second unit can synchronize its output based on actual time coordinates (i.e. 23:04:02 hours) or time offsets in relation to the time at which the command was received (i.e. 10:00 minutes after command receipt).

3.3 Example Embodiments.

FIG. 8 depicts an example of a distributed acoustic modulation unit 210 according to the present invention. A first ultrasonic acoustic unit 212 is coupled to a remote second ultrasonic acoustic unit 214 over a means for communication, exemplified as a network connection 214. It should be appreciated that the units can communicate with wired connections of varied interfacing, wireless RF connections, magnetic field or electric field communication, optical communication, or any other convenient means of communicating data between units. Other units, similar to ultrasonic acoustic unit 212, 214, or providing other features, such as depicted by an imaging system 218 may be coupled to the system for collecting inputs or generating complementary outputs. By way of example the input may comprise a camera input 219a and control processor 219b; the processor may include digital signal processing or neural processing for performing image detection and correlation functions, wherein for example modulated reflected energy streams can be detected and/or images recognized or simply cleaned up and encoded for transmission. Furthermore, a control system (i.e. command and control center, apparatus control console, or the like) can be connected to the ultrasonic acoustic units and other input and output devices over the same or different communication channels.

Ultrasonic acoustic unit 212 is shown comprising an ultrasonic transducer 220 (plurality of associated transducers, or transducer array, configured for operating in unison and which may themselves comprise a subnet of the present invention) coupled to an electrical drive circuit 222. The unit may be established in a stationary configuration wherein the overlap with other units is provided in response to fixed locations, or in response to altering the direction of the other unit. Preferably, the unit is configured with a means for directing its output direction; for example as shown by rotatable coupling 224 (i.e. in one to three dimensions), controlled by an actuator 226 (i.e. one to three axis of motion).

Optionally an electromagnetic output and/or input, such as an optical light output and/or optical sensing unit 230a, 230b, are coupled to the ultrasonic acoustic assembly 220, 222, preferably having its output direction in a known relation to that of the acoustic assembly, such as coaxial, parallel, fixed skew, variable skew. The light output unit may comprise a laser source, or other preferably collimated source, for being directed to locations in relation to the ultrasonic acoustic output, such as for targeting the direction of the ultrasonic acoustic output. The frequency of the optical output may include the visible band, ultraviolet and/or infrared, wherein a range of condition sensing can be provided. The output may also comprise an RF source, such as microwave.

Optical inputs preferably provide a complementary input for sensing reflected output, although they may be utilized for sensing additional and/or alternative information in relation to the ultrasonic acoustic assembly. By way of example the input may comprise a single pixel optical detector, multipixel imaging device (i.e. camera), reflected RF energy detector, and so forth. The optical input may be shielded to detect optical energy received across a narrow angular spread, or more preferably it is configured to detect the received energy over a wider angular span, but allow for determining the relative position of the received energy within the field of view (i.e. camera and signal processing, multielement detectors, mirror arrays).

In one preferred embodiment the electromagnetic output and input comprise a means for detecting persons or objects in the field of view. For example, a laser source and an optical detector configured to detect the frequency and optionally any modulation of the laser output. Another example is that of an RF or optical radar, for detecting position and motion information for persons or objects within the field of view. It will be appreciated that the use of infrared can aid in discerning active elements (i.e. persons, moving vehicles, from background objects such as blowing trash, landscape elements and so forth).

It is contemplated that in applications wherein sufficiently high power ultrasonics are being generated, that a doppler imaging technique can be utilized for detecting ultrasonic and/or audible output, its reflection, and/or interaction with elements along its path, providing an accurate feedback mechanism.

The electromagnetic output and/or input can be utilized to aid in positioning the ultrasonic acoustic output, and/or for augmenting the output with RF and/or optical output.

In a preferred embodiment the electromagnetic output and/or input of one unit can be discerned by other units to aid in focusing the acoustic energy. Each unit is preferably modulated with an encoded security information (fixed or rolling codes etc.) along with a unit identifier that allows the source of the detected reflections to be determined by decoding the unit numbering, while preventing unfriendly interference.

For example a first ultrasonic acoustic unit generates a modulated laser output at a given frequency. The output is directed toward an object or area. Reflections of that signal from objects or terrain can be received by a second ultrasonic acoustic unit within its electromagnetic input. The second unit can find the reflected electromagnetic radiation by a scanning process or by other detecting reflected energy over a sufficient angular range. The second unit can then be repositioned to center the ultrasonic acoustic output in relation to the object reflecting the electromagnetic radiation, preferably directly at it (or otherwise to its side, or a specific location in relation to known distance and recognition of the object such as DSP pattern matching, neural processing, or the like [i.e. directed at drive of vehicle, viewing port of a tank or personnel carrier, head of individual, etc.]).

It will be appreciated that in this way the first and second unit coordinate their output directions so that the ultrasonic acoustic energy produced by the distributed transducers 222, 222′ overlaps at a desired target wherein the sound may be heard. It will be appreciated that the acoustic energy may be produced at a conventional “hearing” level or at far higher power levels and at controlled frequency distributions to provide a tactical acoustic component. The electromagnetic input of a given ultrasonic acoustic unit may also be directed by any source having the desired encoded modulation, such as an laser output from a sighting unit on a weapon or non-military output (which can preferably be configured to output different modulations to indicate the party generating the signal, different information to receiver units, such as the nature or composition of a target, or the desired response to be directed at the target, and so forth.

Preferably at least a controller 232 with memory 234 are coupled to the ultrasonic acoustic assembly for interfacing over the communication link with other units. Programming executable on controller 232 is configured for receiving commands for directing the actions of the acoustic unit, such as directing its direction, frequency output, signal output (i.e. modulation components), as well as for controlling the output of related devices, such as an electromagnetic radiation output device (i.e. laser, RF radar, etc.). Preferably programming for the controller is also configured for detecting the received electromagnetic radiation from an input device and correlating that input with the commands in determining an action. For example in detecting a moving object and maintaining the direction of the electromagnetic output with coupled ultrasonic output directed on the target, or for detecting a target in a direction received over the communication link, or just directing the beam in a desired direction (i.e. for sensing activity that passes that location). Canned audio sequences (i.e. modulation required to encode the beat frequency within the ultrasonic output) may be retained in memory 34, as well as control related information such as motion patterns, command sequences, security codes, and information about a present situation.

Controller programming is also preferably configured for transmitting all or selected (i.e. selected from a remote command or interface coupled to the communication link 216) information available at the ultrasonic transducer unit. Examples of information include output direction, detection status (i.e. no detection, object locked-in, etc.), unit status information, and data streams from an electromagnetic input device and/or the data extracted from that data stream (i.e. codings extracted from the modulations and optionally the positions). It should be appreciated that a local command interface may be coupled to said ultrasonic acoustic units for providing localized control and user feedback, while maintaining the ability to communicate with other units for orchestrating the ultrasonic output.

The ultrasonic patterns are described above as being overlapping of two ultrasonic outputs having different angular relationships with a target location. However, the output from any number of ultrasonic units can be directed to one or more locations utilizing the present invention and multiple ultrasonic acoustic units or heads. Another form of pattern allows a first unit to generate an ultrasonic signal (preferably at a fixed or known pattern of ultrasonic energy) which is intersected along its path in multiple locations by another ultrasonic signal preferably containing the audio information to be delivered at each location along the path. Although this has significance in battlefield scenarios, such as for injecting bogus commands, propaganda, or other distracting audio to opposing forces (see Fau-Tac unit information described elsewhere), or commands and information to friendly personnel, it should also be appreciated that a number of civilian applications exist (i.e. marketing in shopping centers, grocery stores, providing information, generating warnings, and the like which are directed at a specific location on the ground or in a 3D space. Furthermore the method provides a method for directing different messages to one or more persons as they progress through a line, checkpoints, or other queue, or for communicating with a number of parties with audio information based on their position.

In another mode the acoustic ultrasonic units can be configured for scanning an area for motion, such as with the electromagnetic output and input (i.e. laser, RF, etc.). Upon detecting a target the first can lock onto the object and direct the motion of the second unit, such as by providing general distance and direction information, coordinates, or a vector, wherein the second unit sets is direction and then locks unto the object by generated a signal to be reflected off of the object, and/or receives the signals reflected from the first unit. In some instances it is preferable, that the electromagnetic input can process multiple input streams simultaneously and could be configured with multiple inputs.

Another optional aspect of the invention is a method for preventing unfriendlies (or in other situations) from coupling their own ultrasonic audio messages into outputs from the units' is that a unit may be commanded to output a modulated ultrasonic signal which operates in concert with another ultrasonic signal having the same modulation; the beat frequency being carried by an audio modulation of one of the carriers. By way of example and not limitation a first and second modulated audio may be transmitted which shifts every x seconds (i.e. 0.5 S) from a first to a second frequency, where x can be fixed or a variable value. All transmitters are synchronized with the same modulation, wherein no additional beat frequency exists between the in-phase signals. However, if another ultrasonic audio signal without, or with a different, modulation is introduced to overlap over one or the other signal it will be heard to warble which will be indicative that it is not generated by a friendly force with the proper modulation.

3.4 Abstract.

A system and apparatus for directing ultrasonic audio from separated ultrasonic units to a target location in response to commands and/or electromagnetic detection.

4 Sequential Multiround-Cartridge Weapon (Smartridge).

4.1 Problem Description.

Robotic system are being used increasingly for vehicular and airborne weapons deployment. The push is toward developing smaller robotic systems, wherein widespread deployment is very cost effective. Small automated systems can perform tasks that would be too dangerous for manned operations, and have the advantage of being cheap enough to be readily expendable.

Conventional weapons do not scale well to small platforms as the mechanisms for round storage, loading, firing, and shell ejection require heavy and expensive mechanisms. One of the challenges with deploying weapons on robotic platforms is to create low cost, lightweight, reliable weapons. Moving into these smaller low cost platforms, it is also important that captured robotic systems, regardless of the state of damage, should not provide materials, especially weapons, that can be utilized by the enemy. Conventional weapons can be readily removed from military hardware for use by enemy combatants.

Current small weapons systems being deployed on autonomous small platforms, such as stationary, vehicular, watercraft and aircraft systems, have a number of drawbacks which have been recognized by the inventor, and addressed herein, the following partial list being provided by example.

Inflexible weapon deployment—each weapon fires single type munition.

High initial cost—complex mechanisms w/limited use before damage or capture.

Heavy in weight—magazines, shell casings, advance, fire, shell discharge.

Large footprint—substantial space required for magazine, auto action, barrel.

Fire rate limited—weight limits number of weapons, rely on fast firing rates.

Non-adjustable firing rate—fixed firing rates depend on design of mechanism.

Failure prone—weapons with mechanical advance and firing are prone to fail.

Mech. Interface—actuators needed between control electronics and weapon.

Enemy reusable—the conventional weapons can be stripped for enemy use.

Self-destruct limited—difficult to assure damage of mech. w/o endangering users.

Ejected shell problems—leaves visible signs, shells can damage equipment.

Brass casings—increasingly expensive brass used for casing each round.

Vibration—reloading and shell ejections induce off center forces.

Slow reloading—difficult to reload as magazines embedded in the robot system.

It can be readily seen that the use of conventional small arms within robotic platforms is overly costly, complex, heavy and suffers from numerous operational problems. Although since no alternatives have been available to industry, attempts to at a solution appear to be largely limited to changing the implementations and materials within the conventional weapons.

Accordingly, a need exists for a new weapons topology that is particularly well-suited for use within robotic platforms. The present invention satisfies the need for a lightweight, inexpensive, small, flexible, non-enemy-reusable, automated small arms deployment system which can be readily integrated into various applications as a primary weapon system, auxiliary weapon, and/or backup weapons.

4.2 Overview.

A sequentially fired multiround-cartridge weapon system, referred to herein for convenience as the Smartridge™ system (even though this term has no intrinsic generic significance to one in art and is just a made up name), is described which eliminates the need for separate round magazines, bullet advance mechanisms, firing pins, shell ejection mechanisms, and the conversion of electric signal from controller electronics to a mechanical actuation for driving a firing pin. Utilizing Smartridge, small weapons systems can be lightweight, small, low cost, more reliable, and more adaptable while being substantially unusable to the enemy when captured. The Smartridge system could even be considered the first “disposable” multiround weapons platform.

The Smartridge system is arranged with electrically ignited rounds located sequentially within the barrel, or more preferably barrel insertion cartridge. In a preferred embodiment each Smartridge comprises an elongated “stick” cartridge for insertion and engagement within a simple barrel housing. The interior of the Smartridge provides a lining within the interior of the barrel, providing any desired rifling on its interior surface. The rounds in the Smartridge must be fired sequentially, with the round nearest the barrel opening fired first, although the electrical timing allows the rounds to be fired at any desired rate. An explosive charge with electronic igniter is located behind each projectile (i.e. slug(s), and/or pellets), while a frangible separator means, such as a compatible powder, particles, or a wax, separates the powder from one round from the projectile of the following round. The ignitor for each round preferably comprises more than one ignitor element, such as a parallel combination, wherein not all the elements need be operational for discharging a round.

Furthermore, a small ejection charge can be located at the base of the Smartridge for safely unloading any remaining rounds in the event of capture, inoperable damage, or eminent capture.

Smartridge can be configured so that the controller directly activates the ignitor for each round, such as by generating a sufficient activation current through a pair of conductors coupled to the igniter. Although this form of ignition is simple, it also requires a number of connections to be made between the Smartridge and the base of the barrel (number depending on number of rounds). Furthermore, the simple electrical current control allows an enemy, or their children, to rig up a simple form of electrical firing trigger to utilize the rounds within the Smartridge.

A simple control circuit at the base of the Smartridge is preferably configured for receiving firing commands, preferably over a serial interface, from the electronic controller of the robotic device or other system within which the weapon is deployed. The control circuit is coupled to each ignitor and prevents firing the rounds in the incorrect order. The serial interface can be configured to require an authorization signature prior to acting upon firing commands. It will be appreciated that sophisticated technical knowledge would be required to fire the rounds from the Smartridge, and would generally not be worth the trouble considering the few rounds available.

To further discourage enemy reuse, the controller can activate an ejection charge to dislodge all remaining rounds so that the neither the Smartridge or the constituent explosive charges and slugs are available for reuse by the enemy. Even the simple barrel is of little use without the lining of the cartridge, and is not configured for accepting conventional jacketed rounds. Although the remaining rounds could be fired by the controller, situations can arise in which insufficient intelligence is available to warrant indiscriminately firing the rounds. The ejection charge is configured as a slow burning low energy highly expansive charge which ejects any remaining rounds from the barrel at a meager velocity, although preferably sufficient to scatter the material to the winds and assure the powders are irretrievable.

Preferably, in the process of activating the ejection charge, the controller circuit is also destroyed. Optionally, the Smartridge and barrel combination can be configured with an exhaust port, wherein a portion of the ejection charge can be utilized for destroying other portions of the system, or igniting charges for destroying other aspects of the system platform which is carrying the Smartridge weapon system.

Another preferred feature is a seal which covers the end of the Smartridge, which both indicates the state as a new cartridge, contains labeling as to the type of ordinance, and seals out foreign matter and moisture. The seal may be configured as a frangible element, such as thin plastic, through which the bullets can pass through without significant reduction in speed or altering direction. The seal may be shaped with an aerodynamic external profile to reduce wind resistance, especially when deployed within aircraft systems. Optionally, the seal may comprise a plug of material, such as a compressed material, behind which (or within which) is coupled an ignitor and small explosive charge similar to the ejection charge described earlier. Once the platform is activated with weapons systems loaded, the seal can be blown out to unseal the barrels, providing a final test of the serial fire control system. Alternatively, the seal may be retained, such as to lower wind resistance or prevent ingress of foreign materials (bugs, metal shards, water, and so forth).

Another preferred aspect of the invention is a safety, which prevents discharge of the weapon until manually disengaged. By way of example, the safety may comprise a pin which shorts out or otherwise blocks any current from passing into the igniters, and which is pulled just prior to deploying the platform.

4.3 Example Embodiments.

4.3.1 Rolled Smartridge Embodiment

FIG. 9 illustrates an example of a Smartridge based weapon system 310. A barrel is shown 312 with a muzzle 314 at a distal end and a proximal end 316 which may be closed, partially closed or open. A Smartridge 317 is retained within barrel 312, the interior of which is optionally configured with rifling 318 (or other interior barrel flight pattern directing means). An optional lip 320 extends about the muzzle end of the Smartridge to facilitate insertion and removal from barrel 312. Within the interior of Smartridge 317 (shown in a partial cutaway view) are projectiles 322, such as metallic slugs or groupings of pellets, configured for being propelled by explosive powder charges 324 activated by electric igniters 326 retained within or proximal the explosive powder 324. The explosive material 324 utilized within the device may comprise solid or powdered material, or combinations thereof. Preferably the material is selected to burn sufficiently cleanly wherein residue does not build up between rounds that significantly detracts from performance of the weapon system. The electric igniters may extend from the interior of the Smartridge or be disposed on the interior for activating the adjacent powder.

A material 328 is preferably utilized between the explosive charge for one round and the projectile of a subsequent round to contain an explosive discharge so that it does not ignite a subsequent charge, and preferably providing cushioning to reduce the impact of discharge on subsequent rounds. Material 328 is preferably non-flammable and may be a solid material discharged with the round, a frangible material that is broken up and discharged, compacted powder or particles which are discharged with the round, materials which are consumed when subjected to the heat of the explosive discharge, and so forth. One example of material 328 is diatomatious earth, compacted talc, or other material which is readily ejected without significantly impacting muzzle velocity. The isolation material 328 may include lubricants to facilitate the passage of the projectile through the Smartridge as retained within barrel 312. Each projectile is preferably substantially sealed against the interior lining of the Smartridge wherein combustion by products can not force their way past isolation means 328 and the following projectile to reach the powder of the next projectile, thereby preventing a controlled firing of rounds.

A Smartridge controller chip 330 is shown embedded (dashed lines) within the base of the device for receiving serial commands from a serial fire control (SFC) chip 332 with input 34. Within this embodiment SFC chip 32 is configured to generate commands to the Smartridge controller 330 as a serial data stream over the positive power line coupled to the Smartridge, wherein only a power and ground line need be coupled to the device simplifying establishing connections. Trigger signals are received from a data line 334, although other forms of interfacing may be utilized. One advantage of utilizing SFC chip 332 is that it can be configured with an internal microcontroller configured specifically for interfacing with the Smartridge controller chip, wherein the system controller software is not burdened with the need for low level driver code to properly control the Smartridge controller 330 within each replaceable munition.

It should be appreciated that any form of serial, parallel, optical, or even wireless form of communication may be established with the Smartridge without departing from the teachings of the present invention. The Smartridge controller chip 330 may also be coupled directly from a microcontroller of the system or other circuitry. Incorporation of a high efficiency power storage capacitor (or battery, fuel cell etc.) for the Smartridge controller (such as isolated by a diode preventing discharge) can reduce peak current demand when igniters are activated. Furthermore, by incorporating sufficient energy storage, the power for Smartridge controller 330 may be derived from a conventional signal line, so long as that line remains high a sufficient amount of time (i.e. negative going logic with high being the default).

Alternatively, or additionally, a power source 335 may be coupled to SFC 332 located nearby the connection to assure that sufficient device power is available for driving the Smartridge. For example, if SFC 330 detects that power has dropped during a mission and that the system controller is inoperative (with no chance of restoration) it preferably will automatically eject the munitions while power is still available in the capacitor for driving the ignitor. Powering ignitor activation from capacitors which are only charged in response to the controlled signals being sent to the SFC and/or Smartridge controller can add an extra safety, wherein the weapons can not discharge upon power up, or due to errant conditions, but require that the controller be sending appropriate signals which charge the capacitor to put it in readiness.

The serial interface is preferably configured so that the Smartridge chip does not initiate communication with the SFC 330 (or system controllers), but typically only response to queries from these devices. This allows a plurality of Smartridges to be coupled to a single SFC either in a cluster mode (within a single barrel having a diameter exceeding the Smartridge 317), or with separately mounted devices. If the Smartridge detects an error condition or other problem it can assert a flag alerting the SFC to poll for status. Numerous forms of anti-collision protocols are available for communication with the Smartridge controller 330.

When new Smartridges are inserted within an active weapon platform, or power is activated on the weapon platform, a query is sent to the Smartridge controller chip 330, wherein it reads its status and data from embedded memory which indicate information about the munition. Preferably, the data from the munition include: type of munition and projectile, sub-types, number of rounds, caliber, muzzle velocity, range, other characteristics, and a manufacturer code and serial number. For multiple sticks, within a cluster, the above information is collected for each of the sticks. It should be appreciated that different types of Smartridges may be loaded within a given weapon platform, unlike conventional weapons, thereby enhancing mission flexibility.

It should be appreciated that numerous other objects could be deployed from different forms of Smartridges. By way of example, other deployables could comprise: tracers, incendiaries, smoke cartridges, practice projectiles (solid color marker, paint balls, etc), crowd control rounds (i.e. rubber, chalk, etc.), targeting rockets, arrows, grappling hooks, rolled or folded leaflets, audio and/or video bugs, flares, elongated payloads with deployable parachutes, and so forth.

An ejection charge 336 is shown near the proximal end 316 of the Smartridge (i.e. surrounding or proximal the controller) wherein upon activation of its ignitor by the controller, all the remaining rounds within the Smartridge are ejected at a relatively low, preferably non-lethal, velocity.

The exterior of the Smartridge may be thermally coupled to the interior of the barrel to provide cooling between rounds. It should be appreciated that exterior metallic contact surfaces may contact the barrel to provide cooling.

FIG. 10 is a side view of an illustrative embodiment of a Smartridge 317, having a exterior housing 340 with proximal end 342 configured for insertion within barrel 312. The Smartridges may be made of any desired length, depending on application with the diameter being dependent on the projectile diameter. It is preferable that select lengths and diameters be adopted to facilitate standardization. Unlike conventional weapons, wherein a round must precisely fit a standard chamber, it is unnecessary for the Smartridges to be manufactured in standard caliber sizes, they may be manufactured in any desired size so long as an accompanying Smartridge barrel is available, this allows for more flexibility and clustering for different situations. Threads 344 on the proximal end preferably include one or more conductive portions for coupling a power lead (preferably ground) to the exterior of the Smartridge 317, while a central pin 346 provides a second contact. If an additional signal lead is desired, then the central pin 346 may be optionally surrounded by a conductive ring.

It will be appreciated that other forms may be connectors be implemented on Smartridge 317, for example a collection of contact pins which engage receptacles at the proximal end of the barrel (i.e. similar to the base of a vacuum tube such as a nixie tube or similar), edge connectors along the circular edge of the Smartridge which extend for engagement with contacts, or other contact arrangement at the ends or central portion of the Smartridge. If the connectors on the Smartridge must align with the connector then it is preferable that the device be keyed into the barrel and retained with other than a treaded engagement. Retention of the Smartridge on the proximal portion of the barrel (opposite the muzzle) is preferred as it puts the exterior of the Smartridge in tension and able to withstand the combustion and the friction of projectile moving through the barrel without damage.

Adapter tubes are preferably provided within the present invention, so that smaller caliber munitions (i.e. .22 caliber) can be loaded into smartridge barrels configured for a large size munition (i.e. .38 caliber), wherein flexibility is enhanced. The adapter are configured with an exterior having a lip and threaded engagement of the larger munition, and interior structures to match a Smartridge barrel of the smaller caliber for receiving the smaller caliber of Smartridge. It should be appreciated that the adapter need not be a solid steel or other structure, but may have a smooth inner bore with an exterior having ribs or so forth to provide support while keeping the weight limited.

A external lip 320 is shown to limit the insertion of Smartridge in the barrel 312, and to operate on combination with an engagement on the opposing end to tension the walls of the Smartridge. To load munition, a Smartridge is simply treaded into the barrel, although an optional locking means, such as collar, pin, and so forth may be engaged to assure that the Smartridge does not rotationally disengage (although highly unlikely if sufficiency compliancy provided in the engagement connection) and sufficient thread resistance provided.

An aerodynamic tip 348 is shown configured for being ejected by charge 350 in response to activating of a ignitor within the charge prior to discharging projectiles from the device. Alternatively a small charge may be located within tip 348, which is preferably at least partially perforated, wherein the charge blasts radial portions of the tip apart to open the end of the Smartridge.

Smartridge 317 can be configured with an optional safety means, to prevent any chance of discharge prior to launching the weapon platform on a armed mission. By way of example a pin-based safety means comprises an aperture 352 for receiving a tagged pin. Insertion of the pin into aperture 352, through the side of barrel 312, prevents activation of the igniters, such as shorting the outputs from Smartridge to the igniters, or more preferably disrupting intermediate ignitor power which is common for driving any of the igniters. It should be appreciated that a safety means may be implemented in a number of alternative ways without departing from the teachings of the present invention.

FIG. 11 depicts a wing half 370 with four Smartridge barrels 372a-372d mounted thereon and having contacts thereupon coupled with a twisted wire pair carrying power, ground and signal from a serial fire control device 374. It should be appreciated that the relative alignment of the barrels may be varied horizontally or vertically providing additional flexibility of the device in selecting which of the slightly skewed directions of munition is best aligned with the target. Optionally barrel alignment may be actively modulated, such as a with a flexible mount at the base of the barrel and an actuator controlling the movement of the tip of the barrel, such as with a piezoelectric positioner, muscle wire, or conventional forms of actuation.

FIG. 12 depicts a barrel 375 configured with a cluster of seven Smartridges 378a-378g coupled preferably through an adapter to fit within barrel 375 that would otherwise provide for discharging a much larger projectile.

FIG. 13 similarly depicts barrel 375 loaded with three slightly larger Smartridges 382a-382c. Optional interstitial small Smartridges 384a-384c are shown between the other units. It should be appreciated that a number of different cluster configurations can be utilized. It should also be appreciated that clustered Smartridges may be integrated into a single unit by the manufacturer, or they may be assembled by personnel at the time of setting up the mission profile. When clustering Smartridges, each Smartridge may be inserted within a firmwalled sleeve (barrel) or formed with sufficiently sturdy walls so that no additional supports are needed. It should also be appreciated that a large barrel, such as barrel 370, may be replaced with a cluster of joined thinner walled barrels into which the Smartridges are inserted. Each of the clustered barrels may be utilized for deploying a different style of munition, wherein adaptability to a variety of mission plans is further advanced.

4.3.2 Smartridge Construction Embodiment.

FIG. 14 depicts one form of construction for a Smartridge with a material 390 which is formed on a flexible printed circuit substrate which preferably contains the igniters, all connections to the igniters, rifling, receives the Smartridge controller, and connects the controller to the igniters. A small end flap 392 is shown attached for connecting the serial connection pin 394 to controller 396, the other contact being connected through the backside of material 390 where it engages the threaded portion of the Smartridge barrel. Multiple igniters (herein shown as two) are preferably utilized for the charge behind each munition 400a, 400b, 400c, 400d, 400e, to assure proper ignition. These igniters may be formed on the surface of the printed circuit substrate, but can be formed in a similar manner as inserting a component such as a disk capacitor into a printed circuit board wherein the ignitor can be held more toward the center of the charge.

It should be appreciated that a Smartridge may contain any selected number of rounds (depending on the length of the receiving barrel and length of each projectile, charge, and isolation means. Five rounds are shown only by way of example. The igniters may comprise a thin section of nichrome wire covered with a volatile heat sensitive compound. Alternatively, and perhaps preferably new techniques have recently been developed for creating junctions on semiconductors that can be exploded when a signal is applied. For example Sandia National Laboratories has developed a semiconductor bridge (SCB) igniter for the ignition of a variety of explosive materials. When subjected to a low-energy current pulse (less than 3 millijoules), the bridge bursts into a plasma causing rapid ignition of the explosive material pressed against the bridge. Despite the low energies required for ignition, SCB components are explosively safe, meeting both electrostatic discharge (ESD) and no-fire requirements.

Preferably the printed circuit is formed from a temperature resistant material, such as a Kevlar, over which metals are bonded to form the conductors and rifling. Preferably the traces may be formed in a subtractive etching process in a similar manner as a conventional flexible PCB (except a Kevlar base with high temp conductors) and the optional rifling strips are bonded to this afterward. It should be appreciated that any desired number of layers could be supported although this increases the cost. Furthermore, discrete forms of wiring may be utilized between the controller and the igniters.

4.3.3 Testing of Smartridges.

Although the electrical components within each Smartridge would be well tested to military specifications, it is preferably that the assembled Smartridge would be tested to assure connectivity and proper system operation. By way of example, a bi-directional serial interface connection to the Smartridge allows the Smartridge to respond to queries from an external controller, thereby assuring the unit is operational. In addition, one test mode of the device registers the characteristics of each ignitor and the wires leading to the ignitor. A Smartridge having one or more igniters which fall outside of a range of electrical characteristic, such as resistance, capacitance, inductance, cross-talk with other igniters, and so forth, is thereby rejected.

The Smartridge preferably retains the ability to check the igniters and status of itself when operational, performing tests at the command of the serial fire controller. For example after firing a round, the state of the igniters can be checked to assure that the round, and only that round was discharged. In this way it can be ascertained the number of rounds remaining, the round ready to be discharges, and if damage has occurred to the weapon. Furthermore, additional frangible traces or other sensing means, such as disposed along the barrel liner of the Smartridge, may be coupled to the electronics (preferably a single chip) within the Smartridge wherein any damage, such as bending or breakage, of the barrel can be detected by the Smartridge controller.

4.3.4 Cost Factors.

The main cost savings factor for the Smartridge is that the weapon system embedded within the robotic platform consists simply of a tube for receiving a smartridge. Compare these costs with a conventional weapon which requires storage of ammunition in a magazine, a means for moving ammunition to the breach, a means for advancing munitions in the magazine, a mechanical firing pin mechanism, a means for extracting the shell, and an actuator to convert electrical signals from the controller into mechanical actuation of the firing pin.

A single Smartridge typically replaces a series of rounds, such as from four to nine, although more or less may be utilized. The internal components of powder and slug(s) are the same as conventional rounds, however, the Smartridge is encased in a single high-tensile strength cylinder, such as thin metal or composite materials such as Kevlar. In volume production the cost of the rolled closure of the Smartridge should drop below the cost of the number of shell casings which would otherwise be utilized. The cost of the igniters is almost negligible. Optional inclusion of a controller chip within the Smartridge can be expected to add less than half dollar of cost to each Smartridge, although it could be produced for much less, especially if polymeric circuit printing techniques are utilized for embedding the circuit upon a flexible circuit which is rolled to comprise the tube for the Smartridge.

4.4 Abstract

A sequential electronically-fired weapon system that is particularly well suited for use on small robotic platforms or in specialized applications. A series of rounds are retained within a barrel, with an electrical ignitor, explosive charge, and frangible separator between each successive round. The series of rounds are preferably contained within an elongated cartridge configured for insertion within a simplified barrel. The weapon device is lightweight, inexpensive, reliable, flexible and does not provide a weapon or materials which can be utilized by enemy combatants.

5 Non-Mechanically Ignited Weapon Rounds.

5.1 Problem Description.

Traditional munition rounds comprise a shell casing for housing an explosive with the shell being capped with a projectile. The powder in the round is ignited mechanically by a pressure sensitive explosive coupled to the rear of the shell being struck by a firing pin. These mechanisms have remained relatively unchanged since the civil war.

The shell casing must be made of a very sturdy material as it is subjected to the full pressure of the exploded round. Typically brass is utilized for the shell and it may have a weight that is a substantial proportion of the projectile weight being fired. These shell casings are expensive, in particular on larger rounds, such as utilized in tanks, cannons, naval armaments, or other large projectile based systems. Due to the high cost of these casings, they are recycled when practical, requiring checking, reworking, and reloading.

Accordingly, a need exists for reducing the cost of ordnance, in particular the costs of the shell casing. The present invention satisfies that need and can be readily retrofitted within existing equipment.

5.2 Overview.

It appears that the drawbacks with current shell casing usage appears not be fully considered in the art. The Applicant recognizes that with clean-burning modern powders there is less need for the conventional shell casing, whose most important duties comprise building adequate gas pressure prior to releasing the round, containing a portion of the explosive force of the round, and providing a flexible liner for that portion of the barrel. The casing is also configured to provide access to firing cap (ignitor) within the round allowing firing pin to strike the ignitor when firing off the round. The applicant has recognized that by eliminating the firing pin and igniting the round indirectly in a chamber having a built in projectile compression device (to build sufficient pressure prior to allowing the round to move down the barrel), the conventional structurally sturdy shell casing can be eliminated or replaced.

5.3 Example Embodiments.

The rear mounted ignitor and the requirements for retaining an initial loading pressure within the shell can be eliminated from the design of the round. In this way the round can be fabricated with an inexpensive exterior and the extra weight of shell casings need not be carried to and from a firing point. Furthermore, the expensive discharged shells are not lost to the enemy or civilian populations and the overhead and high costs associated with salvage and reworking are eliminated because there is no durable shell casing. In addition the rounds are substantially inert as they do not incorporate an ignitor and require a high temperature to ignite the powder. Furthermore, since the powder is unconstricted, ignition of the powder results in fast burning but not explosive results. Wherein the overall safety is increased for the round while the overall costs are reduced.

FIG. 15 illustrates by way of example a barrel 410 with munition according to an aspect of the present invention. The invention is particularly well suited for use with larger munitions, such as those fired from tanks, fixed artillery pieces, mobile artillery pieces, ships and so forth.

The exterior of the barrel 412 can appear generally conventional, while the interior 414 may be provided with rifling 416. The barrel has a distal end 418 the end of which the projectile is accelerated therefrom, and a proximal end 420 into which the munition is loaded which carries the projectile.

A breach lock and cover 422 are provided which seals the rear of the barrel and has no need of a firing pin mechanism. Optionally the insertion of breach lock 422 can shape the rear area for an optimal charge burning profile, for example having rounded corners and an optimized profile. A portion 426 of the breach lock is shown extending into the barrel, if necessary, for optimizing the burn of the charge. The breach lock may be configured with a motion platform 424 allowing it be slid rearwardly so that extensions 426 can clear the chamber prior to swinging the breach open either sufficiently rearwardly or to one side.

The projectile of the round 430 with its associated powder charge 432 is configured for building up a desired level of pressure prior to allowing the projectile to move down the barrel. This is shown being accomplished with a compression section 428 of the barrel which sufficiently engages a portion of the round so that pressure must be built up within the ignited charge before the round is pressed past the obstruction. This is similar to the force required in a projectile separating from a conventional shell. Compression section 428 may comprise a non-flexible obstruction requiring deformation or deflection of portions of the projectile and/or a flexible obstruction configured to move in response to the application of sufficient pressure, wherein the material of the projectile need not be deformed in any manner.

It is preferred that breach lock 422 be configured in at least three positions: (1) loading position—chamber is open ready to receive a round; (2) ready position—round chambered but not engaged with compression section 428 wherein it may be easily removed if a return to the loading position; (3) firing—compression of the round takes place, such as by moving breach forward to a given position (or alternatively a position in which a certain pressure on projectile), at the instant of firing. The powder can also be ignited to allow the round to move itself a very short distance (i.e. on the order of a few millimeters) to engage the compression section prior to pressure building up in the round.

One method of constructing the proximal end of the barrel is with an inner sleeve 429 containing compression section 428. In this way compression section 428 on sleeve 429 can be removed for easy inspection and/or replacement with the same compression section or one having other desired characteristics.

It should be appreciated that although compression section 428 preferably comprises a fixed restriction it may alternatively have an actuator for controlling the compression to be applied to a given round for controlling the firing characteristics of the fired round, which may have a variety of projectiles. With active compression the compression operation is engaged at a strategic time and to a desired level of compression to control the dynamics of powder burning and projectile motion. One manner of implementing a variably constricting ring is by utilizing a pneumatic chamber coupled behind a compliant end portion of an inner sleeve 429, wherein the pressure can be varied to alter the deflection of the compliant end portions. Electromechanical means and other device may also be incorporated for controlling compression if this is desired.

A over-pressure “blowout” device is shown 434 which allows for preventing the buildup of pressures within the breach which could damage the breach. Although this should not be required under normal conditions it provides a safety factor in case rounds are damaged or debris are admitted into the barrel which interfere with normal operation.

In the present invention the shell casing does not contain a rear mounted firing cap ignitor but is instead activated by an energy output directed at the powder when the round is chambered within the chamber and a verified firing command is received.

FIG. 16 depicts an example of an electrical means of igniting the powder 432 of the round. It will be appreciated that energy is pumped into the powder of the round to ignite the powder in a controller manner. In this example ignition is performed in response to electrical ignition of the round in what might be termed a lightning igniter. When inserted in the chamber the powder of the round is retained proximal contacts 438a, 438b, 438c, other contacts 438d, 438e, 438f, no being seen in this view. These contacts are coupled to a high voltage firing controller 440. The contacts preferably encircling the chamber. In one form of ignition sequence high voltages are applied by a high voltage power supply 440 shown being activated for firing with switch 442, although a multiple level secure triggering device would be preferably utilized to assure secure use and no false activations (gun can be easily prevented from rogue operations). The high voltages are applied in sequence across opposing electrodes in the chamber wherein a spark akin to a lightning strike arcs through the powder between a first and second electrode.

Preferably the high voltages are applied sequentially to the electrodes at a sufficiently fast rate to allow balancing the energy being coupled to the powder from each direction. For example with six electrodes 438a-438f encircling the chamber, a high voltage pulse is induced between 438a to 438d to create a spark which reaches between the sides of the chamber; then a high voltage pulse is applied between 438b to 438e to create a spark, and so forth. The time of the pulses can be varied to even out the amount of energy coupled to the round during the burn cycle. Although the contacts are shown dispersed about the periphery of the barrel it should be appreciated that the electrodes may be additionally, or alternatively positioned on the interior of the breach lock wherein the power is applied to the rear of the powder charge or between the rear of the round and the sides of the round.

Alternatively, the above means for inducing ignition of the round by coupling energy to the powder may be implemented using optical (i.e. laser), RF (i.e. microwave), acoustic, or other energy sources for igniting the powder of the chambered munition. For example, beams of laser light (exceeding approximately 25 Watts each) are focused through apertures in the lower barrel, or breach lock, to ignite the powder. Microwave energy may also be utilized or acoustic energy for generating a localized heating within the round for providing ignition of the powders. rapid thermal

The shell casing of the present invention preferably comprises a thin waterproof exterior over a material (i.e. preferably explosive) which is consumed and/or discharged when the round is ignited. It will be appreciated that an exterior portion of the round can be formed with a less volatile explosive than is utilized within the interior of the round. The round preferably comprising at least an exterior portion having a less volatile composition surrounding an interior of any desired volatility. To provide additional safety the rear of the round prior to use can be slipped into a protective jacket as there is no annular breach engagement projection to complicate slidable engagement within a temporary sleeve.

The explosive powder of the round may extend into a recess in the interior of the projectile to stabilize the construction of the projectile with the solid powder.

Optionally, an exotic construction can be provided wherein combustible material is retained within a portion of the projectile, such as a solid propellant within a nozzled chamber of the projectile to provide essentially a rocket assist built into the round and ignited at the time of firing to achieve a longer range when desired.

5.3.1 Electrical Firing of Conventional Rounds.

Ignition of a round with an electrical firing mechanism similar to that described be adopted with largely conventional rounds adopted with electrodes accessible on the exterior of the round for igniting the powder within the round, however, fewer benefits are accrued relative to the non-shelled munition described above.

5.4 Abstract.

An apparatus and method are described for reducing the cost and weight of large projectiles utilized in artillery. The explosives for the round being encased in a solid propellant covered with a vapor barrier, wherein the entire contents of the round are expended during the ignition sequence or expelled with the round.

6 Environmentally Responsive Firearm Safety Device.

6.1 Problem Description.

Accidents involving firearms (weapons), such as rifles and pistols, are common occurrences despite numerous precautions. People make mistakes whether loading, assuming a position, or being reckless when firing upon targets. One place where many accidents arise is during shooting practice whether at ranges or in the field.

6.2 Overview.

The present invention adds aspects to the referenced patent applications for preventing dangerous weapon discharges. The aspects of the invention may be implemented on a variety of pistols and rifles. Main aspects of the invention provide for limiting weapon firing in response to temporal events, directional sensing, target sensing, remote control of safety lockout, or combinations thereof. These aspects can be implemented in various combinations with the aspects described herein and those described in the referenced applications.

A simple embodiment of the present invention utilizes a default safety position for the weapon with a timed unsafety mode. In order to fire the weapon the user must release the safety. The safety will remain in the firing mode for only a fixed amount of time before returning to the safety position. In this way the user can not leave the weapon with the safety in the off position.

Another embodiment describes a remote firing mode lockout for use at firing ranges, wherein a signal is generated by the firing range to unblock the safeties on the weapons, allowing the user to manually select firing mode, only when the next firing session is to commence.

In another embodiment an activation device, such as in the form of a smart card is inserted into the weapon before the safety can be disengaged, thereby preventing unathorized persons, such as children, from discharging the weapon.

In another embodiment the weapon is configured for providing directional firearm safety for target training weapons. Training weapons are configured with a means for limiting the range of directions, and/or locations at which they may be fired. This reduces the chances of the weapons inadvertently firing toward the wrong locations.

In another embodiment the weapon cannot be fired until a sufficient alignment with a target area is detected, thereby preventing any stray rounds from being fired.

In another embodiment the electronics are set for a specific range of targets (i.e. paper targets, cans, deer, squirrels, birds, etc.). The weapon is configured with an imager and signal processing software which correlates images against the information about the selected target and prevents firing at other targets, such as humans, dogs, cats, etc.

In another embodiment the weapon is configured with what is referred to in this invention as a universal fire control interface (unifire interface), which allows the weapon to be fitted with a module according to the type or types of fire controls which are being utilized at the given site.

It should be appreciated that the weapon may be configured with a combination of the above embodiments, without departing from the teachings of the present invention.

6.3 Example Embodiments.

Each of the following aspects of the invention provide unique benefits for the control of weapon discharge, and the apparatus and method should be individually considered on their structures and merits, even though these aspects may be combined in a number of alternative ways.

6.3.1 Universal Fire Control Interface.

FIG. 17 depicts an embodiment of a system 510 which utilizes a control card device 512, such as in the form of a data card which is inserted into the weapon 514 before the safety 516 can be disengaged, thereby preventing unathorized persons, such as children, from discharging the weapon by activating trigger 518. Various forms of control card device 512 can be provided, such as preferably having its own power source. Control card device 512 may have a fixed extended portion 513a, or a wire attached portion 513b, such as for coupling desired peripherals to the control card and thereby to the circuit within the weapon. The wired version allows the peripheral device hang loose, or to be coupled to the person (i.e. part of a wrist band) or to the weapon (i.e. an optical sensor mounted to the side of the barrel). For example an RF transceiver may be coupled to the control card, for implementing RF control as described below. Other forms of device may be coupled to the control card as well.

Currently, various lockout devices are available in the form of mechanical and electronic weapon locks, however these provide a proprietary locking solution, and one which is not “situationally aware”. The present invention provides a mechanism by which a range of locking and fire control solutions can be easily coupled to a given weapon to suit the situation, individual, and weapon being controlled.

Fixed controls are also preferably established through the use of the cards, such as locking out automatic mode in select scenarios, limiting burst length in limited automatic modes, disabling laser targeting devices on the shooting range, and controlling other aspects of the weapon.

The interface device is the preferred mechanism through which all of the above fire control aspects can be implemented. Therein the type of fire control to be utilized can be selected according to the situations. In this embodiment the weapon is configured with what is referred to in this invention as a universal fire control interface (unifire interface), which allows the weapon to be fitted with a module according to the type or types of fire controls which are being utilized at the given site.

The data card inserted into the unifire interface can provide for conventional limits or be used for controlling other fire control aspects such as described in the associated patent application “Handheld weapon fire rate control” incorporated herein by reference. Therefore the same weapon can be utilized in controlled training environments, and with the change of the module be switched into a tactical mode. The tactical mode can provide control of firing rate aspects as described in the associated patent application, wherein the rate of fire, and number of rounds per burst and other aspects are controlled. Less preferably the module can support a user interface, switches or other form of input for selecting the mode of the weapon, however, this leaves room for mistakes, while the use of control cards can be distributed to platoons depending on the specific training being performed, or may be set for one or more combat modes.

It is preferably that the miniature data cards (i.e. 0.5″×1.0″) can be reprogrammed to any desired setting compatible with the weapon into which it is to be inserted, therein eliminating the need to purchase cards for each scenario. The card format may utilize any existing formats, such as PCS cards containing an identifier for activating a cellular phone, or other form of data card.

6.3.2 Implementation of Fire Control.

FIG. 18 depicts a unifire system 510, such as would be implemented as shown in FIG. 17. It should be appreciated that it may be implemented with any convenient location and means for coupling the control card 512 to the control circuits.

A controller means 520, such as a microcontroller, is coupled within the weapon and configured with an interface 522 for receiving control card 512 (data card) containing memory 524 which can contain parameters or even programming. A controller means may be contained within the control card. Providing all the control functions within the control card, however, is less preferred in that each weapon will have different electronic hardware to which the controller should be adapted. Relying on the controller for all aspects of control requires the control cards to be produced for each different weapon.

Controller 520 within the weapon is preferably configured with a standard set of commands, or an API, wherein parameters and/or programming on the control cards can be carried out within any weapon. For example a standardized control card providing a given form of fire control (i.e. RF firing lockout), can be inserted within any weapon supporting the unifire specification, regardless of the controller and implementations within that weapon. Therein it is generally preferred that specialized elements be contained within the control card. Furthermore, it is preferred that the control card supply standardized power input to controller 520 and the functions within the weapon, although weapons may be implemented with separate power supplies if they are designed with power needs which are outside of the unifire specification.

It should also be appreciated that a data card on simple system could comprise a simple switch contact interconnected for controlling selection aspects, however, this is less preferred as it severely limits the extent of control which can be provided and the universality of the unit.

Controlling weapon firing can be implemented in a number of different ways. By way of example the first 526 provides an electrical over-ride 528 of a mechanical firing system (not shown). The second provides an electromechanical firing system 530, with a switch trigger 532, and a means 534 for electronically controlling firing pin activation, whether by an electromagnetic firing pin, or electromechanical control of pressure valves, spring pressure, or other forms of control.

In the first example 526 of control, weapon firing can be controlled in a simple manner by a lock that prevent movement of the firing pin unless the system has engaged an actuator which then unblocks the firing pin. This allows for local control to prevent inadvertant firing.

The second example 530 provides an electromechanical firing system, wherein the trigger is a switch 532, preferably providing force feedback 536 to mimic to a desired extent a mechanical trigger action, which is coupled to a firing actuator 534 coupled to the firing pin. The operation of the firing pin actuator can be readily controlled by the electronics allowing both preventing of firing and controlling fire rates and so forth, wherein functionality can be added in relation to a strict mechanical firing pin arrangement.

It should be appreciated that in either aspect above, the use of “carbine” pressure (round discharge pressure), can still be utilized within the system for providing the driving power for the firing mechanism, whether that be in a mechanical pressure chamber format or converted to an electrical storage, such as via microturbine, or similar conversion device. In the case of pressure activation the firing pin is driven pneumatically, but an electronic actuator can control a valve for selectively controlling the gas release. It is preferred that weapon systems to be utilized in field situations (i.e. combat & police) be configured to operate from self contained power sources, wherein the electronics are self contained so that no problems arise with “loss of power”.

In either implementation a higher level of control can be implemented to augment a conventional mechanical safety, wherein the electronics control a means 538 for electrically controlling (i.e. actuator 538) whether the safety can be disengaged.

Following are a number of embodiments which provide a given type of fire control to the handheld, or shoulder mounted, weapon system. These will be described in reference to the unifire system, but may be alternatively implemented as a dedicated control for that particular function (i.e. without the ability to swap modes) or some combination thereof.

6.3.3 Timed Firing Position.

A simple embodiment of the present invention utilizes a default safety position for the weapon with a timed unsafety mode. In order to fire the weapon the user must release the safety 518. The safety (which can appear as a conventional mechanical safety) preferably only remains in the firing mode for only a fixed amount of time (i.e. from 1-5 minutes) before returning to the safety position. In this way the user is can not inadvertently leave the weapon with the safety in the off position. This mode is very useful in most non-tactical situations. Programming of controller 520 detects the safety activation and registers the time period. Upon time period expiration the controller deactivates firing mode, such as changing state of an actuator.

The safety may be implemented as a sensor and actuator utilized in combination with a mechanical safety. For example a mechanical safety which is biased with a spring into the safe position. The electronics control an actuator 538 which in a first position allows retaining the safety into the firing (non-safety position) and which can release the mechanical safety to return to the safety position. It will be appreciated that removal of the control card 512 prevents the safety from being retained in the firing position, thereby increasing weapon security.

Alternatively, the safety may be implemented electronically, wherein a push button 518 is pressed to activate firing mode, wherein the electronics can disengage any mechanical lockouts, such as actuator 538, and allow trigger control of the firing pin. It is preferable that an indicator be utilized in this mode to indicate safety and firing modes. By way of example the surface of button 518 may be configured for displaying the safety state. For instance the button is overlaid with electronic ink and electrodes for setting the color from RED (firing mode) to BLACK (safety). The indicator may be located elsewhere and either visual or audio indicators may be utilized.

It should be appreciated that this mode can be less preferably integrated with a conventional weapon that does not have the unifire controller 520. A dedicated mechanical or electrical timer may be utilized. For example a rotating mechanical timer (i.e. ⅜″ diameter) is pressed and rotated to enter firing mode, then the dial rotates slowly until the time has expired and it pops out again, providing both indication and safety timing.

6.3.4 Remote Firing Mode Lockout.

Another embodiment describes a remote firing mode lockout for use at firing ranges, wherein a signal is generated by the firing range to selectively unblock the safeties on the weapons, allowing the user to manually select firing mode, only when the next firing session is to commence.

A communication link 540 is coupled to controller 520 which does not allow the weapon to be fired unless it is receiving an encoded command over communication link 540. The communication link 540 can be via radio frequencies, inductive, magnetic field sensing, optical, link, and so forth. Preferably modulated and/or encoded RF transmissions communicated to control the time periods when the weapon can be fired. Alternatively, a magnetic, inductive, or RF form of transponder can be utilized wherein the unit receives information (and optionally all or some of the operating power) from a challenge from a transceiver, to which it responds with its own transmission. Providing two way communication allows the unit to “check in” with the control system at the firing range or other facility, while it can also provide a mechanism for communicating when each round is fired by a given device, which can allow the fire timing and number of rounds fired to be tracked, such as to aid in training or to determine charges and so forth.

The communication link 540 may be resident within the weapon, or more preferably may be coupled to card 512, such as with a receiver portion extending from the card 513a (FIG. 17), or wired to the card 513b (FIG. 17). Card 512 also preferably contains a power source, such as in the form of a replaceable or rechargeable energy source (battery, fuel cell, capacitor). A preferred implementation of the communication link is as a receiver circuit 540′ within or attached to the unifire control card for insertion into the interface. It will be appreciated that the necessary range is minimal, because the firing range should have localized transmitters near each group of firing positions. By coupling the communication link into the control card, extra circuits are not needed in the weapon for every eventuality, while various types of communication can be utilized, depending on the situation.

Communication link 540, 540′ may also be readily implemented as an optical link, wherein an optodetector on control card 512 is configured for receiving light modulation, such as IR, UV, etc., within which the information is contained for controlling the activation periods. In a simplest version the received light directly commands controller 520 whether it should allow the weapon to fire. Slightly more sophisticated the light may have a fixed modulation, which is detected to enact the function (lockout or to allow firing). While active forms of modulation may be utilized to embed information into a control stream to the control unit via the optical (or other form of communication link).

6.3.5 Directional Fire Control.

In another embodiment the weapon is configured for providing directional firearm safety for target training weapons. A directional sensing module 542 is shown preferably coupled to control card 512 (i.e. integrated on, extending from, or attached to), although it may be contained within the weapon, or coupled thereto. Weapons operating in the training mode described within this embodiment are configured for limiting the range of directions, and/or locations at which they may be fired. This reduces the chances of the weapons inadvertently firing toward the wrong locations. The direction module 542 may contain any desired form of direction sensing, such as compass, tilt, global positioning data (GPS), differential GPS, inertial data (movement), and so forth and combinations thereof. Implementation of various direction sensing circuits being well known in the art.

By way of example, the unit may be configured to lockout firing in response to compass heading and range of tilt angles, or prevent weapon firing at all outside of a selected range of coordinates (i.e. within the firing box at the training center). These directions can be set for a specific weapon training site, or received via wireless communication link, such as from a communication system at the site. One preferred implementation utilizes radio, magnetic, or inductive communication generated near the stall at the firing range which communicates allowable firing directions (compass heading and tilt), and optionally the time of firing, to the weapon.

The direction information may be utilized separately or in conjunction with other control aspects, such as the communication link timing control, and so forth without departing from the teachings herein.

6.3.6 Target Signal Reception Fire Control.

In another embodiment the weapon cannot be fired until a sufficient alignment with a target area is detected, thereby preventing any stray rounds from being fired. The system can have a receptor means 544 for registering that it is pointed toward a target to be fired upon. By way of example, an optical system wherein the weapon must register a specific pattern of light in the target direction (i.e. the color or pattern of the target, or other light sources from the target or surrounds in that direction such as UV, IR or visible lighting effects) before controller 520 allows discharging any rounds. Between rounds, such as when targets are retrieved, the optical system discontinues generating the signals, whereby the weapons can't be discharged.

6.3.7 Target Identification Fire Control.

In another embodiment the electronics are set for a specific range of targets (i.e. paper targets, cans, deer, squirrels, birds, etc.). The weapon is configured with an imager 544 (shown as enhanced optical detector) and signal processing software (i.e. on control card 512) which correlates images against the information about the selected target and prevents firing at other targets, such as humans, dogs, cats, etc. Image recognition is well known in the art. This allows the unit to discern what should be shot at from what is not be shot at. This can readily aid in discerning live moving non-targets from stationary targets. This can even be used in a hunting situation to aid in preventing the weapon from being fired upon human targets. Unlike the other aspects disclosed for the present invention this mode of operation requires a large amount of memory and signal processing that is quite sophisticated and costly.

6.3.8 TAutomated Target Information Acquisitiondentification Fire Control.

A controller activate video (or still) camera image capture upon detection of a first level of pressure being applied to a trigger, and/or a sensed level of pressure applied to the stock, handgrip etc. The image collection (still or video) preferably continues as long as the weapon is drawn. To reduce storage requirements the amount frames saved can be culled as time elapses without any weapon firing. For example, collecting video in real time, then as time elapses the video is clipped down to fewer and fewer stills and finally all buffer space is recaptured. Alternatively, the material can all be saved until downloaded to a central station or the like. It will be appreciated that these modes of capture provide full image capture of events (i.e. just preceding discharge) and of potentially slightly less information about events leading up to the discharge event. Once an event arises, then no more culling of the frames occurs about that time period, wherein information is available for correlating with the discharge incident.

6.4 Abstract.

An apparatus and method for providing additional safety for weapons, such as utilized at a firing range. The weapons are configured to recognize specific firing orientations, and/or firing times, under which rounds may be discharged, thus preventing accidental fire incidents.

7 Target Lead Weapons Training Device.

7.1 Problem Description.

It is often difficult to learn how to properly fire at a fast moving target. The present invention provides a method to enhance that training.

7.2 Overview.

A system and method for enhancing target lead training, which can be used for any weapon training requiring significant target leading.

7.3 Example Embodiments.

Invention has different modes of operation such as the following.

(1) Location based fire receipt registration. In this embodiment the moving target generates positioning information, such as from an augmented GPS system (i.e. extra transmitters utilized on the ground to enhance accuracy). Accurate direction and tilt information are registered from the weapon at each firing. A fire processing application on a computer then estimates the path of the shell in response to the direction of firing from the known location of the weapon and determines if, and where on the target, that path intersected the path of the target. The output may be displayed on the target or on a display visible to the weapon operator. The system above is utilized when simulating the firing of rounds.

To aid in setting up fire, the unit can be utilized with simulated fire display, or goggles, which allow the operator to view the scene in substantially real time while the computer renders realistic traces emitting from the weapon, such as indicative of tracer rounds, which aid the operator in aligning their target.

(2) Spread Encoded Optical—The weapon generates an encoded optical output allowing optical sensors on the target to decode the encoding (received fire information) to determine where they are in relation to the sight of the weapon (for example vertically and/or horizontally). The encoding may be preferably according to Cartesian or polar mapping. The decoded position information is utilized in combination with the motion vector of the vehicle (aircraft, truck, etc.) to determine the relative accuracy of the shot. It will be appreciated that the optical output may be generated as a burst corresponding to each round of ammunition fired, or a continuous output wherein the encoded data changes to indicate the time of firing each round.

It should be appreciated that the processing and annunciation of accuracy (i.e. registering hits) may be performed on the target vehicle (i.e. light flashing, optical output changes, sounds, etc.) or at the site of, or near, the weapon. Scoring may be communicated to a computer system executing an application which tracks the marksmanship for each individual (or automatic weapon system being tested or calibrated).

If weapon site processing is being performed then the received fire information is augmented with information on the vehicle vector, including speed direction and acceleration, at the time each round was registered.

7.4 Abstract.

A system and method of training personnel on the proper use of weapons, in particular the proper leading of moving targets.

8 Methods and System for Mechanical Disassociation.

8.1 Problem Description.

There are number of applications in which it is beneficial to provide a controlled mechanical disassociation between two elements.

8.2 Overview.

The present invention describes a number of embodiments of controlled mechanical disassociation between elements in response to conditions.

8.3 Description of Preferred Embodiments.

FIG. 19 illustrates an example embodiment of a device 610 configured for connecting in-line with a cable configured to release in response to a predetermined tension, or alternately/additionally other sensed conditions. The device is a self-contained controlled release element that is configured for transferring forces (i.e. tension or compression) until a given set of conditions are met.

A first association member 612 is coupled to a second member 614 at a junction 616 which is coated with an electrically responsive epoxy material 618. Members 612, 614 are configured with means 615a, 615b for being joined between two elements upon which a tension load is being applied, such as between two cables, straps, structural elements, beam and structure, or other combination between which a load is being applied.

In many applications it is preferred that the period of time over which the disassociation takes place be controlled to reduce the possibility of dangerous ballistic egress conditions. Therefore, the first and second members are shown coupled to one another with surfaces largely normal to the load tension, wherein the elements remain partially engaged after the epoxy is released. To further extend the period of disassociation, a keeper 628 can be coupled between the elements, such as an elastomer that will compliantly stretch before breakage. Keeper 628 may also be utilized to prevent the full separation of ends 620, 622, wherein the disassociation of first and second members 612, 614 acts only to lengthen the material as keeper 28 essentially replaces the elements of the device. In another embodiment a sleeve, or coating, surrounding the exterior of the first and second member can ease the disassociative transition as members 612, 614 separate after the epoxy is released. For example, a polymeric material can be coated over joined members 612, 614, wherein upon epoxy release the strength of the polymeric material is insufficient to support the load and stretches and or tears until first and second member are released.

One of this class of electrically responsive materials 618 is called ElectRelease™ and is manufactured by EIC Laboratories. In this embodiment the first and second association members are shaped so as to receive a desired portion of the load, depicted as applied pressure P from straps 620, 622 coupled to the associative elements 612, 614 which are still capable of separating in response to electrically releasing the epoxy material.

Electronic circuit 624 is preferably coupled to either the first or second associative element and electrically attached 626 to the complementary associative element. for providing a release of the elements if sensed conditions are met. Circuit 624 is configured to automatically generate a drive voltage for releasing the bond between first and second associative element 612, 614, resulting in the controlled disassociation of these elements wherein straps 620, 622 can each move in their own directions. By way of example the release condition preferably comprises sensing the applied pressure, which can be modified by other forms of sensing, such as temperature and moisture.

FIG. 20 depicts electronic circuit 624 having a controller 630, such as a small 8 pin microcontroller from Microchip® Corporation in Chandler Arizona, or other control circuit. Output from controller 624 is configured for activating the electrically controllable epoxy 618 adhering members 612, 614, in this embodiment the output is directed through a switching means 632 (i.e. MOSFET transistor) to enhance the drive capability. For materials requiring a disassociation voltage which is higher than the voltage level of the microcontroller, a voltage regulator can precede the controller circuit, and a level shifting drive circuit utilized.

A pressure sensor 636 is coupled to controller unit 624, preferably providing a digital output or an analog output which is read by an A/D converter on the MCU, or alternatively by charging an input pin (preferably with additional capacitance, i.e. 0.01 uF) that discharges under program control when a desired threshold is reached, wherein the time to charge provides an analog measurement functionality. To allow the controller to further decide the conditions under which the device is to release other sensors can be utilized, such as exemplified as a temperature transducer 638 and liquid sensor 640. It should also be appreciated that the primary sensor within the device can be utilized to sense other conditions as a primary metric, such as temperature, flexure, acceleration (post acceleration—i.e. crash), optical energy, radiation and so forth.

FIG. 21 depicts an embodiment of a device member 650 configured for receiving a compressive force and releasing that compressive force under the direction of controller 630, such as in response to pressure, temperature, environmental sensing, post crash sensing and so forth. First members 652a, 652b, (i.e. angled steel sections) are joined to second member 654 with ElecEpoxy 618. An optional fastener 656 can be provided to limit the motion of member 654 to rotation, or sliding if a slot is provided along the length of member 654. It will be appreciated that the relative motion between the members can be constrained in any desired way to suit the application without departing from the teachings of the present invention. An insulator 658 joins the rear portions 652a, 652b of the first member and the electrical control circuit 660 is shown configured for passing a current through a portion of the first member, through the interface with second member 654 and back through another interface with a second portion of the first member to the controller. In this way the epoxy is released by the controller at the desired time.

If the release between the first and second members needs to be enhanced, then explosive charges, such as of a conventional composition, or small explosive charges more recently fabricated using semiconductor processes, can be incorporated between the first and second members. The device then performs a sequence in which the epoxy bonding is released and then after a period T, the explosive charges are detonated. The timing T depends on the application. Typically T would be a positive value of sufficient duration to assure that the epoxy bond had sufficiently released before the discharge completes the separation.

FIG. 22 depicts another aspect of the invention as locking bolt 770 which can be electrically unlocked prior to removal. This aspect of the invention departs from the prior one in that this can be implemented without the integral electronics and relies on manual application of the separation voltage. A first member 772 with exterior threads 774 (threaded bolt) is shown engaged within a second member 776 with threaded interior 78 (threaded nut). The interface between the nut and bolt is configured according to the invention for being locked using the electrically releasable epoxy described earlier. It will be appreciated that applying the epoxy to the full interface between the nut and bolt would not provide proper release performance, since portions of the metal of the nut and bolt would be in contact thus preventing current flow through the epoxy.

The present invention, however, overcomes these problems. A portion of the nut 776 (or alternatively the bolt) is cut out and adapted with a conductive element 782 (i.e. ring) shielded by insulator 780 from the remainder of the nut. It is generally preferably that the insulator 782 make contact with the bolt 772 but conductor 782 should not be in contact with bolt 772, otherwise current would flow through the metal-to-metal interface and not the ElecEpoxy material. Conductive element 782 is shown with an internal C-shaped structure, wherein the epoxy material can be prevented from exiting the interface area as the nut and bolt are joined. Sufficient space within conductive element 782 is provided for receiving the ElecEpoxy 784 which engages between the nut and bolt and prevents both slippage as well as providing a seal between the two elements. The epoxy may be inserted into a recess in conductor 782 as a mixed viscous paste, or in the form of rings that are preformed and activated at the time of use, such as with a liquid catalyst. The preformed uncatalyzed epoxy can be preinserted within the nuts (or alternatively on the bolt) wherein the operations are simplified.

The nut and bolts are secured conventionally. Prior to separating the bolts and nuts, a sufficient electrical potential 786 is applied between conductor 782 and first member 772 which chemically alters the epoxy releasing its hold on bolt 772 wherein the nut can be easily removed.

It should be appreciated that insulator 780 and conductor 782 are preferably securely fastened to the nut 776 (or alternatively the bolt 772) such as mechanical and/or adhesive bonding, these portions may even themselves be threaded (preferably fine pitched threads).

It should also be appreciated that the unlockable threadable interface can be configured in a number of alternative configurations, such as vertical locking slots, locking caps, separate locking nuts and so forth, according to the teachings of the present invention and without departing from the present invention.

One device that can make use of the above principles is a remote rodeo unharnessing device. In this device a replaceable joint for the hand-hold or other harness elements wherein upon the individual getting into trouble a spotter activates a transmitter which upon receipt at the rope leads to a voltage being applied across the selective connection to release it. Preferable the preconnected elements are purchased by a user premade and tested to assure adequate strength. Preferably both the transmitter and receiver are configured with full dual circuitry, including additional power sources, wherein the possibility for failure is substantially reduced. In one embodiment the power source at the point of separation contains a high density capacitor for operating the receiver and seletively activating the joint. In one embodiment the user charges this capacitor from the battery in the transmitter, which is configured for recharging on an AC adapter or similar.

The extraction system can be similarly utilized for removing boots, clothing, bullet-proof vests, and so forth, although these can often be readily cut away when necessary. Using electrically responsive epoxy for safety extraction systems in aircraft and automobiles.

9 Internet-Based Image Collection and Dissemination Method.

9.1 Problem Description.

It is inconvenient to always carry a camera around with us. Furthermore, even when a camera is carried that does not assure that the individual will have a tripod or a another person for taking a shot. Hauling a camera around is very inconvenient.

Theme parks have long used cameras placed strategically, such as during the drop in a flume ride or similar, wherein a picture is taken and shown at some place adjacent to the ride allowing the user to purchase the shot.

Another system described in U.S. Pat. No. 6,597,392 takes this a little farther allowing theme park image capture, but it requires the guest to obtain an infrared code receiver which obtains information about each picture that is taken. This system is expensive for each individual as it logs the shots that have been taken.

Accordingly this system has a number of drawbacks including that is unable to take action shots and shots spontaneously.

9.2 Overview.

It has not been fully appreciated in the industry that pictures can be taken and identified in a manner to expedite identification. In contrast to the prior art, which identifies the shot within a device held by the patron, this device works in the opposite manner—identifying the patrons to the imaging system. This approach is far superior in that it only requires the guest to have an inexpensive RFID which transmits an ID in response to a challenge, these RFID identifiers can be provided for a few cents apiece and may be incorporated within ride passes and the like.

A user activates the picture mode to a desired extent, which can be conditional on the amount of a payment. A network of cameras in the vicinity then collects images of them as they traverse the area. A code is preferably stamped on each RFID that allows the user to access the shots taken. These can be accessed there at the location, such as on a dedicated kiosk, or more preferably performed from home, wherein the user can download the shots, audio, video as desired in response to entering their specific code. They can print the shots, or pay for having the shots printed and sent to them at a fee. This provides maximum flexibility while not requiring the user to wait for long periods of time while missing out on the experience they came for in the first place.

Preferably the system is configured for detecting not only when a specific patron wanting pictures collected is within range, but also their orientiation wherein the shots will not typically be of the back of their heads. For example, the tag can be configured to be fastened to the front of the individual and to provide a directional component. For example providing a significant reading range only when facing the camera. This can be accomplished with signal shielding the use of phased array antenna technology and other convenient mechanisms. Additionally, or alternatively, a camera registering the proximity of the individuals can be configured to perform image recognition to determine if the persons faces are directed toward the camera, or bank of cameras. In this instance the system can thus collect images with a higher probability of being desirable to the patron. The system can optionally extend this to recognize the facial attributes of individuals, and even to detect when they are smiling, or making a “goofy” face or action that the person, or their group may want captured.

The system is preferably configured so that groups can establish a photo share mode in which every one can access photos of the others. More fun when friends can laugh at each other. Otherwise each can access the photos that they are in, even if others are in same shot.

The system is configured to take shots as these individuals roam about near the cameras, which may be stationary, roaming, integrated with roaming characters and so forth. The images (still and/or video) can be sequenced for viewing in a time mode allowing the user to create a vignette of their trip of any desired size. Alternatively, the images can be sorted as desired, with splicing and cropping being readily provided, preferably on the web site (or kiosk etc.) that provides access.

9.3 Example Embodiments.

FIG. 23 depicts a block diagram of the system 810 wherein audio and/or image (video or still) collection devices 812, 814 are distributed within an area, such as a theme park, ski slope, shopping mall and so forth wherein it is desirable to collect still images, video sequences, and preferably the associated audio if desired.

Each node 812, 814 is preferably configured with a means for detecting the approach is at least the selected individuals (patrons) 816a, such as those that want to have their images collected. Alternatively, the system can identify everyone and then only choose to activate in response to the extent to which those individuals want multimedia collected about their experience. Optionally a number of identifier boxes 816a, 816b, 816c, and so forth can be provided to ascertain the position and motion of the individual, therein allowing shots to be taken at a distance, such as moving toward the camera, or to prepare for collecting a shot as the individual proceeds to be near the camera.

In a preferred embodiment of the invention, the patron has on their person an RFID device or similar device, preferably passive, from which an identification may be determined as the individual is within sufficient proximity of a reader (i.e. 816a-816d). The RFID is preferably passive, wherein the tag need not have its own power source but response to challenges sent from the image collection devices 812, 814, preferably the readers 816a-816d.

These RFID tags can be incorporated within badges, adhesive tags and the like. Additional information may be associated with each of these tags. For example each tag preferably has a user readable identifier, which may be covered allowing the user to see it after scratching off, or otherwise removing a covering. This prevents others from seeing the codes of others, such as capturing these identifiers on cell phone cameras and the like. Furthermore, the system is preferably configured to allow the patron to submit an additional password, or enter other information (i.e. responding to a question as to birthday, mother's maiden name, name of pet, and so forth) that further qualifies access to the collected images or data.

An imager 818 and microphone 820 are provided for collecting the multimedia information under the direction of local controller 822 which communicates through a network interface 824 with a main computer 826 which can store and access the image, video and audio data from a database 828. Alternatively wireless communication 825 can be established between the collection devices 812, 814 and the main computer 824.

Collected data 830 is preferably stored according to the identification of the patron, or patrons present at the time. Preferably each image segment is identified with an image identifier wherein pointer to these can be stored under the identifier of each patron. It will be appreciated that a number of patrons may be present during the collection of a single audio, video, or image collection, wherein this eliminates the need to have copies of the multimedia data within the system. For each identifier it is preferred that at least a pointer to the collected image(s), video, and/or audio be provided (preferably default is video segments along with associated audio such as in MPEG-2 format), the date and time, the location, although other information may also included. Also the special identifiers of the user should be included, such as the identifier printed on their RFID, wherein this can be associated with the collected data.

A portion of the system then provides for access to the collection and printing of images, burning CDs and the like. Web servers 832, 834 are configured for querying computer 826 and processing requests of patrons such as through internet 836 by patron at system 838, or alternatively via a kiosk 840 or other system coupled device connected through the internet, directly to the server, or even directly to the main computer. It will be appreciated that a number of connectivity solutions may be provided without departing from the teachings of the present invention. These preferably allow the user to view the collected data, select portions, edit portions, download portions, print portions, delete portions, and so forth. The patron can also make the collections, or elements thereof available to other persons in their group. They may want to mark memorable shots and allow others in their group to view these or to save these memories themselves.

In one embodiment a magnetic/inductive challenge and/or GHz RF transmission are preferred for limiting the range so that only the IDs of those in the picture are collected. The system can also include a mechanism for detecting the orientation of the persons. For example, the set of detectors 816b-816c can determine the motion of the patrons wherein if moving toward the camera they must be roughly facing it, wherein images collected are generally of higher value than if walking away. Other forms of orientation detection may be utilized, such as directional RFID, wherein the signal is attenuated in certain directions, such as passing through the body from a front mounted RFID (i.e. on a stick-on badge). In addition, the camera can detect if and how many faces are detected within the image field, such as detecting facial features, such as eyes, nose, etc. It will be appreciated that such image processing is readily performed with nominal overhead. However, identifying a specific patron from image data is less preferred in that it requires a great deal of processing overhead and requires that a good image of each patron be collected up-front.

Embodiments of the invention may be utilized in a number of different applications, such as but not limited to ski slopes, theme parks, shopping malls, movie theatres, video arcades, miniature golfing, driving ranges, golf courses, amusement parks, museums, and other places that people gather socially in particular if scenery exists that persons may want in a given photo or video segment.

The image/audio collection can be performed from non-stationary elements. For example battery (solar) powered WLAN connected collection devices can be affixed on robotic platforms to move about the area to get the desired shot. It is preferred that the units have a GPS locator for providing their location, and theft deterrent mechanisms. Furthermore unit position can be monitored by a position sensing means (i.e. GPS, INS, perimeter sensing, items tag etc.) wherein alarms are generated in response to the unit leaving the desired perimeter. Units at a fixed position or mobile can allow the user to set focal distance, pan and tilt.

Although the present system is particularly-well suited for collecting images candidly, it can collect posed images as well. Typically in a posed image, a forward facing viewfinder (preferably large) is provided that allows the persons to see how they are fitting in the upcoming shot, and to direct when the shot is taken (i.e. pressing a button, stepping on a step, jumping from a ledge, or other desired action shots). In high motion activities, such as skiing the system can collect images of the persons during one or more selected runs. The system can even allow the person to select themselves for being filmed during an entire run. For example they get proximal to a unit at the top of the hill and select their preference. The unit then directs cameras along the path to operate in concert to collect images of the person on the course. The cameras preferably using a combination of RFID detection and image detection to maintain proper focusing and camera motion in response to the patron moving through the area.

Backgrounds. The backgrounds preferably are those provided by the location, such as a scenic backdrop, a staged backdrop, a display, and so forth, however, these can be augmented or replaced by the user with video generated backgrounds, such as when images are collected against what is referred to as a bluescreen, or otherwise the background discerned and removed form the foreground as described in another of the applications by the inventor.

In one embodiment the user pays an up front fee (i.e. a nominal fee of $2-$8 for a given number of shots (i.e. 10-40) which can preferably be utilized across the set of cameras. Different scenes can be set up in association with the cameras they can then access those prints from the internet. The images can be modified on the internet by the user as desired before printing out.

Camera can be configured to generate an indicator that picture is about to be taken. For example the conventional flashing light with increasing flash frequency until a steady on light, or displaying a number of seconds and so forth. Can include a flash location away from the camera lens to reduce red-eye conditions. The RFID coupled to the user can be augmented with an annunciator, such as audio and/or visual to alert the user when image/audio collection is taking place.

In some locations physical or lighted marks are preferably provided so the user knows where to stand, or where to ski, walk etc. These may include painted marks or physical structural marks in locations where appropriate, such as on the floor in a shopping mall. In a location that is not conducive to the use of fixed marks, such as on a ski slope, the marks may be generated by directing a light, such as a laser, to indicate the mark that the user or group is to align themselves with. The laser for example may project a box or partial box within which the persons are to be positioned. Incorporated herein by reference are aspects of an camera alignment indicator, described elsewherein in this application.

In one embodiment of the invention, image collection is provided in dressing rooms, wherein the patron can step from their cubicle out in front of an image collection device wherein they can transmit images and communicate in real time to their friends which can help them in selecting outfits.

Sharing images. The system can provide access to certain images to other authorized parties. For example taggable by individual or group to determine the scope of accessibility. If each person in a group of friends defines this given group, i.e. “soccer team”, “bowling buddies”, “close family”, and so forth and adds the individuals of the group to that list, then each member of the group can seamlessly view the images marked for viewing by the group without the need to access the images from each person individually. Also images can be set to public domain, allowing anyone visiting the server to view the images, which can be categorized by content, keywords and so forth.

Similarly, the system allows the images to be blogged, wherein the content is moved or copied to a blog that is accessible to the group.

One aspect of the invention allows utilizing the RFID and reader system for locating individuals, such as children that have strayed. When the tickets are purchased a relationship can be established between the group of tags, allowing any individual in that group (having a tag within the group) to access information on the whereabouts of the other individuals.

In addition, information can be collected as damage is done to sites at the park, since the location of the individuals can be monitored by the computer. For example, if a group of gang-members goes on a spree destroying things at the park, then the tracking can allow identification or tracking of the individuals. As this feature may be controversial it would be optional, implemented at the behest of the particular venue.

The transponder can be configured with increased gain for receiving the challenge when the device has a desired orientation to the transmitter associated with the image collection device.

Alternatively, the RFID can incorporate a direction device (i.e. compass) in the transponder for generating a signal as the direction the party is facing, therein allowing a selection of directions.

10 Camera Field of View Alignment Indicators.

10.1 Overview.

Physical or lighted marks are preferably provided so the user knows where to stand. These may include painted marks or physical structural marks in locations where appropriate, such as on the floor in a shopping mall. In a location that is not conducive to the use of fixed marks, such as on a ski slope, the marks may be generated by directing a light, such as a laser, to indicate the mark that the user or group is to align themselves with. The laser for example may project a box or partial box within which the persons are to be positioned. Incorporated herein by reference are aspects of an camera alignment indicator, described elsewherein in this application.
Laser projection
   a toe line
   the front of a box
   side of a wedge with a toe mark
   moving mark for taking videos
Automatic panning in response to motion
   maintain frame on person or persons
   detect positioning with a sensor (image collected by camera itself)
Projecting 3D alignment mark
   Holographic projection
      floating mark (can align accurately, such as a face)
   Audio alignment mark
      by itself or augment other marks
      generate stereo ultrasonic beat freq. aligned with head of persons.
         10.2 Example Embodiments.

FIG. 24 illustrates an image collection system 910 with selective marking according to the invention. A camera 912 is controlled by controller 914 which is controlled through I/O 916. A positioning marking head 918 is configured for directing individuals as to where to stand for a selected image. The marking head, for example can generate a laser output 920 to generate a box 922, or any other desired shape of marking, to aid persons 924 in achieving a proper alignment.

The invention is particularly well suited to situations that can change, such as having different number of persons on the shot, motion of the individuals (moving toe marks), different situations, different directions from the camera angle and other variable aspects which make the use of a single fixed mark ineffective.

The marks can be projected by a moving head laser, or other optical output device, or by passing light through a pixelated graticule, or by using a mirror array, or any other technique which allows controller 914 to establish the mark according to the conditions, what is entered on I/O 916, and the image being detected by camera 912. For example the camera can detect the parties in the scene (i.e. bluescreen backdrop, or by determining the differences between current image and static image of the given backdrop for the camera position and orientation). Wherein the controller can determine whether the shot is sufficiently well formed and adjust the markings to steer the individuals to increase the effectiveness of the shot.

11 Location Aware Prerecorded Audio Tour Player.

11.1 Problem Description.

A number of shortcomings and limitations exist with current methods and systems of automatically disseminating tour information. One popular method of disseminating information aspects of a tour is through the use of prerecorded audio which is played back as the individual takes the tour. However, a number of drawbacks exist with these present systems.

When utilizing prerecorded audio tour information it is often difficult to synchronize the recorded audio with the location of the individual within the tour. Current systems provide limited choices, as represented as follows. (1) User should keep up with the audio tour; the tour audio including descriptions of where the next point of interest is located, as the user moves from location to location. (2) User presses a button to pause action if they are delayed from the next area, and once at that location can press resume. (3) User enters a number value corresponding to a station for which audio is available.

It should be appreciated, however, that these mechanisms tend to constrain the free flow and sequence of the tour when the person must follow the selected order of the points of interest at the speed of the audio tour. Otherwise the individual must find the proper code at the point of interest and then enter in a code for that point of interest and start the audio.

11.2 Overview.

The present invention allows the audio device to cost-effectively recognize its proximity to each of the points of interest. The digital audio stored within the tour device is accessed randomly in response to the location and/or direction of the patron. The user can go at their own pace and their unit will automatically interrogate the RFID devices near them retrieving an identifier that is used for accessing a record within the device, such as an audio record, or optionally audio and video, or text (i.e. for hearing impaired patrons). Unlike conventional devices, the user can select the level of detail they desire during the tour—some people want every detail while others want just the high points (i.e. the “encyclopedia” version, normal version, “readers digest” version, “Egghead” version). The system can be set to provide any level of detail, allow selecting depth of vocabulary from simple to scholarly, selection of languages and so forth. A button on the system can allow cutting off the description at any desired point and moving on.

Furthermore, the present invention provides a number of additional features for increasing the utility of the tour information provided. The RFID reader responds to transponder tags at points of interest. The opposing scenario can be less preferably created with the RFID reader at the stationary point and the RFID transponder in the possession of the patron.

The tour device can be utilized for reading codes from smaller elements, i.e. artifacts, pictures and the like to provide information on that specific area of interest to the individual. This could be considered a “Fau-Docent” mode. For example an optical reader, such as bar code reader, block codes, or other mechanism capable of discerning one tag from among many in close proximity (also a proximal RFID transponder can be used which requires contact or close proximity). The bar code or other items indicator is placed on selected items for which information is available and the user is given that information. For example, a photograph may contain elements over which a miniature code is placed; the user runs a reader on their tour device over the bar code or upon the block code and the unit then accesses data stored internally and generates audio describing that element. As another example the controls in a submarine on display may be coded wherein the user can learn what each lever, wheel, indicator and so forth is intended to perform. A label, which could be very small (i.e. about ⅜ inch) could be placed on each item for which information is made available. Preferably a small readable sequence number is also included to aid in scripting by personal. The display on the unit can output a name for each element, and optionally the text of the information for the hearing impaired to read instead of listen to.

11.3 Example Embodiments.

FIG. 25 depicts a tour guide device 1010 having a controlling means 1012, preferably a microcontroller or microprocessor coupled to memory 1014, which comprise both a program store and a data store. The program store preferably comprises a memory stick, ROM, or other form of non-volatile memory. Volatile RAM memory can be utilized if the device is coupled to a means of downloading new information prior to each activation (although less preferable). It is preferred that the controller have sufficient processing power, such as 1016 bit controller, to allow for the use of common audio MP3 and video formats (i.e. MPEG-2, AVI, etc.) as well as for external communications.

Memory 1014 provides storage for user parameters and configurations (i.e. volume, level of tour detail to disclose, language, and so forth), as well as stored audio, images, text and so forth. A sequence of entries in the tour database can comprise an identifier (ID) associated with the specific location, and a pointer to content data. The type of content (i.e. depth, language, etc) can also be encoded so that a specific type of entry can be played.

A challenge transceiver 1016 is configured for generating a challenge and receiving the response from the RFID, such as 1018a, 1018b. An optional shield means 1020 may be incorporated to increase directionality of transceiver 1016, so for example to communicate with RFID 1018a and not RFID 1018b.

Alternatively, or additionally, an optional compass circuit 1022 can be included allowing the programming to select one of multiply responding RFIDs based on the orientation of the tour guide device. It will be appreciated that inexpensive electronic compass circuits are incorporated within wrist watches and a number of other devices.

Audio output 1024 is shown being directed through amplifier 1026 (i.e. class D amplifier) which drives headphones 1028 and is controlled by volume control 1030. It will be appreciated that other audio combinations may be utilized, such as analog amplifiers, conventional speakers, or even the use of multiple directional ultrasonic transducers which produce a beat frequency at a specific direction and distance from the unit, thus allowing use of the tour guide unit without headsets while not disrupting others nearby.

A collection of input/output (I/O) 1032 are depicted with device inputs 1034 through a driver 1036. The inputs preferably comprise buttons, switches, knobs, and so forth for controlling the aspects of the device. Optionally, the inputs can include a touch screen such as over a display, or a touch pad, touch stick, or other forms of pointing devices. A scroll wheel is preferably mounted for activation on each side of housing for activation by the thumb for either right-hand or left hand use to allow the user to skip through content (audio or text) to reach the desired content.

One or more output devices 1038 are shown with device driver 1040. The output preferably comprises indicators for state (i.e. On/Off, Volume, Station ID, etc.) and may also comprise one or more display screens. The inclusion of a display screen is preferred as it allows text to be displayed as an alternative to the audio for the hearing impaired, or in addition to the audio. In one mode of the invention, preferably configured as a default mode, an outline for the audio retained for each location or item ID is displayed on the display wherein the user can use the scroll wheel to get just the content desired while skipping elements that are not of interest. By way of example a small intro would play for each station and by followed by categorized content having additional details. When setting up the device the user can be allowed to establish a default priority to the menus, for example wanting technical details over historical details (only an engineer would think of that). The display may also be utilized for displaying images, graphics and so forth which relate to the content.

The device can include additional reader mechanisms, such as a bar code reader 1042 with an interface 1044, output LED 1046 and optical detector 1048. The bar code reader allows user to select from different elements that are in close proximity, such as tags on a photograph, or a listing of additional content contained in the room. This is an inexpensive means for providing access to added information without the need of utilizing additional RFIDs that are configured for close proximity localized communication.

It should be appreciated that the RFID themselves may contain the data to be communicated to the user, or alternatively a unique key number used to access a database of facts about items and locations addressed within the given tour.

External communication can be optionally provided to the device, such as via wireless RF transceiver 1050, network interface 1052 (wired or wireless), or a dedicated wired connection (i.e. USB, firewire, etc.) with driver 1054 and connector 1056 configured for coupling with a plug 1058.

11.3.1 Alternatives

GPS utilization. An alternative to the use of the RFID, or to enhance its operation, is in the inclusion of a GPS unit 1060 to recognize the exact position of the patron. The GPS would be preferably utilized in differential mode in association with at least one local transmitter. This GPS configuration has been relied upon to provide position accuracies of 1 cm. By utilizing the GPS unit in concert with compass 1022 the device can determine where the patron is and what they are pointing to without the need to provide RFID tags. It will be appreciated, however, that some form of tags are still necessary wherein the user will know where they must move to gather information as it typically is not available for every area.

It will be appreciated that differential GPS may be used instead of, or in addition to, the RFID mechanism, or a combination. Proprietary tour units can be configured for just the given differential GPS wherein users could not use their own GPS devices with a third party database and achieve the same operation.

Non-dedicated device use. The tour guide functionality can be less preferably incorporated into PDA, cellphone, MP3 player, and other designs. In this embodiment the tour appliance is owned by the user, and is therefore not preloaded with the audio tour information. The audio, and any available graphics for the tour (for graphic equipped appliance), are loaded prior to commencing the tour at any convenient location. For example the data can be loaded over the internet from a home location, a wired or wireless internet connection at the tour site, wirelessly over a telephone connection, wirelessly from an RF data transmitter, and so forth.

The personal electronic device of the user can be equipped with a local communication means, for receiving ID codes from RFID tags, said ID codes being convertible into location information based on a mapping received with the tour data, or the ID utilized directly with the audio (or video data) selection programming to make accessible the data associated with the given location of the RFID. By way of example a low-power challenge-response transceiver commonly utilized for activating nearby RFID transponder chips (i.e. located within 3 to 10 feet of the transceiver). Alternatively, conventional RF communication links may be utilized (wireless link to repeater, separate wireless channel, Bluetooth™, near-field magnetic communication, optical links, and so forth). This communication pathway may be utilized for receiving information at short range from transmitters located at select destinations along the tour.

An optical imager, or optical code reader, coupled to the personal information appliance can be configured in software for reading optical codes at very close range (i.e. maximum of one to six inches), as a means of gathering additional information about articles and portions of articles within the tour. For items out of reach, or that can not or should not be festooned with an optical reader tag, a photo of the area can be provided nearby with the optical reader tag allowing the user to make a selection in that manner. It should be appreciated that an image, or image stream, from a conventional still or video camera can be processed by optical code extraction methods as described in a copending application by the inventor.

The system software is preferably configured to secure the tour data, such as to prevent distribution and with a view toward collecting additional tour fees. For example, the software is configured to require receipt of a code at the site of the tour which is utilized for gaining access to and/or for controlling decryption of the tour data. Once the tour data has been utilized, and/or a specific time limit has elapsed, the tour data is destroyed. Or alternatively, the decryption of the encrypted content is no longer available. By way of example, decryption codes can be generated by stations along the tour for decrypting only that portion of the information, with the decryption code not being stored for subsequent decryptions of the content.

Although conventional tour information can be made available utilizing distribution aspects of the present invention, such as utilizing the device simply as an audio player or an audio player with identified portions of the audio, it is preferred that extended functions of the present invention be incorporated.

12 External Data Camera API.

12.1 Problem Description.

Cameras, both still and video, are being increasing used for a variety of special applications. However, creating a camera system around a specific application is expensive and results in high end user costs.

Therefore, a method is needed to speed implementation and to lower the costs of custom camera based applications.

12.2 Overview.

A system and method which allows application designers to readily incorporate additional information into data recorded by a camera system. The system may be implemented within still and video cameras which are provided separately or integrated within PDAs, camera-phones, or other multi-use devices containing cameras.

The camera system is configured with a standard interface for receiving external sense data, such as GPS coordinates, compass direction, distance (i.e. received from electronic tape measure), tilt angle, identifier for cameraperson (i.e. password, biometric scan, etc.), distance to object in center of frame, atomic clock timestamp, temperature, relationship between pictures, and any other form of sensing input which a designer may wish to incorporate. These elements may be preferably be incorporated singly or in any desired combination.

The standard interface on the camera system allows these elements to be connected wherein it can automatically receive the additional data and correlate it with the still or video images. The data is associated by printing it on the image frames and/or less preferably retaining it as separate information about the collected image frames. In this embodiment no programming is required to gather additional data associated with a given application.

By way of example, an installer of window blinds may take measurements for the window, captured by an electronic based tape measure, and then take a picture of the window, wherein the measured data is automatically displayed on the picture of the window. (It should be appreciated that the data may be input to the camera system before or after images are collected—depending on how the camera device is configured). It will be appreciated that a large number of professions could be aided by the ability to readily add other forms of data to the image record.

The camera system is preferably equipped with an API (Application Programming Interface) for manipulating the input data in relation to the image data being collected, in cases where the application warrants additional sophistication. For example in the prior example codes can be added to an application programming area of the camera coupled to the API, for displaying window measurement vectors on the image frames with legends containing the measured distances.

The additional collected data can be used to modify the images collected, such as displaying results, such as described above, or even modifying the image such as by morphing the image, changing image size/resolution, image coloring, image format, superimposition of images, relationships between collected images (or sequences), or other modifications as determined by the application programmer and which are preferably supported by the API.

The API can also be preferably configured for controlling a user interface, for example allowing a user to mark portions of collected images, such as marking the edges of a window frame in the example above. Image recognition functions may be accessible with the API, or external functions coupled to the API to allow image processing functions to be executed, such as a form of boundary detection, wherein the edges of the window frame in the example above can be automatically identified and marked accordingly.

12.3 Example Embodiments.

FIG. 26 depicts a camera system according to the present invention 1110 shown with a camera body and lens 1112 having a module receptacle 1114, shown on one side, which is configured for receiving one or more sense data collection modules 1116, 1122. The camera may incorporate sound input, especially if the camera is configured for capturing any video imaging. Each sense module is shown with a first communication port 1118, 1124 for connecting to the camera or a preceding module, and a second communication port 1120, 1126 for connecting to a successive sensing module.

In this way any number of a variety of different modules may be coupled to the camera for collecting any desired information. Preferably, the port (or a separate port) is also configured for being coupled to an external data source (and/or data receiver). The link may comprise a link according to a standard such as USB, Firewire, or any other form of wired or wireless electronic communication link. By example an external data sourcing/receiving system 1128 is shown with connector 1130 configured for connecting to the camera or to the modules attached to the camera. A computer system 1132 is shown coupled to connector 1128, although PDA, laptops, servers, or other electronic data sources/receivers may be utilized. Computer system 1132 is shown coupled through internet 1134 to server 1136, such as that of module manufacturers, third party software providers, or other sources of programming to facilitate readily creating applications based on the selected sense modules.

FIG. 27 illustrates example of layers 1150 within the camera system of the present invention. An application programming interface 1152 is shown which is coupled to an embedded programming layer containing programming for controlling aspects of the camera, depicted by way of example as an image data storage and retrieval block 1154 (controls the actual storage and retrieval of image/video data), a camera settings, parameters and controls block 1156 for controlling how the camera is configured, a user interface block for interacting with user for controlling both native aspects of the camera as well as add-on module specific elements, such as controlling how an add-in module is to be configured, supplying additional data for use with module supplied data, displaying information from the module on the camera display so enhance use of the camera, and other forms of input/output interaction between the user, camera, and modules. An image data repository 1160 is shown for storing image/video data, this may be in the form of memory, memory cards, mass storage devices, even remote data stores coupled to the unit, or combinations thereof. An auxilliary data storage and retrieval block 1162 is shown for storing and retrieving data from an auxilliary data store 1164, that data therein being generally associated with each image, although data may be collected separately which is not associated with any one particular image, or any of the images

Coupled to the API is an application layer shown with programming associated with functions (and other support programming) for an add-in module. Also programming may be received from another source to provide additional or related functionality 1168 to the add-in modules (i.e. third party module software, or manufacturer supplied auxilliary functions). It should be appreciated that these add-in module programming may be coupled to the API forming an extended API for access by application programming. Finally, application programming 1170 is shown which is specifically written to support the modules or is a modification of an existing application. The system can configured to allow the application programming to be written in a conventional computer language, such as C++, or as a script language, such as Java, etc. Camera API 1152 may be part of a larger API (i.e. an integrated device such as a PDA having camera functionality), or be coupled to other APIs in a modular system. It should be noted that baseline functionality can be provided for numerous modules by the present system without the need of writing any application programming.

12.4 Abstract

A system and method of collecting and storing any desired forms of additional information within a camera in conjunction with images or video streams. The additional information being collected by add-in modules coupled to the camera. The system allows a wide number of specific applications to be readily supported, in some cases without the need of writing application programming, but in other cases in conjunction with programming written over an API to facilitate quickly cobbling programming together to create an application. The system can configured to allow the application programming to be written in a conventional computer language, such as C++, or as a script language, such as Java, etc.

13 Cell Phone User Location Limiter—CPULL.

13.1 Problem Description.

The use of wireless telephones (cell phones) while driving is leading to increasing numbers of accidents. Most individuals do not take the precaution of connecting a hands free connection to the phone and utilize a standard phone held to the ear which keeps one hand off the wheel and often requires the attention of the driver to be focused on the itty-bitty display screen of the phone and the plurality of miniscule buttons on the user interface. The danger is such activity has already caused some states to enact laws preventing drivers from operating their phones while driving. However, it is uncertain how such laws are to be enforced.

Therefore a need exists for a system and method for limiting dangerous phone use based on location and equipment. The present invention fulfills that need and others and can be readily implemented.

13.2 Overview.

A system and method of restricting phone use in certain locations, and more specifically to restrict phone use based on the conditions and equipment being utilized. The present invention is very well suited for use in vehicles for preventing the driver from using a conventional cell phone which must be held to the ear and which does not have a hands free control mechanism. The present invention is also preferably configured wherein it allows others in the vehicle (other locations in the same vehicle) to freely utilize any telephones.

In a preferred configuration the system prevents only the person in the drivers position when the vehicle is moving from operating the telephone placed up to their head. The use of safe hands free headsets and other mechanisms designed for use without tying up the drivers hands or attention are not restricted.

The invention may be implemented in a number of alternative ways. A receiver or transponder device in the handset is configured to detect a signal from the vehicle to control the activity of the telephone. Two general embodiments are described herein. (1) The cellphone detects a very low power directional signal from the vehicle which is directed to the upper areas of the driver seat. The signal is only generated when the vehicle is in motion. In response to receiving this signal the cellphone blocks use of the phone. (2) The vehicle when in motion detects that the cell phone transmitter has been activated at the drivers position, such as with a directional antenna, wherein the vehicle generates a signal to the cell phone to block use of the cell phone.

The signals may be communicated according to any convenient communication means, such as a radio signal, magnetic/inductive field, ultrasonic audio, and/or optical signal. The use of radio or magnetic/inductive signals are preferred in that they are not readily blocked by the body of the driver as could arise with optical or acoustics signals.

13.3 Example Embodiments.

FIG. 28 illustrates the cell phone blocking system 1210 of the present invention. A vehicle 1212 is shown in motion with driver 1214. Driver 1214 is attempting to utilize a cellular phone 1216 equipped with the present invention. A directional detection unit 1218 on vehicle 1212 communicates with cell phone 1216 wherein circuitry on the phone prevents the use while driving, as represented by the slashed circle.

FIG. 29 is a block diagram showing two optional embodiments of the present invention. The conventional aspects of cellular phone 1216 comprise an RF transceiver 1220, a control circuit 1222, a user interface 1224 (i.e. keypad and display), a microphone 1226. and an audio transducer 1228. Blocking use of the cell phone by a driver of a moving vehicle, or other environment wherein said use may be deemed hazardous, (i.e. operating room, aircraft cockpit, and so forth) is shown embodied in two different ways.

A directional receiver embodiment is shown, wherein the vehicle based unit 1230 utilizes a direction receiver 1232 (indicated by the feed horn although may be implemented as phased array or other conventional techniques known to those of ordinary skill in the art). Directional receiver 1232 is connected to a controller 1234, which may be a separate controller for this unit, or a controller that is integrated with the vehicle for performing other control functions (i.e. such as one of the vehicle control systems). Controller 1234 is configured to receive an indication of vehicle motion, or speed, 1236. It will be appreciated that a speed signal is already often available to control systems within the vehicle, wherein a separate sensor need not be utilized. In response to detecting that cell phone 1216 has been activated in the location of the driver, which is dependent on receiving a signal along the direction path to directional receiver 1232, the controller checks for vehicle movement from speed input 1236, wherein if the vehicle is moving the controller activates a transmitter 1238 which generates a blocking command signal (i.e. along a directional path or less preferably omni directional) to a receiver 1240 in cellular phone 1216. Cell phone controller 1222 upon receiving the signal blocks the use of the cell phone, although this is preferably performed in firmware, it is indicated by the switches 1242 being operated in response to the controller for switching of the RF section and the user interface.

A directional transmitter embodiment is also shown in the figure, wherein a vehicle based unit 1250 is configured with a directional transmitter 1252, configured to generate a directional blocking command signal to cellular phone 1216. Directional transmitter is coupled to a controller 1254 which receives a vehicle motion (speed) sense input 1256. Upon receipt of the directional blocking command signal the cellular phone then blocks cell phone use in the manner described above. So that the transmitter need not always be active, an optional receiver 1258 (i.e. directional or omni directional) can be coupled to controller 1254, wherein the blocking signal is only transmitted in response to detecting local transmitter activity.

Two embodiments of the invention have been shown to indicate that the system and method may be implemented in a number of ways, it should be appreciated that the systems and methods above may be modified in various ways and in combination with various other equipment without departing from the teachings of the present invention.

It will be appreciated that separate wireless communication transceivers are being incorporated on telephones for communicating in close range with other users and for ordering from vending machines, paying parking meters, and the like. Wireless protocols, such as Bluetooth™, IEEE 802.11 wireless standard, and others may be utilized for carrying the communication whether voice or data. It should be appreciated that some standards, such as IEEE 802.11g incorporate a signal strength reading and beacon frames. This feature can be made use of the in the present invention, for roughly determining the distance of the signal being generated, to aid in determining if the driver is the party operating the cellular phone. This feature is preferably utilized in conjunction with the directional antenna. It should also be appreciated that proposals have been put forth toward increasing the accuracy of detection by changing the signal strength measurement method, frequency of measurement, or performing a form of calibration operation. In the present invention another method that can be utilized is to provide multiple directional antennas, wherein the relationship of the signal strength reading to the cross-over point of the antenna pattern can significantly increase location accuracy. For example, there should exist a general correspondence between the two readings for a signal generated at the cross-over point.

One optional embodiment involves the use of transponder technology wherein a challenge is issued and a response received. Upon being activated, or a call being attempted, the cellular phone may issue a challenge signal which is received by the vehicle base unit, which determines if the challenge was received from the vicinity of the driver, wherein the response can contain a blocking command signal telling the cell phone to block use.

It should also be appreciated that the above embodiments illustrate the general use of radio frequency communication techniques, however, the use of magnetic/inductive signals, ultrasonic audio signals, optical signals, electric field signals, other communication forms and combinations thereof, may be alternatively utilized without departing from the teachings of the present invention.

13.4 Abstract

A system and method for preventing drivers from utilizing wireless telephones, or other voice communication devices (i.e. walkie talkies) which are not equipped for hands free operation, when operating motor vehicles.

14 ECeptor—Environmental Data Collection—Enhancement

14.1 Description Invention.

An optional enhancement for the ECeptor system, which is incorporated herein, is described. Wherein the communication link between the reception unit and the Eidos comprises a communication standard which includes a signal strength function, such as within beacon frames, as found within the wireless IEEE 802.11g standard, or any other convenient standard. In this way the detection of distance is simplified. Furthermore, it is expected that new signal measurement techniques will be incorporated within such standards thereby increasing the accuracy of them.

15 Pre-Encoded Keys.

15.1 Problem Description.

Coupling a set of keys to a microcontroller requires that a number of I/O lines be utilized, or that row-column keypad control devices be utilized. Both of the current methods have a number of drawbacks. Both approaches take up a number of processor I/O lines, or require the use of an external device for detecting key presses. Row-column detection circuits also cannot be utilized when the input may comprise simultaneous input on more than one key. Furthermore, product upgrades are difficult since adding new keys can require changing the circuitry as well as often complex trace routing.

15.2 Overview.

Apparatus and methods are described for reducing the number of lines needed from a microcontroller, or similar, for receiving input from a plurality of keys. Circuitry in the keys themselves reduce the number of control lines needed as well as the additional overhead.

15.3 Description of Preferred Embodiments.

Each tactile key is configured with an integral means of generating a response. The mechanism can allow implementing a system with an arbitrary number of keys which share a parallel response path.

15.3.1 Synchronous Embodiment.

In one embodiment, each key device comprises the following. (a) A means for sensing user input (i.e. switch contact, proximity sensing, piezoelectric flex sensor, capacitive or inductive sensor, and so forth). (b) A location memory configured for retaining a response identifier which can be associated with the key position. (c) A means of communicating said response identifier upon activation of said means for sensing user input.

The location memory of the device can be programmed statically, wherein the pre-encoded keys are programmed to a key location prior to installation in the device. Alternatively, the keys may be programmed to specific locations within a programming operation once the unit is fabricated.

The means of communicating the response identifier preferably comprises transmitting the response identifier in parallel with that of other keys.

Programming.

Pressing keys in succession, each key listens during programming and keeps a count of each key programmed. With each signal received during programming the count is incremented. When a key receives the program pulse and is activated, it knows to load the count into its response identifier memory, and then does not further respond.

15.3.2 Sequential Embodiment.

In another embodiment, each key device comprises the following. (a) power connections; (b) input line; (c) output line; (d) means for generating a code packet on the output line; (e) means for updating a code packet received on said input line and outputting it on said output line.

The code packet preferably comprises at least a default value, such as 01h, which is changed (i.e. incremented) in a defined way as it passes through successive keys in the chain. Additional data may be provided to indicate key status, such as whether this is a new key press, or key is being held down; and to indicate the number of transmissions of the same key value.

In this embodiment keys are connected in a series string, each key having an input, output as well as power connection (or less preferably power supplied on input line with a ground provided). Upon activating a key it generates a default code on the serial line (after preferably first determining the line is clear for a period of time). As the code as passed back through successive keys the circuit for each key increments a count value.

Two basic embodiments are described, in a first embodiment each key device operate asynchronously, wherein it attempts to return data on the serial line as soon as it detects a change in status. It will be appreciated that this embodiment requires some form of collision remediation, such as transmission repetition with random holdoffs, priority encoding and so forth. A second, more preferred embodiment, is a synchronous embodiment in which data generation is synchronized, such as by the controller or less preferably one of the keys themselves.

The data passed back for a keypress preferably comprising a sequence count value, a status and a repeat value. The repeat value is preferably only utilized with an asynchronous embodiment wherein collisions can arise as it allows a key to send data for the same keypress a number of times without that being confused with a new press of that key. In this way collisions can be handled by repeating the send. A status value can be incorporated so that conditions of the key can be sent, such as for distinguishing between a newly pressed key and a key that continues to be held down, because it is often important to distinguish between these events, one driving a single key entry while the other driving a repeat function. In addition the status value can allow inputs other than simple ON/OFF keys to be connected on the input string, such as digital pots, multiposition switches, and other input or sensor devices having a sufficiently low data rate. It will be appreciated that multiple keys can be pressed simultaneous and they will still report these conditions to the microcontroller. The first key activated grabs the bus first for transmission with keys grabbing the bus thereafter as it becomes available. Each key preferably having a somewhat unique hold-off time to reduce possible bus contention.

By way of example, consider a device having 20 keys. The keys can all be attached to a single serial line from the processor and connected to the ground plane. If the last key on the string is activated, it generates a default count value code, let's call it 001h in this example. The signal is received by the preceding key which then outputs a 002h value, and the process continues for all 20 keys. The processor, upon receiving the count value of 20 knows that the key on the end of the line has been pressed.

15.3.3 Cascade Embodiment.

FIGS. 30 and 31 depict another embodiment of the invention 1310, in which the data is passed through the series of input circuits according to a cascade polling mode. For some applications this is the simplest of the embodiments to implement.

A plurality of input devices are connected to a controller 1312, such as microprocessor, or a dedicated I/O device configured for supporting devices in this mode. Using a micropocessor requires that it internally decode the serial bit stream received into usable data, which is not difficult for limited number of I/O devices, however in some applications this could represent undue processor overhead, wherein a peripheral device 1312 can be utilized having internal serial to parallel conversion circuitry 1314 which loads a number of addressable registers 1316 which are accessed as memory or I/O addresses via control lines 1318 such as comprising chip select line, register address lines, data lines, read line, write line (to allow setting configuration in a configuration register).

A plurality of input device 1320a, 1320b, 1320c, and 1320n are depicted connected in series between output 1314 of a processor/SIOP device 1312 and an input 1316 of the same device. Each input device can be configured to encode a desired number of data bits according to input module, such as push button (PBNO) switches, single throw switch, multiple pole switch, analog type input (i.e. digital pot, analog pot converted to digital, sense input converted to digital). Preferably the circuit of each key includes some debouncing circuit to eliminate misinterpretation of bouncy key inputs, or other forms of signal conditioning to reduce encoding errors.

The processor/SIOP device 1312 collects data from the devices periodically, such as according to a polling mode of a sufficient rate not to miss intermittent contacts, such as on a push button switch in which valid user input should not be less than 100 mS. For example polling should occur at least at a 100 mS period if quick inputs are not to be missed by the circuit. To collect the data the processor/SIOP device 1312 generates a start pulse on output 1314 which triggers each successive device to “unload” its data onto the serial line for receipt at input 1316 of processor/SIOP device 1312.

FIG. 31 depicts an embodiment of a circuit 1320 for accomplishing the cascade data collection. The input switch 1334 or other input form, is encoded by an encoder 1332 and loaded into a shift register 1328 while the device is inactive (prior to detection of start signal). Input 1322 then receives a trigger from the processor/SIOP device 1312 or from a preceding device. The trigger is detected in comparison to the static setting of the line, such as normally held at zero. The start/stop detection circuit disables loading of the shift register from encoder 1332, such as deactivating the load input of the shift register, and/or tri-stating the output of the encoder. Upon detecting the start by circuit 1324, a clock generator 1326 is activated (can use R/C timing as little accuracy is required), which clocks the loaded data out followed by the string of data arriving from a prior device, through output 1336, preferably buffered by buffer 1338 to output 1340. The start/stop detection circuit then detects that the data has already been sent (such as detecting elapsing of a sufficient period of time without non-zero data, counting clocks from the clock circuit until a limit for the circuit is reached, detecting a particular pattern sent by the processor/SIOP device as a trigger, or other threshold mechanism), and stops the clock and returns the shift register and/or encoder back into a data loading mode wherein changes are automatically loaded into the shift register, which is already zeroed.

It will be appreciated that the above interface can be readily implemented with conventional circuit fabrication techniques and allows for encoding data from a wide variety of devices. It should also be appreciated that the data for the device is always received in the known order of the elements on the serial string.

The encoder may optionally contain other elements, such as a change of state detector wherein it encodes a bit indicating if a change has occurred, this data could then be encoded to reduce the necessity of the processor performing comparisons, but this may not be warranted in the bulk of applications.

It should also be appreciated that the data from the encoder can be appended to the end of the shift register, however, this typically requires either a longer shift register, or advanced control circuits for appending the encoded data after the incoming data is clocked in, such as by loading a portion of a long shift register.

15.3.4 Reflective Cascade Embodiment.

In this embodiment a single-ended series of devices can be serially connected to the processor/SIOP device, the series devices are configured for having a first I/O configuration that upon receiving a signal and sending it on is converted to a second I/O configuration. Specifically a signal received from the processor/SIOP device is passed through all devices to the end and is reflected back from the end along with all the data retained in each of the devices.

FIG. 32 depicts an embodiment 1350 in which a series of input modules 1352a, 1352b through 1352n are chained in a reflective cascade according to the teachings of the invention. An input of module 1352a is received and passed through the other modules including the final module 1352n. After outputting the data on output 1356 the module changes its I/O direction wherein it detects the high on line 1356 as a signal and begins clocking collected data back in the opposing direction to the microcontroller. It will be appreciated that if desired information can be embedded within the trigger signal from the processor/SIOP device to configure the input modules according to some desired configuration. It should also be appreciated that the pulse received from the processor/SIOP device can be used for providing power to the input device if desired, thus eliminating the need for a power line and reducing system power consumption so that power is only consumed in response to the power generated from the trigger signal. Alternatively, the trigger may additionally trigger each input module to exit a low power mode for a period of time, although the simplicity and low speed of the circuit does not otherwise consume much power.

FIG. 33 depicts a block diagram of a circuit 1352. In its normal configuration the device is configured with line 1360 as an input for receiving a trigger from the processor and line 1362 as an output for passing along the trigger. A buffer 1364 is shown for driving the signal between input modules, however, a shift-register or other circuit can be utilized if data is to be gleaned from this signal, such as configuration data. Once this signal has been passed to output, such as for a given duration, or based on the duration of the signal being passed itself, or other mechanism, then mode control circuit 1366 switches device mode, such as by changing tri-state conditions, so that line 1360 now is an output, and line 1362 is now an input.

When this change occurs, the edge of the mode change causes the data from encoder 1368 to be loaded into shift register 1370, but the data is not being shifted in the shift register because clock 1372 is not active. It is preferably that the encoding include an initial high bit (start bit) and conclude with at least one trailing low bit (stop bit) as an end of data indicator. When mode circuit 1366 detects a high on line 1362 (now an input) then it starts clock 1372 which begins clocking the shift register. Each bit of data for the devices is considered of duration T, and the clock is generated to be at approximately the center of the arriving bits from the preceding stage on line 1362. The data for this input module is clocked out through buffer 1374 held in active state by tri-state control 1376 to line 1360 (now an output) to the processor/SIOP device. As the local data is clocked out the data from the preceding stages is clocked in and passed through the devices to the processor/SIOP device. The clocking continues until all data has been transferred through the input modules, which is detected by mode circuit 1366 which will be detecting a solid high on input 1362 as the high on 1352n from the pullup has reflected back through the intermediate stages.

Therefore the mode device in response to detecting a sufficient period without low transitions (i.e. based on timer or counts from the clock), then stops clocking for a short period of time and then switches itself back to its original I/O state in which line 1360 is an input. The clocking is stopped for a period of time prior to switching states, so that even if the input modules do not transition at the same time a race conditions will not arise in which a change of I/O direction by one stage is detected as a low going data element from another stage.

It should be appreciated that the present invention allows a large number of devices to be strung on a single I/O line without the need to address each element, or to concern oneself with contention problems in the system.

It has been mentioned that a serial I/O processing (SIOP) device can be developed for readily interfacing with the serial input chain. It is preferable that microcontrollers and microprocessors eventually provide an input which ties to a series of internal registers to support the function. The interface would support the I/O functions by generating the I/O update as desired under program control, or periodically. An output is generated and then the line switches to input and begins loading the string of bits upon receiving the first start bit which precedes the first string of data. The start and stop bits can be loaded into an extended length shift register capable of receiving all data from the elements in the chain of input modules. The shift register is then accessible as registers which can be read by the processor, preferably without the start and stop bits which frame each piece of data. The data from each module preferably comprises a fixed length, such as 8-12 bits of data, wherein a large number of different input devices can be supported without unduly wasting resource. This mode of utilizing a processing element allows a number of input devices to be coupled to a processor having very few I/O lines while it simplifies overall connectivity, PCB real-estate issues, routing and other design aspects.

In a preferred embodiment each input module is an integrated element having the input switch, selector, or variable value selector coupled to the Reflective Cascade circuit. The end user need only purchase input devices following this standard and can connect them to the processor in any order without any additional considerations.

16 Heated Insect Bait Trap.

16.1 Problem Description.

In home, business, and rural settings individuals struggle with eliminating pests. To eliminate the pests they must be located are trapped or poisoned, or lure the pests to a bait station for trapping or elimination. Making these trapping methods more effective, can reduce pest population and make life more pleasant for the individuals.

The present invention provides enhanced pest trapping overcoming many shortcomings of previous solutions.

16.2 Overview.

Baits are often used to lure pests, such as ants, crickets, cockroaches, and other small pests into a trap (i.e. mechanical doors, flaps, mazes, sticky mats, or combinations) and/or to feed on a poison bait. However, the effectiveness of these baits is marginal in a number of situations, which is enhanced by the present invention.

One such problem environment is that of cold weather. In cold environments the odors generated by the bait stations is minimal, wherein the pests are not attracted to the station. Furthermore, the pests often won't linger long enough at the bait station due to the cold temperatures. We have also found that pests, especially cockroaches, when subject to cold conditions are drawn toward warm items. Coffeemaking machines for example, are invaded by cockroaches in seek of warmth. They will actually set up residence in the machines, the same hold for microwave ovens and a number of them have been shorted out by cockroaches crawling around in the electronics.

The present invention provides apparatus and methods for enhancing traps and bait stations by generating heat. The heat draws the pests to the station, and more preferably provides heating of bait, or other aromatic attractants, to aid in luring pests to the station. The term “bait” may be generally utilized herein to indicate baits which are to be ingested by insects, and attractants, such as indicating food, or sexual partners (i.e. pheromones), which draw insects into the trap. One preferred form of bait station is configured for plugging into a conventional AC outlet for heating the trap/bait station. The heating may be configured to provide a warm inviting “roach motel” that is capable of attracting more pests per unit of time, especially in cold climates in which the pests would otherwise hide out in the warm recesses of the structure and its contents.

16.3 Example Embodiments.

FIG. 34 depicts a roach trap/bait station 1410 having a housing 1412 with at least one opening 1414 that allows the pests to enter the trap or to access poison bait. An AC plug 1416 is coupled to the housing, preferably directly as shown, but may be indirectly. A trap or bait reservoir 1418 is shown which preferably contains a bait or other attractant 1420, which under heating is more aromatic. For example a hard bait at low room temperatures may become a gel or liquid at elevated temperatures. AC plug 1416 is coupled to a heater element 1422 coupled to said attractant 1420. It will be appreciated that any convenient method may be utilized for trapping pests lured by the aroma and heat, feeding the pests with a poison bait, even restraining them in a poison chamber while an aromatic poison takes effect, or combinations thereof without departing from the teachings of the present invention.

Optionally, the aromatic material may be configured to have portions which provide an attractant to the particular pest, while having other portions which give off aromas pleasing to humans.

Preferably a means is provided for user determination of the condition of any bait or attractant within the trap housing, for example a window for viewing the bait, or a visual indicator (i.e. light or display) whose output changes state in response to sensing the change in bait conditions. For example, with a conductive bait the intensity of an LED, neon, EL, or other light source could diminish as the bait level dropped and so the conductivity between two electrodes separated by the bait material.

FIG. 35 illustrates an example embodiment 1430 for indicating the state of the bait. Poser is received through line inputs 1432, limited by devices 1434, such as resistors, passed through an optical output element 1436, depicted herein as a neon light (alternatively may be an LED, EL, electronic ink region, and so forth). The optical output is in response to the current passing between electrodes 1438a, 1438b, between which bait, or other aromatic elements are held in a bait tray (or trap) 1418. A light output need not be generated, for example electronic ink regions can be configured to change state, such as printed lettering containing electronic ink changing from a color that matches the background to where it reads “Replace Bait”, or a similar notice that becomes increasingly visible in response to depletion of the attractant. This can be achieved for example by using an electronic ink biased toward a first output state, as described in application entitled “Electronic Ink Enhancement—Biased Output State” described elsewhere in this application. Using electronic ink in this application, increased resistance between electrodes on the bait can drop the signal to the display wherein the bias on the spheres, such as magnetic, exceeds the electrical field intensity allowing a change of state to occur indicating the need to replace the attractant, or the entire unit.

It should be appreciated that bait or attractant condition can be sensed utilizing other forms of sensors, such as capacitive, inductive, and any other convenient means. It will be appreciated that similar means can be provided for traps wherein an indication can be provided that the trap is near full.

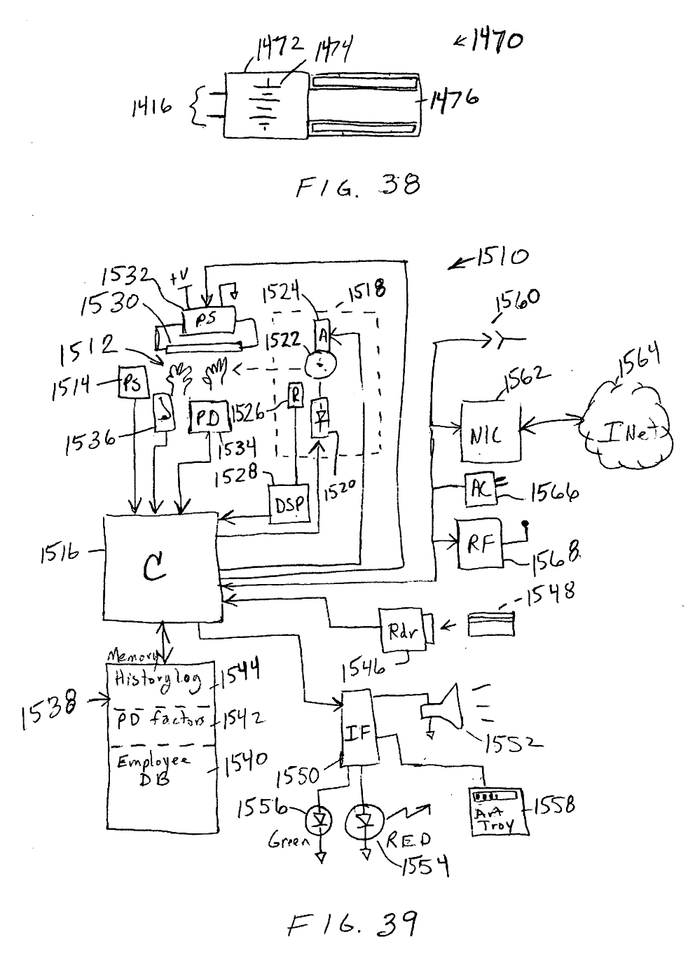

FIG. 36 and FIG. 37 illustrate a packaging embodiment 1450 that allows the bait to be retained in housing 1412 on the ground although the outlet from which power is derived is up to two feet above the ground level. An outlet A is shown on wall B which intersects floor C, outlet A being a distance D above floor level. A power coupling 1452 is configured to couple the AC power, preferably through a voltage dropping resistance or zener diode drops, to a conductive strip 1454 (i.e. with two conductors) which couples power from the AC outlet A to the heating element within housing 1412. Excess portions of conductive strip 1454 are shown still retained in an original spiral 1456.

The package is shown configured with conductive strip 1454 slidably engaged with coupling 1452, allowing housing to be properly positioned for a given installation. Coupling 1452 may connect to exposed contacts on strip 1454 because the voltage may be dropped to a safe level within coupling 1452. An inset of FIG. 37 depicts a facing view of an exposed set of conductive traces 1458, 1460, upon which contact tabs of coupling 1452 make electrical contact. Alternatively, coupling 1452 can be configured with a engagement means 1458, such as a snap-down tab that drive contacts into strip 1454 to make internal electrical contact, whereby no voltages are exposed. Preferably, the snap down tab arrangement, once engaged is locked into coupling 1452 and cannot be changed to different locations along the strip, which could expose individuals to contact with previously cut portions.

It should be appreciated that the coupling between the power outlet and the heated trap/bait housing can be provided in a number of alternative ways without departing from the teachings of the present invention. It should also be appreciated that viewing windows and indicators can be implemented in a number of ways by one of ordinary skill in the art.

It should be appreciated that the housing may be configured for being heated in a number of alternative ways. An power storage module can be provided for powering an AC line powered trap/bait station. The power storage module is configured with a means of storing power, such as fuel cell, batteries, capacitors and the like, and can contain a power inverter for generating the AC voltage for operating a conventional AC powered unit as shown. Alternatively, the power storage module may be configured for generating the proper native voltage, such as preferably between three to twelve volts D.C. wherein power from the storage device is directly coupled to a heater element.

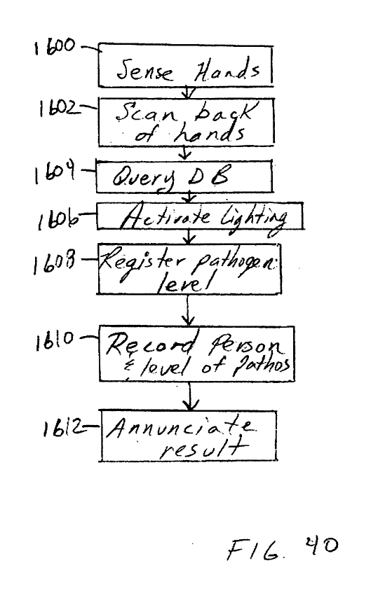

FIG. 38 depicts a device having a rechargeable power module 1472 having internal power storage 1474 configured for coupling to a trap/bait station housing, with openings. A number of configurations may be adopted for remotely powering the unit from secondary power sources (i.e. rechargeable batteries), as described, or primary power sources (i.e. non-rechargeable batteries).

Although typically more costly, the bait can be heated by means of chemical forms of heating, such as utilized with heated compresses that are activated upon mixing the two or more constituent compounds.

The bait may also be heated during the night from power collected during the day. In a first mechanism light energy is directed to a rock or other heat reservoir which is insulated and whose heat then keeps the bait at an elevated temperature during the night. Alternatively, solar cells can be utilized to store energy used for heating the bait during the night or other times of lower temperature.

17 Hand Sanitation Verification Station.

17.1 Problem Description.

The public is becoming increasingly aware of sanitation issues as the number and virulence of infectious biological agents (i.e. bacteria, viruses, rogue proteins, etc.) increases. One mechanism by which these infectious agents are communication is by workers that fail to adequately sanitize or maintain sanitary conditions. One example of this is in the food services industry, wherein management continues to alert workers to the need of washing their hands, in particular following bathroom breaks and the like. Another example, is that of workers that do not properly cover their mouth when coughing or sneezing, wherein infections agents can be disseminated over a wide area.

Accordingly, the present invention provides a number of systems and methods for increasing compliance with proper sanitary procedures.

17.2 Overview.

Hand sanitation validation system. A system which generally comprises (a) means for detecting contaminants, pathogens, or other materials on the hands (or other body portions of a worker, such a forearms if these make contact with food or other items) which indicate that proper sanitation has not been maintained; (b) means for scanning veins in the skin of said individual for identifying that individual. Optionally, the system is configured with an alert or indicative means, and means for communicating collected information to a data collection and/or processing system, such as a computer system.

17.3 Example Embodiments.

FIG. 39 illustrates an embodiment of a hand sanitation validation system 1510. The hands 1512 of an employee, or other individual that has been identified to the system, are detected by a proximity sensor 1514 coupled to a processing element 1516, such as a microcontroller. A means for scanning an identification from the back of the hands of the user comprises a laser scanner 1518. The laser scanner may be implemented in a number of ways including with a solid state laser diode 1520 with associated optics, wherein the beam is directed to a spinning reflector 1522 driven by actuator 1524 for providing the scan path. Reflected light is registered by optic detector 1526 and the signal processed, such as by a digital signal processor 1528 configured to generate a digital signature associated with the unique pattern of veins detected in the back of the scanned hands. It will be appreciated that analog signal processing techniques can be less preferably used or a combination of digital and analog processing techniques. The techniques for identifying vein pattern in the eyes, or other areas of skin are known in the art wherein no additional details need be provided.

A light 1530 (i.e. ultraviolet) for illuminating the hands to indicate the presence of pathogens and other contaminants is shown coupled to a source of power 1532 whose activation is controlled by controller 1516. A pathogen sensing means 1534, such as an imaging system configured for detecting the germs, bacteria, and other unwanted elements whose presence indicate a lack of sufficient washing. The sensing of pathogens based on imaging is known in the art. An optional sensor 1536 is also configured to sense the presence of other pathogens or similar undesired elements that should have been washed off. By way of example a device known as an artificial nose may be utilized, though numerous other types of equipment may be utilized which rely on detector arrays, spectral scans, and so forth.

Memory 1538 is coupled to processor 1516 containing executable programming as well as a database of employee information 1540 including codes associated with their hand scan pattern to allow matching. Pathogen factor information 1542 can also be stored in the system for controlling the detection of unwanted materials on the hands of the individual being tested. An optional history log is preferably maintained with a history of the scans performed on individuals. This allows a check on (1) whether persons on shifts are properly using the machine, (2) if any patterns of uncleanliness show up in the patterns of user—anyone often failing or marginal in their sanitation.

A reader mechanism 1546 is shown receiving an employee identification card 1548, or other form of identification for the specific user. This feature is used by a personnel director, owner, or other responsible individual to initially configure the device for a new employee. The reader mechanism may even be removable and only attached when a new person is to be entered into the system. Their card is read and then sufficient scanning of their hands is performed to build sufficient data for later identification purposes. The hand scanning should be performed with the hands in the condition with which they are to be sanitized. For example if the system is used with hands that may be gloved or ungloved, then the individual should be scanned in both conditions.

Annunciation output devices are preferably provided to indicate whether the individuals hands are sufficiently clean. For example an interface 1550 is configured with an audio annunciator 1552, visual annunciators 1554, 1556 and optionally a display 1558 configured for providing a value of hand cleanliness. It is preferred that display 1558 also display the name of the person which has been identified by the hand scan, wherein an individual can be sure they are being properly identified by the machine.

Results can be communicated to other systems, such as a main computer, or over a network to any desired entity collecting the cleanliness data. Data may be communicated over direct wired connections 1560, wired network connections 1562, AC power line network connection 1566, wireless connections 1568, or other communication medium. The data from the device can be directed to electronic dashboard consoles so that sanitation can be monitored in a large industrial facility from a central point.

FIG. 40 depicts the method of operation of the system-apparatus. As represented in block 1600 the system senses that the hands of the user are present and then as per block 1602 scans the back of the user's hands. The hand scanning should be operable for users with or without gloves. The scan data is preferably processed into a digital signature form for inclusion with a database query which is generated as per block 1604. Preferably while the query is taking place (or simultaneously) lighting is activated at block 1606 (preferably direct although scanned lighting may be utilized) and the cleanliness is detected as per block 1608, such as by registering pathogens or other elements which are indicative of hands which are perhaps not fully washed, or which are not properly covered with clean gloves. The cleanliness is then recorded at block 1610 and the results annunciated at block 1612, and optionally communicated to other systems.

18 Scrollster—Enhancements and Added Embodiments.

18.1 Example Embodiments.

The following are additional elements to be added to the scrollster set of applications as referenced above.

Preferably provide a communication link (i.e. wired, wireless connection (i.e. RF, magnetic field, inductive, optical, ultrasonic), network connection, internet connection, or other means of receiving data for output on the scroll and preferably control information on scroll movement, lighting, and so forth.

Housing—

A hideaway compartment in the housing which is particularly well suited for receiving personal items such as wallets, keys, cell phones, secret papers, candy, and the like. In this way the scrolling unit provides both a visual and sound center for the room, but a repository of items which should not be forgotten. Access to the compartment can be selectively controlled by means of a keyed access, password entry, sliding panel actuation, and other means of reducing the chance that others will gain access to the contents.

Other Functions—

Clock—may receive RF synchronization signals, such as what are commonly referred to as atomic clocks.

Radio—can receive radio broadcasts for output from the audio output device. Programming in the control circuit of a high-end embodiment is preferably configured to allow the user to record segments of the radio content for being replayed from the unit in response to manual selection, and/or in response to time, mode, or position of the scroll.

Control Circuit—

Configured for altering the scrolling speed in response to data contained on the scroll, and/or to internal data (i.e. timer, alarms, information from received radio broadcast) and external data (i.e. sensed external conditions, microphone input, optical sensor, inputs on user interface, communications interface, etc.). Audio and lighting effects can be configured to operate at any desired speed as they are always inherently synchronized with the scroll.

Scrolls—

Describe further the means by which positioning information along with audio and/or lighting information are encoded. For example (1) using split head that can read multiple strip portions. (2) encoding audio tags (i.e. specific patterns) to represent positioning information, such as a specific frequency such as 5 Khz for a given duration. Data may be encoded digitally, wherein distinct codes can delineate which are control and positioning information from which are audio and/or lighting data.

Use of separate positioning indexes to determine the position of the scroll without the need to encode position information in the data strip.

A plurality of data strips on the scroll, these strips can be read by one or more sensors. A plurality of sensors proximal to the data strips for reading content from one or more selected data strip at a given time. At least one sensor configured with an actuator for selectively moving the sensor perpendicular to the direction of scroll material travel into alignment with one or more data strips for reading data content.

Two sided scrolls. The data strip is located toward the edge of the scroll, preferably unseen, wherein each side has its own imprinted poster and data strip.

Means for coupling scrolls to one another to form a longer scroll, wherein user can have greater variety. The control circuit, or firmware executed on the control circuit, is preferably configured to allow the user to select how to interact with multiple scrolls. For example, alternating use, selection based on time of day, manual selection of alternative scroll, and so forth.

Metallic based material of scroll wherein the use of transparent colors in at least selection portions increases the reflectivity of the material providing enhanced visuals, while the use of opaque colors results in a more conventional, less reflective, appearance.

Scrolls which can be easily written upon, such as with a felt tip marker, grease pencil, etc. Scrolls may even be printed from a computer, such as from content contained at the site of a manufacturer, for example which may charge for downloading additional scroll content.

Internet Interface—

The unit can be configured with a port (i.e. USB) wherein it may be connected to a source of content, such as a manufacturer site over the internet. Alternatively, the unit can receive content (or programming) loaded from memory sticks or other memory resident items.

Allow loading information from the internet for controlling the display or operation of the scrolling unit (i.e. text, graphics, light patterns, sound patterns, modes of operation). This is best used with the device having internal memory for storing the information and which is output in response to position of the scroll. (This adds a feature not in the prior art) This feature can be used in combination with information contained on the poster scroll. The control circuit is configured to allow the user to select how to use both sets of content (i.e. downloaded content, scroll content, combination of the two, and so forth).

Electronic Ink—

Describe the opposing electrodes. Describe embedding a ground electrode in the material which contacts the spool to establish ground. Alternatively using a conductive or semi-conductive, spool which maintains a ground plane behind a portion of the scrolling material. Alternatively, the programming electrodes and the ground plane may be disposed between the spool locations, such as at the edge of the housing, or elsewhere.

Animation effects—altering the state of eink between a first and second viewable position on the poster scroll. At least two electrode arrays are retained proximal the path of the scroll, or at least portions containing the electronic ink sections, wherein portions of the poster displayed as electronic ink can be altered as the scroll moves. For example a character may be holding a sword whose depicted as a black outline by electronic ink having two states. As the scroll moves over another set of electrodes the old sword position can be erased and a new sword position programmed. It will be appreciated that one or more interior electrode arrays may be utilized with electrode arrays which are hidden beyond the edges of the movable scroll.

Illustrate a grid of electrodes behind the material for dynamically programming the state of an area of the scroll containing electronic ink. These can program eink located anywhere on the scroll at that particular position between the top and bottom of the scroll.

The whole scroll may contain eink, such as over painted portions, these may be reflective or otherwise modulate the effect of the eink.

Conventional Poster or any graphics with animated colors in sections. Eink within a section is modulated dynamically to alter the optical characteristics, such as to generate shimmer or other effects that increase the value of the display. Part of this is already described in another patent by the inventor describing animated labels and such.

Directed Audio—

At least two ultrasonic transducers configured for generating ultrasonic acoustic signals which overlap at a location at which a beat frequency component of the transmissions of said ultrasonic transducers may be heard. Preferably the orientation of the transducers can be adjusted to select the location, or locations, at which the transducer outputs overlap.

19 Method of Disseminating Personal Info in Response to DNA Analysis.

19.1 Overview.

The use of DNA has provided information that allows matching an individual to a biological sample. Genetic information is being discovered that related to conditions or predispositions that arise in relation to certain gene patterns. Some studies of DNA patterns have allowed determining ancestral information of the donor.

The present invention provides a method and system whereby persons can access information relating to their DNA, preferably in a secure format. Information relating to different known conditions, ancestry, area of origin, recessive traits, what is known of others in lineage. Information regarding family members with close genetic ties can also be made available, if both parties consent. A number of aspects of the invention are described which can be implemented together or separately.

19.2 Description of a Preferred Embodiment.

DNA background—Method of providing information to persons based upon their DNA, and other information which has been collected. The invention may be described as a method of disseminating genetic information, comprising a number of steps as follows.

(1) Capturing DNA from a donor. Any sample element from the person can be utilized from which DNA can be extracted. However, to prevent abuse, it is (i) preferable that the user wanting to get information about their own DNA goes to a lab, or pharmacy, wherein their identification is checked and a sample from their body is taken. For example, from a mouth swab, blood sample, skin sample, or other form of tissue-laden sample of DNA is taken. In this way a donor cannot bring in DNA from someone else to get information about that other person. Other information from the donor may be optional collected, such as health related measurements, survey information, and so forth.

(2) Generating an identifier means for the donor, such as a identifier and password, allowing them to access a web site and associate themselves with the collected sample. Alternatively, the donor can supply an email address to which information is to be sent. Preferably, multiple levels of identification means is provided, allowing a highest level of security for the donor, but allowing the donor to allow others to gain access to portions of the information as desired. For example, a second level of identification can be given to relatives that also are having a DNA screening, wherein the genetic analysis program can utilize all the information available from the donors and family members which have provided access to the information.

(3) Collecting additional information from the donor for use in the genetic analysis, to aid the program in determining facts about the individual (optional). For example, they may know from which countries their family originated, and have specific information about parents and relatives. Furthermore, they may know about specific medical conditions that they have or that specific relatives have, and the like. They can also provide information about their own eye color, hair color, and so forth.

(4) Analyzing the DNA sample along with any other optional information. The DNA coding is registered by any convenient mechanism, either at the site of the collection, or in response to being sent to a location at which an analysis device is located. Once registered the genetic pattern is uploaded to a computer system coupled to a database of genetic information. Portions of the genetic sequence are compared against specific patterns of discerning health, ancestral, and optionally compatibility aspects if more than one set of DNA information is provided.

(5) Generating a report, such as to the donor and optionally to others, based on the analysis of the DNA sample, and optionally the information provided by the donor. This information is preferably generated for user access over the internet allowing the user to print out, or download the information. Alternatively, the information can be mailed. Preferably, the donor is allowed to download their DNA mapping, for use in other applications.

(6) Generating subsequent reports to the donor as new information becomes available about relating to their genetic makeup. These can be generated autonomously by the system or in response to a query from the donor. The system preferably maintains a snapshot of the most recent information provided to the donors, or to others. As new genetic information becomes available, the DNA information of the donor can be periodically checked, such as to glean additional information. If new information becomes available which extends past the snapshot, such as for example exceeding a threshold level preferably set by the user, then the user can be alerted to the availability of the additional information, wherein it can be accessed.

Alternatively, the donor can log on periodically to get additional information relating to their genes as it becomes available. They preferably also will update the information about their health, family, and so forth. They can add additional background information at any time to enhance the analysis.

Preferably, the database of donors is annonymous and does not contain any user names, addresses, phone numbers, email addresses or the like. Wherein the DNA database has information about DNA, and information about medical conditions and the like from the donor.

Optionally, a user can provide permanent or temporary access to their DNA information to another party (or parties). For example, a fiancé, wherein both parties are fully informed about one another.

The system provides information to researchers, but allows users to gather information important for charting ancestry, determining health issues and the like.

19.2.1 Extended Prenuptual Analysis.

As a wealth of DNA related information becomes available it will be increasingly beneficial to correlate the DNA of a prospective bride and groom, wherein possible genetic compatibility issues can be assessed by both parties, allowing more intelligent decisions to be made, such as in regard to family planning. In a preferred aspect of the invention, prospective wedding partners are encouraged, or required, to obtain a DNA analysis, along with a blood test, if still necessary in view of the superset of information provided by the DNA testing. The parties may separately submit DNA samples at a collection site where preferably their identity is verified. The couple is provided with one or two access codes allowing them to access their genetic information as separate sets of information or collected into a single file. Furthermore, the system is preferably configured to allow the information to be directed to the couple's physician, or other health care professional, in particular if the analysis indicates any issues with genetic issues. Issues arising from the DNA analysis are compared against one or more severity thresholds, wherein any issues exceeding a given threshold or that cumulatively exceed an overall threshold, trigger communicating the related information to the health care professional. Furthermore, elements of the DNA analysis being reported to the donors are ranked with regard to prospective importance.

Some municipalities may require that each party sign off after having been apprised of the report generated in response to the DNA analysis produced by the present system. In this way it is assured that each party is aware of the genetic issues regarding the other party. The information generated from the report may include other information such as blood tests, health screening information, disease test information and the like.

20 Method of Providing Web Based after Death Gifting Service.

20.1 Overview.

A service allowing persons to communicate gifting, notes, and so forth to those family and friends that they love; after they have passed on. Obviously the customer makes the selections and pays for the services prior to passing away.

We all want to leave a legacy after we pass away, and even more importantly we want those left behind to know that we still love them. We may even have some wisdom that could be timely for that person. There is also much to be said that those alive would not hear before we departed. We may want to remind them of the love of God.

Many have heard the story of how Jack Benny established a trust so that flowers were to be brought to his wife each week for the rest of her life. There are sufficient instances such that a business can be supported by gifting after the patron is deceased (i.e. sending periodic gifts). The statement “Gone, . . . But Not Forgotten” speaks about the sentiment. Repeat business is different than most businesses, . . . talk about deadbeat clients and lack of follow-on business. The method can be established with existing gift related companies to provide a different service for them. The items being gifted can come from them exclusively or from them and other participating vendors.

20.2 Description of a Preferred Embodiment.

An internet based business having a web front end, but able to send materials, letters, and so forth. Patrons enter message, (text, voice, multimedia, etc.) along with information about the recipient. They can choose to have these delivered by email or by mail. If they select a gift, the message will be included with the gift.

The remembrance emails or regular mails can be sent with or without gifts. Individuals can send their thoughts, letters, videos, and so forth without the need to include gifts. The sending of email is preferably free allowing many people to use the service. (Handling charges incurred for select services, such as sending of letters, videos, and so forth).

Recipients are encouraged to respond to email so that the system knows it can stop sending additional copies of the email. If not deliverable, then the email can be routed through a close contact which was provided by the deceased party. If neither respond then letters sent out with information on how to enter a new email address for the individual.

A number of aspects of the invention can be provided including but not limited to the following.

A catalog of gifts and remembrances can be provided which lists items. Each item is categorized (type, theme, colors), so that if specific item is not available at the time of sending the gift, then a similar gift can be selected.

Sending money to charities in the name of the individual—helping others to understand the power of giving.

Creating a living last will and testament—with division of assets & properties.

User can select how any replacements are to be handled.

Select dates for them being sent.

Event driven—what message to send at a graduation, barmitzva, wedding.

Event contacts—these people are close to those for which events are chosen.

Hand written letters—provide stickers for associating these with selected gifts & remembrances.

Video—can send video in, containing one or preferably more messages. These are then sent within email message to the individual.

Philosophy/Memoirs—Can be a way to share your life philosophy and such with those still around. The messages in the series can be selectively put in a album for sending to the individual.

Charity—if the party to which the gifts are directed has passed away the system allows the user to select a charity to which the moneys would be directed.

Sharing experiences—has questions which touch the heart of many aspects of life. Happy moments in life, remembering when children were born, weddings, and interesting things that happened in the person's life. Favorite sayings in their own voice. What they learned from life about: getting along with a spouse, what's important in life, how to live, vacationing, relationship to the creator.

A program can be set up wherein, persons close to them can facilitate collecting the information, taking videos, and setting everything up. Preferably two parties take part in it so that the person can thank those who helped them set up the program (probably a close individual that is one of the more important persons to them).

Can be an adjunct to a site by other merchants. For example this site can orchestrate purchases through other sites, such as Amazon.com which are configured for interfacing with the system for both the initial selection of goods, and then later handling the purchase and direct sending of the gift along with the gift card, letter, etc.

Program can be setup at nursing homes, wherein they even provide a recorder, camera, and perhaps the internet based equipment. Can have a video station set up wherein users can record video for being sent to others.

21 Invention Scope.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof. For example, one of ordinary skill may find other suitable substitutes for certain applications, expressed as types, configurations, placement, number of, etc.

Moreover, a system, apparatus, or method according to the various embodiments of the invention may be provided with all with all of features described herein, or only portions thereof, which combinations may be practiced and/or sold together or separately. For example, a system, apparatus, or method may be manufactured and sold without certain desired equipment for later assembly. In this regard, such equipment may be “adapted to” include or otherwise couple to such equipment without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for detecting and enhancing the display of ballistic objects, and very fast moving elements in the field of view, comprising:
a high speed imager configured for collecting images at a sufficiently high framing rate to discern the motion of projectiles and very fast moving objects (VFM) from slower moving objects, personnel, and vehicles;
means for displaying image information collected from said high speed imager;
means for extracting a sufficiently low framing rate image signal from the signals generated by said high speed imager to be displayed by said means for displaying;
means for determining vectors associated with VFM; and
means for generating display elements, based on vectors associated with VFM, for a desired period of time which are overlayed on said means for displaying images or within said low framing rate image signal.

2. An apparatus as recited in claim 1, wherein said means for generating display elements is configured to alter the characteristics of the generated display output associated with a given VFM element or event.

3. An apparatus as recited in claim 2, wherein said characteristics comprises changing the color, size, representation, or pixel density of the displayed element.

4. An apparatus as recited in claim 3:
wherein changing said representation comprises changing the solidness of the image;
wherein solidness in a line vector can change from a solid line to dashed lines; and
wherein the transition from solid to dashed lines can be performed progressively over a selected period of time until the line become faint and finally disappears from the displayed image.

5. An apparatus as recited in claim 1, wherein said means for displaying image information is further configured for displaying information received from an external source.

6. An apparatus for confusing enemy forces in an engagement as to the composition of friendly forces, comprising:
a housing containing a power source;
an electronic controller for modulating outputs to simulate the presence of troops;
light outputs controlled by said controller; and
audio output configured for simulating a contingent of personnel.

7. An apparatus as recited in claim 6, wherein said electronic controller is configured to modulate the audio and/or lighting outputs of said apparatus to mimic the presence of personnel.

8. An apparatus as recited in claim 6, wherein said lights comprise LEDs.

9. An apparatus as recited in claim 6, wherein the device is configured with a plurality of said lights providing different lighting effects and/or different directions.

10. An apparatus as recited in claim 6; wherein said audio output comprises recorded sounds which are indicative of conversations and the sounds of personnel.

11. An apparatus as recited in claim 6, wherein said audio output comprises computer generated speech and sounds.

12. An apparatus as recited in claim 6, further comprising an optical sensor for detecting sudden changes in available lighting which can indicate the proximity of personnel and vehicles.

13. An apparatus as recited in claim 12, wherein said electronic controller is configured to alter the effects being output by said apparatus in response to changing lighting.

14. An apparatus as recited in claim 13, wherein said electronic controller is configured to generate effects light levels in accord with the ambient lighting; wherein said effects light levels are partially dimmed in response to darkness.

15. An apparatus as recited in claim 6, further comprising an acoustic sensor for registering acoustic events; wherein said controller is configured to alter effects output in response to detected sounds.

16. An apparatus as recited in claim 6, further comprising a plurality of electronically ignited explosive charges coupled to said electronic controller for being set off periodically, randomly, or in response to events.

17. An apparatus as recited in claim 16, wherein said explosive charges comprise bullets electronically fired.

18. An apparatus as recited in claim 16, wherein said controller is configured to respond to select detected acoustic or ambient lighting events by igniting one or more explosive charges.

19. An apparatus as recited in claim 16, wherein said electronically ignited charges comprise:
a plurality of small explosive charges configured to simulate small arms fire;
electrically activated igniter; and
a base plate to which said charges and ignitors are coupled;
wherein said base plate is configured with an electrical connector for electrically coupling said base plate with electronically charges to said electronic controller.

20. An apparatus as recited in claim 19, wherein said small explosive charges comprise blank bullets configured for being electronically triggered.

21-147. (canceled)
